(19) United States
(12) Patent Application Publication
(10) Pub. No.: US 2005/0054533 A1
(43) Pub. Date: Mar. 10, 2005

(54) Herbicidal conposition

(76) Inventor: Willy T. Rüegg, Stein (CH)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/497,614

(22) PCT Filed: Dec. 2, 2002
(86) PCT No.: PCT/EP02/13615

(30) Foreign Application Priority Data
Dec. 3, 2001 (CH) 2214/01

(51) Int. Cl. A01N 25/00; A01N 43/40

(52) U.S. Cl. 504/260

(57) ABSTRACT

Herbicidal composition that, in addition to comprising customary inert formulation adjuvants, comprises a) a compound of formula (I), wherein the substituents are as defined in claim 1, or an agronomically acceptable salt of that compound, and b) a synergistically effective amount of one or mote compounds of formulae 2.1 to 2.53 and the compounds prosulfocarb, picolinafen, pyraflufen-ethyl, beflubutamid, fenoxaprop-P-ethyl, dliclofop-methyl, amidosulfuron, flupyr-sulfuron, flupyrsulfuron-methyl-sodium, metsulfuron-methyl, sulfosulfuron, tribe-nuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlor-prop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin. The compositions according to the invention may also comprise a safener.

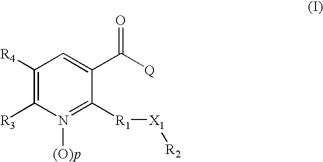

The present invention relates to a novel herbicidal composition comprising a herbicidal active ingredient combination that is suitable for the selective control of weeds in crops of useful plants, for example in crops of maize. The invention relates also to a method of controlling weeds in crops of useful plants and to the use of the novel composition for that purpose.

The compounds of formula I 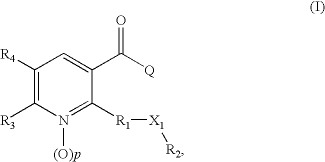
wherein
p is 0 or 1;
R₁ is a C₁-C₆alkylene, C₃-C₆alkenylene or C₃-C₆alkynylene chain, which may be substituted one or more times by halogen or by R₅, the unsaturated bonds of the chain not being attached directly to the substituent X₁;
X₁ is oxygen, —O(CO)—, —(CO)O—, —O(CO)O—, —N(R₆)—O—, —O—NR₅₁—, thio, sulfinyl, sulfonyl, —SO₂NR₇—, —NR₅₂SO₂— or —NR₈—;
R₂ is a C₁-C₈alkyl, C₃-C₆alkenyl or C₃-C₆alkynyl group, which is substituted one or more times by halogen, hydroxy, amino, formyl, nitro, cyano, mercapto, carbamoyl, C₁-C₆alkoxy, C₁-C₆alkoxycarbonyl, C₂-C₆alkenyl, C₂-C₆haloalkenyl, C₂-C₆alkynyl, C₂-C₆haloalkynyl, C₃-C₆-cycloalkyl, halo-substituted C₃-C₆cycloalkyl, C₃-C₆alkenyloxy, C₃-C₆alkynyloxy, C₁-C₆halo-alkoxy, C₃-C₆haloalkenyloxy, cyano-C₁-C₆alkoxy, C₁-C₆alkoxy-C₁-C₆alkoxy, C₁-C₆alkoxy-C₁-C₆alkoxy-C₁-C₆alkoxy, C₁-C₆alkylthio-C₁-C₆alkoxy, C₁-C₆alkylsulfinyl-C₁-C₆alkoxy, C₁-C₆-alkylsulfonyl-C₁-C₆alkoxy, C₁-C₆alkoxycarbonyl-C₁-C₆alkoxy, C₁-C₆alkoxycarbonyl, C₁-C₆-alkylcarbonyl, C₁-C₆alkylthio, C₁-C₆alkylsulfinyl, C₁-C₆alkylsulfonyl, C₁-C₆haloalkylthio, C₁-C₆haloalkylsulfinyl, C₁-C₆haloalkylsulfonyl, oxiranyl (which may in turn be substituted by C₁-C₆alkyl), (3-oxetanyl)-oxy (which may in turn be substituted by C₁-C₆alkyl), benzylthio, benzylsulfinyl, benzylsulfonyl, C₁-C₆alkylamino, di(C₁-C₆alkyl)amino, R₉S(O)₂O, R₁₀N(R₁₁)SO₂—, rhodano, phenyl, phenoxy, phenylthio, phenylsulfinyl or by phenylsulfonyl; wherein the phenyl- or benzyl-containing groups may in turn be substituted by one or more C₁-C₆alkyl, C₁-C₆haloalkyl, C₁-C₆alkoxy, C₁-C₆haloalkoxy, halogen, cyano, hydroxy or nitro groups, or
R₂ is phenyl, which may be substituted one or more times by C₁-C₆alkyl, C₁-C₆haloalkyl, C₁-C₆alkoxy, C₁-C₆haloalkoxy, halogen, cyano, hydroxy or by nitro; or
R₂ is C₃-C₆cycloalkyl; C₃-C₆cycloalkyl substituted by C₁-C₆alkoxy or by C₁-C₆alkyl; 3-oxetanyl or 3-oxetanyl substituted by C₁-C₆alkyl;
or, when Q is Q₂ or Q₃, or when Q is Q₁ wherein R₁₄ and R₂₂ denote a C₂-C₃alkylene chain, R₂ may additionally be a five- to ten-membered, monocyclic or fused bicyclic ring system, which may be aromatic, saturated or partially saturated and which may contain from 1 to 4 hetero atoms selected from nitrogen, oxygen and sulfur, the ring system being bonded to the substituent X, directly or via a C₁-C₄alkylene, C₂-C₄alkenyl-C₁-C₄alkylene, C₂-C₄alkynyl-C₁-C₄alkylene, —N(R₁₂)—C₁-C₄alkylene, —SO—C₁-C₄alkylene or —SO₂—C₁-C₄alkylene group, and wherein each ring system may contain no more than two oxygen atoms and no more than two sulfur atoms and the ring system may itself be mono-, di- or tri-substituted by C₁-C₆alkyl, C₁-C₆haloalkyl, C₂-C₆alkenyl, C₂-C₆haloalkenyl, C₂-C₆alkynyl, C₂-C₆haloalkynyl, C₁-C₆alkoxy, hydroxy, C₁-C₆haloalkoxy, C₃-C₆alkenyloxy, C₃-C₆alkynyloxy, mercapto, C₁-C₆alkylthio, C₁-C₆haloalkylthio, C₃-C₆alkenylthio, C₃-C₆haloalkenylthio, C₃-C₆alkynylthio, C₂-C₅alkoxyalkylthio, C₃-C₅acetylalkylthio, C₃-C₆alkoxycarbonylalkylthio, C₂-C₄cyanoalkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₂alkylaminosulfonyl, di(C₁-C₂alkyl)aminosulfonyl, di(C₁-C₄alkyl)amino, halogen, cyano, nitro, phenyl or by benzylthio, wherein phenyl and benzylthio may in turn be substituted on the phenyl ring by C₁-C₃alkyl, C₁-C₃haloalkyl, C₁-C₃alkoxy, C₁-C₃haloalkoxy, halogen, cyano or by nitro, and wherein the substituents on the nitrogen in the heterocyclic ring are other than halogen; or
R₂ is hydrogen or unsubstituted C₁-C₈alkyl, when either
a) R₁ is substituted by the group R₅, or
b) Q is the group Q₂, or
c) Q is the group Q₃ wherein X, is —O(CO)—, —(CO)O—, —N(R₆)—O—, —O—NR₅₁—, —SO₂NR₇—, —NR₅₂SO₂— or —NR₈—; or
d) Q is the group Q₁ wherein X₁ is —N(R₆)—O—, —O—NR₅₁—, —SO₂NR₇—, —NR₅₂SO₂— or —NR₈—, or
e) Q is the group Q₁ wherein R₁₄ and R₂₂ in Q₁ denote a C₂-C₃alkylene chain and X₁ is —O(CO)— or —(CO)O—;
R₃ is C₁-C₃haloalkyl;
R₄ is hydrogen, halogen, C₁-C₃alkyl, C₁-C₃haloalkyl, C₁-C₃alkoxy, C₁-C₃alkoxy-C₁-C₃alkyl or C₁-C₃alkoxy-C₁-C₃alkoxy;
R₅ is hydroxy, C₁-C₆alkoxy, C₃-C₆cycloalkyloxy, C₁-C₆alkoxy-C₁-C₆alkoxy, C₁-C₆alkoxy-C₁-C₆alkoxy-C₁-C₆alkoxy or C₁-C₂alkylsulfonyloxy;
R₆, R₇, R₈, R₉, R₁₀, R₁1, R₁₂, R₅₁ and R₅₂ are each independently of the others hydrogen, C₁-C₆alkyl, C₁-C₆haloalkyl, C₁-C₆alkoxycarbonyl, C₁-C₆alkylcarbonyl, C₁-C₆alkoxy-C₁-C₆alkyl, C₁-C₆alkoxy-C₁-C₆alkyl substituted by C₁-C₆alkoxy, benzyl, or phenyl, wherein phenyl and benzyl may in turn be substituted one or more times by C₁-C₆alkyl, C₁-C₆haloalkyl, C₁-C₆-alkoxy, C₁-C₆haloalkoxy, halogen, cyano, hydroxy or by nitro; wherein R₆ is not hydrogen when R₉ is hydrogen, C₁-C₆alkoxycarbonyl or C₁-C₆alkylcarbonyl;
Q is Q₁ 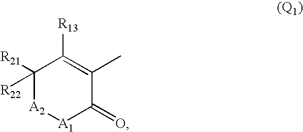
   wherein
A₁ is C(R₁₄R₁₅), NR₁₆ or oxygen;
A₂ is C(R₁₇R₁₈), C(O), —C═N—O—R₁₉, oxygen, thio, sulfinyl, sulfonyl, —NR₂₀ or ethylene; with the provisos that A₁ is other than oxygen when A₂ is oxygen, C(O), thio, sulfinyl, —C═N—O—R₁₉, NR₂₀ or C(R₁₇R₁₈), R₁₇ and R₁₈ being each independently of the other C₁-C₄alkoxy, C₁-C₄-alkylthio, C₁-C₄alkylsulfinyl or C₁-C₄alkylsulfonyl; and that A₁ is other than NR₁₆ when A₂ is thio, sulfinyl or C(R₁₇R₁₈), R₁₇ and R₁₈ being each independently of the other C₁-C₄alkoxy, C₁-C₄alkylthio, C₁-C₄alkylsulfinyl or C₁-C₄alkylsulfonyl;
R₁₄ and R₂₂ are each independently of the other hydrogen, C₁-C₄alkyl, C₁-C₄haloalkyl, C₃-C₄-alkenyl, C₃-C₄alkynyl, C₁-C₄alkylthio, C₁-C₄alkylsulfinyl, C₁-C₄alkylsulfonyl, C₁-C₄alkylsulfonyl-oxy, C₁-C₄alkoxy, C₁-C₄alkoxycarbonyl or C₁-C₄alkylcarbonyl;
R₁₅ and R₂₁ are each independently of the other hydrogen, C₁-C₄alkyl, C₁-C₄haloalkyl, C₃-C₄-alkenyl or C₃-C₄alkynyl;
R₁₇ is hydrogen, C₁-C₄alkyl, C₁-C₄haloalkyl, C₁-C₄alkoxy, C₁-C₄alkylthio, C₁-C₄alkylsulfinyl or C₁-C₄alkylsulfonyl;
R₁₈ is hydrogen, C₁-C₄alkyl, C₁-C₄haloalkyl, C₃-C₄alkenyl, C₃-C₄alkynyl, C₁-C₄alkoxy, C₁-C₄-alkylthio, C₁-C₄alkylsulfinyl, C₁-C₄alkylsulfonyl or di(C₁-C₄)alkoxyalkyl-C₁-C₄alkyl;
R₂₀ is C₁-C₄alkyl, C₃-C₆cycloalkyl, C₃-C₄alkenyl, C₃-C₄alkynyl, C₁-C₄alkylcarbonyl, C₁-C₄alkyl-carbonyloxy, di(C₁-C₄)alkylaminocarbonyl or benzyl, wherein the phenyl group may be substituted one or more times by C₁-C₆alkyl, C₁-C₆haloalkyl, C₁-C₆alkoxy, C₁-C₆haloalkoxy, halogen, cyano, hydroxy or by nitro;
R₁₉ and R₁₆ are each independently of the other hydrogen, C₁-C₄alkyl, C₃-C₆cycloalkyl, C₃-C₄alkenyl, C₃-C₄alkynyl, benzyl or phenyl, wherein phenyl and benzyl may in turn be substituted one or more times by C₁-C₆alkyl, C₁-C₆haloalkyl, C₁-C₆alkoxy, C₁-C₆haloalkoxy, halogen, cyano, hydroxy or by nitro;
or R₁₄ and R₂₂ together form a C₂-C₃alkylene chain;
or R₁₄ and R₁₅ together and/or R₁₇ and R₁₈ together and/or R₂₁ and R₂₂ together form a C₂-C₄alkylene chain, which may be interrupted by oxygen and/or by carbonyl and/or by sulfur, with the proviso that the oxygen and sulfur atoms are separated by at least one methylene group;
or R₁₄ and R₁₈ together form a C₂-C₄alkylene chain; or
R₂₂ and R₁₆ together form a C₂-C₄alkylene chain;
or R₁₈ forms, together with R₂₂ or R₁₄, a direct bond;
or R₁₆ and R₁₈ together form a C₂-C₄alkylene chain;
R₁₃ is hydroxy; O⁻M⁺ wherein M⁺ is an alkali metal cation or an ammonium cation; halogen, C₁-C₁₂alkylsulfonyloxy, amino, C₁-C₄alkylthio, C₁-C₁₂alkylsulfinyl, C₁-C₁₂alkylsulfonyl, C₁-C₁₂-haloalkylthio, C₁-C₁₂haloalkylsulfinyl, C₁-C₁₂haloalkylsulfonyl, C₁-C₆alkoxy-C₁-C₆alkylthio, C₁-C₆alkoxy-C₁-C₆alkylsulfinyl, C₁-C₆alkoxy-C₁-C₆alkylsulfonyl, C₃-C₁₂alkenylthio, C₃-C₁₂-alkenylsulfinyl, C₃-C₁₂alkenylsulfonyl, C₃-C₁₂alkynylthio, C₃-C₁₂alkynylsulfinyl, C₃-C₁₂alkynyl-sulfonyl, C₁-C₄alkoxycarbonyl-C₁-C₄alkylthio, C₁-C₄alkoxycarbonyl-C₁-C₄alkylsulfinyl, C₁-C₄-alkoxycarbonyl-C₁-C₄alkylsulfonyl, (C₁-C₄alkoxy)₂P(O)O, C₁-C₄alkyl-(C₁-C₄alkoxy)P(O)O, H(C₁-C₄alkoxy)P(O)O, R₂₃R₂₄N, R₂₅R₂₆NNH, R₂₇R₂₈NC(O)O—, R₂₉R₃₀NC(O)NH—, C₁-C₁₈alkyl-carbonyloxy, C₂-C₁₈alkenylcarbonyloxy, C₂-C₁₈alkynylcarbonyloxy, C₃-C₆cycloalkylcarbonyloxy, C₁-C₁₂alkoxycarbonyloxy, C₁-C₁₂alkylthiocarbonyloxy or C₁-C₁₂alkylthiocarbamoyl, wherein the alkyl, alkenyl and alkynyl groups may be substituted by halogen, C₁-C₆alkoxy, C₁-C₆alkylthio, C₁-C₆alkylsulfinyl, C₁-C₆alkylsulfonyl or by cyano;
or R₁₃ is phenoxy, phenylthio, phenylsulfinyl, phenylsulfonyl, phenylsulfonylamino, phenyl-sulfonyloxy or benzoyloxy, wherein the phenyl groups may in turn be substituted by one or more halogen, nitro, cyano, C₁-C₄alkyl, C₁-C₄haloalkyl, C₁-C₄alkoxy or C₁-C₄haloalkoxy groups;
or R₁₃ is a group Het₁-thio, Het₂-sulfinyl, Het₃-sulfonyl, Het₄-(CO)O or Het₅-N(R₃₃); wherein Het₁, Het₂, Het₃, Het₄ and Het₅ are each independently of the others a five- to ten-membered, monocyclic or fused bicyclic ring system, which may be aromatic or partially saturated and which may contain from 1 to 4 hetero atoms selected from nitrogen, oxygen and sulfur and wherein each ring system may contain no more than two oxygen atoms and no more than two sulfur atoms and the ring system may itself be substituted by C₁-C₆alkyl, C₁-C₆haloalkyl, C₁-C₆alkoxy, C₁-C₆haloalkoxy, C₁-C₆alkylthio, C₁-C₆alkylsulfinyl, C₁-C₆alkylsulfonyl, di(C₁-C₄alkyl)aminosulfonyl, di(C₁-C₄alkyl)amino, halogen, cyano, nitro or by phenyl, and wherein the substituents on the nitrogen in the heterocyclic ring are other than halogen;
R₂₃, R₂₄, R₂₅, R₂₆, R₂₇, R₂₈, R₂₉, R₃₀ and R₃₃ are each independently of the others hydrogen or C₁-C₆alkyl;
or R₂₃ and R₂₄ together or R₂₅ and R₂₆ together or R₂₇ and R₂₈ together or R₂₉ and R₃₀ together are pyrrolidino, piperidino, morpholino or thiomorpholino, each of which may be mono- or poly-substituted by methyl groups;
or Q is Q₂ 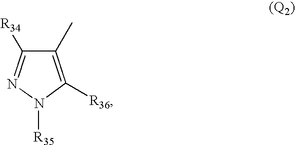
   wherein
R₃₄ is hydrogen, C₁-C₄alkyl, C₁-C₄haloalkyl, C₃-C₆cycloalkyl, C₂-C₄alkenyl, C₂-C₄alkynyl or benzyl, wherein the phenyl group may be substituted one or more times by C₁-C₆alkyl, C₁-C₆haloalkyl, C₁-C₆alkoxy, C₁-C₆haloalkoxy, halogen, cyano, hydroxy or by nitro;
R₃₅ is hydrogen, C₁-C₄alkyl, C₁-C₄haloalkyl, C₃-C₆cycloalkyl, C₃-C₄alkenyl, C₃-C₄alkynyl or benzyl; wherein the phenyl group may be substituted one or more times by C₁-C₆alkyl, C₁-C₆haloalkyl, C₁-C₆alkoxy, C₁-C₆haloalkoxy, halogen, cyano, hydroxy or by nitro;
R₃₆ is hydroxy; O⁻M⁺wherein M⁺is an alkali metal cation or an ammonium cation; halogen, C₁-C₁₂alkylsulfonyloxy, amino, C₁-C₄alkylthio, C₁-C₁₂alkylsulfinyl, C₁-C₁₂alkylsulfonyl, C₁-C₁₂haloalkylthio, C₁-C₁₂haloalkylsulfinyl, C₁-C₁₂haloalkylsulfonyl, C₁-C₆alkoxy-C₁-C₆alkyl-thio, C₁-C₆alkoxy-C₁-C₆alkylsulfinyl, C₁-C₆alkoxy-C₁-C₆alkylsulfonyl, C₃-C₁₂alkenylthio, C₃-C₁₂alkenylsulfinyl, C₃-C₁₂alkenylsulfonyl, C₃-C₁₂alkynylthio, C₃-C₁₂alkynylsulfinyl, C₃-C₁₂alkynylsulfonyl, C₁-C₄alkoxycarbonyl-C₁-C₄alkylthio, C₁-C₄alkoxycarbonyl-C₁-C₄alkyl-sulfinyl, C₁-C₄alkoxycarbonyl-C₁-C₄alkylsulfonyl, (C₁-C₄alkoxy)₂P(O)O, C₁-C₄alkyl-(C₁-C₄alkoxy)P(O)O, H(C₁-C₄alkoxy)P(O)O, R₃₇R₃₈N, R₃₉R₄₀NNH, R₄₁R₄₂NC(O)O—, R₄₃R₄₄NC(O)NH—, C₁-C₁₈alkylcarbonyloxy, C₂-C₁₈alkenylcarbonyloxy, C₂-C₁₆alkynylcarbonyloxy, C₃-C₆cycloalkylcarbonyloxy, C₁-C₁₂alkoxycarbonyloxy, C₁-C₁₂alkylthiocarbonyloxy or C₁-C₁₂alkylthiocarbamoyl, wherein the alkyl, alkenyl and alkynyl groups may be substituted by halogen, C₁-C₆alkoxy, C₁-C₆alkylthio, C₁-C₆alkylsulfinyl, C₁-C₆alkylsulfonyl or by cyano; or R₃₆ is phenoxy, phenylthio, phenylsulfinyl, phenylsulfonyl, phenylsulfonylamino, phenyl-sulfonyloxy or benzoyloxy, wherein the phenyl groups may in turn be substituted one or more times by halogen, nitro, cyano, C₁-C₄alkyl, C₁-C₄haloalkyl, C₁-C₄alkoxy or by C₁-C₄halo-alkoxy,
or R₃₆ is a group Het₇-thio, Het₈-sulfinyl, Het₉-sulfonyl, Het₁₀-(CO)O or Het₁₁-N(R₄₇); wherein Het₇, Het₈, Het₉, Het₁₀ and Het₁₁ are each independently of the others a five- to ten-membered, monocyclic or fused bicyclic ring system, which may be aromatic or partially saturated and which may contain from 1 to 4 hetero atoms selected from nitrogen, oxygen and sulfur and wherein each ring system may contain no more than two oxygen atoms and no more than two sulfur atoms and the ring system may itself be substituted by C₁-C₆alkyl, C₁-C₆haloalkyl, C₁-C₆alkoxy, C₁-C₆haloalkoxy, C₁-C₆alkylthio, C₁-C₆alkylsulfinyl, C₁-C₆alkyl-sulfonyl, di(C₁-C₄alkyl)aminosulfonyl, di(C₁-C₄alkyl)amino, halogen, cyano, nitro or by phenyl, and wherein the substituents on the nitrogen in the heterocyclic ring are other than halogen; R₃₇, R₃₈, R₃₉, R₄₀, R₄₁, R₄₂, R₄₃, R₄₄ and R₄₇ are each independently of the others hydrogen or C₁-C₆alkyl; or
R₃₇ and R₃₈ together or R₃₉ and R₄₀ together or R₄₁ and R₄₂ together or R₄₃ and R₄₄ together are pyrrolidino, piperidino, morpholino or thiomorpholino, each of which may be mono- or poly-substituted by methyl groups;
or Q is Q₃ 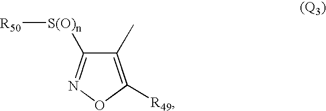
   wherein
R₄₉ is C₁-C₄alkyl, C₁-C₄haloalkyl, C₃-C₆cycloalkyl or halo-substituted C₃-C₆cycloalkyl;
R₅₀ is C₁-C₃alkylene, which may be substituted by halogen, hydroxy, C₁-C₆alkoxy, C₂-C₆-alkenyl, C₂-C₆alkynyl, C₃-C₆cycloalkyl, C₁-C₆alkoxy-C₁-C₆alkoxy, C₁-C₆alkoxy-C₁-C₆alkoxy-C₁-C₆alkoxy, (3-oxetanyl)-oxy, or by (3-oxetanyl)-oxy substituted by C₁-C₆alkyl, or by benzylthio, benzylsulfinyl, benzylsulfonyl, phenyl, phenoxy, phenylthio, phenylsulfinyl or by phenylsulfonyl, wherein the phenyl- and benzyl-containing groups may in turn be substituted by one or more C₁-C₆alkyl, C₁-C₆haloalkyl, C₁-C₆alkoxy, C₁-C₆haloalkoxy, halogen, cyano, hydroxy or nitro groups;
or R₅₀ is phenyl, wherein the phenyl-containing group may in turn be substituted by one or more C₁-C₆alkyl, C₁-C₆haloalkyl, C₁-C₆alkoxy, C₁-C₆haloalkoxy, halogen, cyano, hydroxy or nitro substituents,
or R₅₀ is C₃-C₆cycloalkyl, C₃-C₆cycloalkyl substituted by C₁-C₆alkoxy or by C₁-C₆alkyl, 3-oxetanyl or 3-oxetanyl substituted by C₁-C₆alkyl; and
n is 0, 1 or 2; and also agronomically acceptable salts/N-oxides/isomers/enantiomers of such compounds except for the compound 4-hydroxy-3-[2-(2-methoxyethoxyethoxymethyl)-6-trifluoromethylpyridine-3-carbonyl]-bicyclo[3.2.1]oct-3-en-2-one, and with the provisos that —R₁—X, —R₂ is other than C₁-C₄alkoxy-C₁-C₄alkoxy-C₁-C₄alkyl when
a) Q is Q, wherein A₁ is C(R₁₄R₁₅) and A₂ is C(R₁₇R₁₈), R₁₅, R₁₇ and R₁₈ are hydrogen and R₁₄ and R₂₂ together form a C₂-C₃alkylene chain; and when
b) Q is Q₁, R₁₄ and R₂₂ do not together form a C₂-C₃alkylene chain, A₁ is C(R₁₄R₁₅), or A₁ is NR₁₆ and A₂ is oxygen; and when
c) Q is Q₃, exhibit herbicidal action.

The compounds of formula I and their preparation are known, for example, from WO 01/94339. The compounds of formula I can also be prepared by methods known per se described, for example, in WO 97/46530 or WO 00/15615 or WO 00/39094.

Surprisingly, it has now been found that a combination of variable amounts of active ingredients, that is to say a compound of formula I together with one or more of the active ingredients indicated below, which are known and some of which are also commercially available, exhibits a synergistic action that is capable of controlling, both pre-emergence and post-emergence, the majority of weeds occurring especially in crops of useful plants.

There is therefore proposed in accordance with the present invention a novel synergistic composition for the selective control of weeds which, in addition to comprising customary inert formulation adjuvants, comprises as active ingredient a mixture of
a) a herbicidally effective amount of a compound of formula I 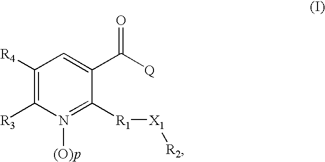
   wherein
p is 0 or 1;
R₁ is a C₁-C₆alkylene, C₃-C₆alkenylene or C₃-C₆alkynylene chain, which may be substituted one or more times by halogen or by R₅, the unsaturated bonds of the chain not being attached directly to the substituent X₁;
X₁ is oxygen, —O(CO)—, —(CO)O—, —O(CO)O—, —N(R₆)—O—, —O—NR₅₁—, thio, sulfinyl, sulfonyl, —SO₂NR₇—, —NR₅₂SO₂— or —NR₈—;
R₂ is a C₁-C₈alkyl, C₃-C₆alkenyl or C₃-C₆alkynyl group, which is substituted one or more times by halogen, hydroxy, amino, formyl, nitro, cyano, mercapto, carbamoyl, C₁-C₆alkoxy, C₁-C₆alkoxycarbonyl, C₂-C₆alkenyl, C₂-C₆haloalkenyl, C₂-C₆alkynyl, C₂-C₆haloalkynyl, C₃-C₆-cycloalkyl, halo-substituted C₃-C₆cycloalkyl, C₃-C₆alkenyloxy, C₃-C₆alkynyloxy, C₁-C₆halo-alkoxy, C₃-C₆haloalkenyloxy, cyano-C₁-C₆alkoxy, C₁-C₆alkoxy-C₁-C₆alkoxy, C₁-C₆alkoxy-C₁-C₆alkoxy-C₁-C₆alkoxy, C₁-C₆alkylthio-C₁-C₆alkoxy, C₁-C₆alkylsulfinyl-C₁-C₆alkoxy, C₁-C₆-alkylsulfonyl-C₁-C₆alkoxy, C₁-C₆alkoxycarbonyl-C₁-C₆alkoxy, C₁-C₆alkoxycarbonyl, C₁-C₆-alkylcarbonyl, C₁-C₆alkylthio, C₁-C₆alkylsulfinyl, C₁-C₆alkylsulfonyl, C₁-C₆haloalkylthio, C₁-C₆haloalkylsulfinyl, C₁-C₆haloalkylsulfonyl, oxiranyl (which may in turn be substituted by C₁-C₆alkyl), (3-oxetanyl)-oxy (which may in turn be substituted by C₁-C₆alkyl), benzylthio, benzylsulfinyl, benzylsulfonyl, C₁-C₆alkylamino, di(C₁-C₆alkyl)amino, R₉S(O)₂O, R₁₀N(R₁₁)SO₂—, rhodano, phenyl, phenoxy, phenylthio, phenylsulfinyl or by phenylsulfonyl; wherein the phenyl- or benzyl-containing groups may in turn be substituted by one or more C₁-C₆alkyl, C₁-C₆haloalkyl, C₁-C₆alkoxy, C₁-C₆haloalkoxy, halogen, cyano, hydroxy or nitro groups, or
R₂ is phenyl, which may be substituted one or more times by C₁-C₆alkyl, C₁-C₆haloalkyl, C₁-C₆alkoxy, C₁-C₆haloalkoxy, halogen, cyano, hydroxy or by nitro; or
R₂ is C₃-C₆cycloalkyl; C₃-C₆cycloalkyl substituted by C₁-C₆alkoxy or by C₁-C₆alkyl; 3-oxetanyl or 3-oxetanyl substituted by C₁-C₆alkyl;
or, when Q is O₂ or Q₃, or when Q is Q, wherein R₁₄ and R₂₂ denote a C₂-C₃alkylene chain, R₂ is additionally a five- to ten-membered, monocyclic or fused bicyclic ring system, which may be aromatic, saturated or partially saturated and which may contain from 1 to 4 hetero atoms selected from nitrogen, oxygen and sulfur, the ring system being bonded to the substituent X₁ directly or via a C₁-C₄alkylene, C₂-C₄alkenyl-C₁-C₄alkylene, C₂-C₄alkynyl-C₁-C₄alkylene, —N(R₁₂)—C₁-C₄alkylene, —SO—C₁-C₄alkylene or —SO₂—C₁-C₄alkylene group, and wherein each ring system may contain no more than two oxygen atoms and no more than two sulfur atoms and the ring system may itself be mono-, di- or tri-substituted by C₁-C₆alkyl, C₁-C₆haloalkyl, C₂-C₆alkenyl, C₂-C₆haloalkenyl, C₂-C₆alkynyl, C₂-C₆haloalkynyl, C₁-C₆alkoxy, hydroxy, C₁-C₆haloalkoxy, C₃-C₆alkenyloxy, C₃-C₆alkynyloxy, mercapto, C₁-C₆alkylthio, C₁-C₆haloalkylthio, C₃-C₆alkenylthio, C₃-C₆haloalkenylthio, C₃-C₆alkynylthio, C₂-C₅alkoxyalkylthio, C₃-C₅acetylalkylthio, C₃-C₆alkoxycarbonylalkylthio, C₂-C₄cyanoalkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₂alkylaminosulfonyl, di(C₁-C₂alkyl)aminosulfonyl, di(C₁-C₄alkyl)amino, halogen, cyano, nitro, phenyl or by benzylthio, wherein phenyl and benzylthio may in turn be substituted on the phenyl ring by C₁-C₃alkyl, C₁-C₃haloalkyl, C₁-C₃alkoxy, C₁-C₃haloalkoxy, halogen, cyano or by nitro, and wherein the substituents on the nitrogen in the heterocyclic ring are other than halogen; or
R₂ is hydrogen or unsubstituted C₁-C₈alkyl, when either
a) R₁ is substituted by the group R₅, or
b) Q is the group Q₂, or
c) Q is the group Q₃ wherein X₁ is —O(CO)—, —(CO)O—, —N(R₆)—O—, —O—NR₅₁—, —SO₂NR₇—, —NR₅₂SO₂— or —NR₈—; or
d) Q is the group Q₁ wherein X₁ is —N(R₆)—O—, —O—NR₅₁—, —SO₂NR₇—, —NR₅₂SO₂— or —NR₈—, or
e) Q is the group Q₁ wherein R₁₄ and R₂₂ in Q₁ denote a C₂-C₃alkylene chain and X₁ is —O(CO)— or —(CO)O—;
R₃ is C₁-C₃haloalkyl;
R₄ is hydrogen, halogen, C₁-C₃alkyl, C₁-C₃haloalkyl, C₁-C₃alkoxy, C₁-C₃alkoxy-C₁-C₃alkyl or C₁-C₃alkoxy-C₁-C₃alkoxy;
R₅ is hydroxy, C₁-C₆alkoxy, C₃-C₆Cycloalkyloxy, C₁-C₆alkoxy-C₁-C₆alkoxy, C₁-C₆alkoxy-C₁-C₆alkoxy-C₁-C₆alkoxy or C₁-C₂alkylsulfonyloxy;
R₆, R₇, R₈, R₉, R₁₀, R₁₁, R₁₂, R₅₁ and R₅₂ are each independently of the others hydrogen, C₁-C₆alkyl, C₁-C₆haloalkyl, C₁-C₆alkoxycarbonyl, C₁-C₆alkylcarbonyl, C₁-C₆alkoxy-C₁-C₆alkyl, C₁-C₆alkoxy-C₁-C₆alkyl substituted by C₁-C₆alkoxy, benzyl, or phenyl, wherein phenyl and benzyl may in turn be substituted one or more times by C₁-C₆alkyl, C₁-C₆haloalkyl, C₁-C₆-alkoxy, C₁-C₆haloalkoxy, halogen, cyano, hydroxy or by nitro; wherein R₆ is not hydrogen when R₉ is hydrogen, C₁-C₆alkoxycarbonyl or C₁-C₆alkylcarbonyl;
Q is Q₁ 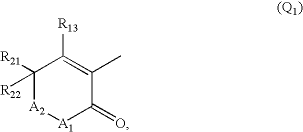
   wherein
A₁ is C(R₁₄R₁₅), NR₁₆ or oxygen;
A₂ is C(R₁₇R₁₈), C(O), —C═N—O—R₁₉, oxygen, thio, sulfinyl, sulfonyl, —NR₂₀ or ethylene; with the provisos that A₁ is other than oxygen when A₂ is oxygen, C(O), thio, sulfinyl, —C═N—O—R₁₉, NR₂₀ or C(R₁₇R₁₈), R₁₇ and R₁₈ being each independently of the other C₁-C₄alkoxy, C₁-C₄-alkylthio, C₁-C₄alkylsulfinyl or C₁-C₄alkylsulfonyl; and that A₁ is other than NR₁₆ when A₂ is thio, sulfinyl or C(R₁₇R₁₈), R₁₇ and R₁₈ being each independently of the other C₁-C₄alkoxy, C₁-C₄alkylthio, C₁-C₄alkylsulfinyl or C₁-C₄alkylsulfonyl;
R₁₄ and R₂₂ are each independently of the other hydrogen, C₁-C₄alkyl, C₁-C₄haloalkyl, C₃-C₄-alkenyl, C₃-C₄alkynyl, C₁-C₄alkylthio, C₁-C₄alkylsulfinyl, C₁-C₄alkylsulfonyl, C₁-C₄alkylsulfonyl-oxy, C₁-C₄alkoxy, C₁-C₄alkoxycarbonyl or C₁-C₄alkylcarbonyl;
R₁₅ and R₂₁ are each independently of the other hydrogen, C₁-C₄alkyl, C₁-C₄haloalkyl, C₃-C₄-alkenyl or C₃-C₄alkynyl;
R₁₇ is hydrogen, C₁-C₄alkyl, C₁-C₄haloalkyl, C₁-C₄alkoxy, C₁-C₄alkylthio, C₁-C₄alkylsulfinyl or C₁-C₄alkylsulfonyl;
R₁₈ is hydrogen, C₁-C₄alkyl, C₁-C₄haloalkyl, C₃-C₄alkenyl, C₃-C₄alkynyl, C₁-C₄alkoxy, C₁-C₄-alkylthio, C₁-C₄alkylsulfinyl, C₁-C₄alkylsulfonyl or di(C₁-C₄)alkoxyalkyl-C₁-C₄alkyl;
R₂₀ is C₁-C₄alkyl, C₃-C₆cycloalkyl, C₃-C₄alkenyl, C₃-C₄alkynyl, C₁-C₄alkylcarbonyl, C₁-C₄alkyl-carbonyloxy, di(C₁-C₄)alkylaminocarbonyl or benzyl, wherein the phenyl group may be substituted one or more times by C₁-C₆alkyl, C₁-C₆haloalkyl, C₁-C₆alkoxy, C₁-C₆haloalkoxy, halogen, cyano, hydroxy or by nitro;
R₁₉ and R₁₆ are each independently of the other hydrogen, C₁-C₄alkyl, C₃-C₆cycloalkyl, C₃-C₄alkenyl, C₃-C₄alkynyl, benzyl or phenyl, wherein phenyl and benzyl may in turn be substituted one or more times by C₁-C₆alkyl, C₁-C₆haloalkyl, C₁-C₆alkoxy, C₁-C₆haloalkoxy, halogen, cyano, hydroxy or by nitro;
or R₁₄ and R₂₂ together form a C₂-C₃alkylene chain;
or R₁₄ and R₁₅ together and/or R₁₇ and R₁₈ together and/or R₂₁ and R₂₂ together form a C₂-C₄alkylene chain, which may be interrupted by oxygen and/or by carbonyl and/or by sulfur, with the proviso that the oxygen and sulfur atoms are separated by at least one methylene group;
or R₁₄ and R₁₈ together form a C₂-C₄alkylene chain; or
R₂₂ and R₁₈ together form a C₂-C₄alkylene chain;
or R₁₈ forms, together with R₂₂ or R₁₄, a direct bond;
or R₁₆ and R₁₈ together form a C₂-C₄alkylene chain;
R₁₃ is hydroxy; O⁻M⁺ wherein M⁺ is an alkali metal cation or an ammonium cation; halogen, C₁-C₁₂alkylsulfonyloxy, amino, C₁-C₄alkylthio, C₁-C₁₂alkylsulfinyl, C₁-C₁₂alkylsulfonyl, C₁-C₁₂-haloalkylthio, C₁-C₁₂haloalkylsulfinyl, C₁-C₁₂haloalkylsulfonyl, C₁-C₆alkoxy-C₁-C₆alkylthio, C₁-C₆alkoxy-C₁-C₆alkylsulfinyl, C₁-C₆alkoxy-C₁-C₆alkylsulfonyl, C₃-C₁₂alkenylthio, C₃-C₁₂-alkenylsulfinyl, C₃-C₁₂alkenylsulfonyl, C₃-C₁₂alkynylthio, C₃-C₁₂alkynylsulfinyl, C₃-C₁₂alkynyl-sulfonyl, C₁-C₄alkoxycarbonyl-C₁-C₄alkylthio, C₁-C₄alkoxycarbonyl-C₁-C₄alkylsulfinyl, C₁-C₄-alkoxycarbonyl-C₁-C₄alkylsulfonyl, (C₁-C₄alkoxy)₂P(O)O, C₁-C₄alkyl-(C₁-C₄alkoxy)P(O)O, H(C₁-C₄alkoxy)P(O)O, R₂₃R₂₄N, R₂₅R₂₆NNH, R₂₇R₂₈NC(O)O—, R₂₉R₃₀NC(O)NH—, C₁-C₁₈alkyl-carbonyloxy, C₂-C₁ alkenylcarbonyloxy, C₂-C₁₈alkynylcarbonyloxy, C₃-C₆cycloalkylcarbonyl-oxy, C₁-C₁₂alkoxycarbonyloxy, C₁-C₁₂alkylthiocarbonyloxy or C₁-C₁₂alkylthiocarbamoyl, wherein the alkyl, alkenyl and alkynyl groups may be substituted by halogen, C₁-C₆alkoxy, C₁-C₆alkylthio, C₁-C₆alkylsulfinyl, C₁-C₆alkylsulfonyl or by cyano;
or R₁₃ is phenoxy, phenylthio, phenylsulfinyl, phenylsulfonyl, phenylsulfonylamino, phenyl-sulfonyloxy or benzoyloxy, wherein the phenyl groups may in turn be substituted by one or more halogen, nitro, cyano, C₁-C₄alkyl, C₁-C₄haloalkyl, C₁-C₄alkoxy or C₁-C₄haloalkoxy groups;
or R₁₃ is a group Het₁-thio, Het₂-sulfinyl, Het₃-sulfonyl, Het₄-(CO)O or Het₅-N(R₃₃); wherein Het₁, Het₂, Het₃, Het₄ and Het₅ are each independently of the others a five- to ten-membered, monocyclic or fused bicyclic ring system, which may be aromatic or partially saturated and which may contain from 1 to 4 hetero atoms selected from nitrogen, oxygen and sulfur and wherein each ring system may contain no more than two oxygen atoms and no more than two sulfur atoms and the ring system may itself be substituted by C₁-C₆alkyl, C₁-C₆haloalkyl, C₁-C₆alkoxy, C₁-C₆haloalkoxy, C₁-C₆alkylthio, C₁-C₆alkylsulfinyl, C₁-C₆alkylsulfonyl, di(C₁-C₄alkyl)aminosulfonyl, di(C₁-C₄alkyl)amino, halogen, cyano, nitro or by phenyl, and wherein the substituents on the nitrogen in the heterocyclic ring are other than halogen;
R₂₃, R₂₄, R₂₅, R₂₆, R₂₇, R₂₈, R₂₉, R₃₀ and R₃₃ are each independently of the others hydrogen or C₁-C₆alkyl;
or R₂₃ and R₂₄ together or R₂₅ and R₂₆ together or R₂₇ and R₂₈ together or R₂₉ and R₃₀ together are pyrrolidino, piperidino, morpholino or thiomorpholino, each of which may be mono- or poly-substituted by methyl groups;
or Q is Q₂ 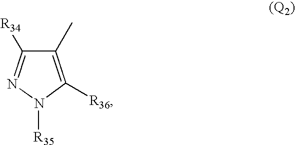
   wherein
R₃₄ is hydrogen, C₁-C₄alkyl, C₁-C₄haloalkyl, C₃-C₆cycloalkyl, C₂-C₄alkenyl, C₂-C₄alkynyl or benzyl, wherein the phenyl group may be substituted one or more times by C₁-C₆alkyl, C₁-C₆haloalkyl, C₁-C₆alkoxy, C₁-C₆haloalkoxy, halogen, cyano, hydroxy or by nitro;
R₃₅ is hydrogen, C₁-C₄alkyl, C₁-C₄haloalkyl, C₃-C₆cycloalkyl, C₃-C₄alkenyl, C₃-C₄alkynyl or benzyl, wherein the phenyl group may be substituted one or more times by C₁-C₆alkyl, C₁-C₆haloalkyl, C₁-C₆alkoxy, C₁-C₆haloalkoxy, halogen, cyano, hydroxy or by nitro;
R₃₆ is hydroxy; O⁻M⁺ wherein M⁺ is an alkali metal cation or an ammonium cation; halogen, C₁-C₁₂alkylsulfonyloxy, amino, C₁-C₄alkylthio, C₁-C₁₂alkylsulfinyl, C₁-C₁₂alkylsulfonyl, C₁-C₁₂haloalkylthio, C₁-C₁₂haloalkylsulfinyl, C₁-C₁₂haloalkylsulfonyl, C₁-C₆alkoxy-C₁-C₆alkyl-thio, C₁-C₆alkoxy-C₁-C₆alkylsulfinyl, C₁-C₆alkoxy-C₁-C₆alkylsulfonyl, C₃-C₁₂alkenylthio, C₃-C₁₂alkenylsulfinyl, C₃-C₁₂alkenylsulfonyl, C₃-C₁₂alkynylthio, C₃-C₁₂alkynylsulfinyl, C₃-C₁₂alkynylsulfonyl, C₁-C₄alkoxycarbonyl-C₁-C₄alkylthio, C₁-C₄alkoxycarbonyl-C₁-C₄alkyl-sulfinyl, C₁-C₄alkoxycarbonyl-C₁-C₄alkylsulfonyl, (C₁-C₄alkoxy)₂P(O)O, C₁-C₄alkyl-(C₁-C₄alkoxy)P(O)O, H(C₁-C₄alkoxy)P(O)O, R₃₇R₃₈N, R₃₉R₄₀NNH, R₄₁R₄₂NC(O)O—, R₄₃R₄₄NC(O)N H—, C, —C₁₋₈alkylcarbonyloxy, C₂-C₁₈alkenylcarbonyloxy, C₂-C₁₈alkynylcarbonyloxy, C₃-C₆cycloalkylcarbonyloxy, C₁-C₁₂alkoxycarbonyloxy, C₁-C₁₂alkylthiocarbonyloxy or C₁-C₁₂alkylthiocarbamoyl, wherein the alkyl, alkenyl and alkynyl groups may be substituted by halogen, C₁-C₆alkoxy, C₁-C₆alkylthio, C₁-C₆alkylsulfinyl, C₁-C₆alkylsulfonyl or by cyano; or R₃₆ is phenoxy, phenylthio, phenylsulfinyl, phenylsulfonyl, phenylsulfonylamino, phenyl-sulfonyloxy or benzoyloxy, wherein the phenyl groups may in turn be substituted one or more times by halogen, nitro, cyano, C₁-C₄alkyl, C₁-C₄haloalkyl, C₁-C₄alkoxy or by C₁-C₄halo-alkoxy,
or R₃₆ is a group Het₇-thio, Het₈-sulfinyl, Het₉-sulfonyl, Het₁₀-(CO)O or Het₁₁-N(R₄₇); wherein Het₇, Het₈, Het₉, Het₁₀ and Het₁₁ are each independently of the others a five- to ten-membered, monocyclic or fused bicyclic ring system, which may be aromatic or partially saturated and which may contain from 1 to 4 hetero atoms selected from nitrogen, oxygen and sulfur and wherein each ring system may contain no more than two oxygen atoms and no more than two sulfur atoms and the ring system may itself be substituted by C₁-C₆alkyl, C₁-C₆haloalkyl, C₁-C₆alkoxy, C₁-C₆haloalkoxy, C₁-C₆alkylthio, C₁-C₆alkylsulfinyl, C₁-C₆alkyl-sulfonyl, di(C₁-C₄alkyl)aminosulfonyl, di(C₁-C₄alkyl)amino, halogen, cyano, nitro or by phenyl, and wherein the substituents on the nitrogen in the heterocyclic ring are other than halogen; R₃₇, R₃₈, R₃₉, R₄₀, R₄₁, R₄₂, R₄₃, R₄₄ and R₄₇ are each independently of the others hydrogen or C₁-C₆alkyl; or
R₃₇ and R₃₈ together or R₃₉ and R₄₀ together or R₄₁ and R₄₂ together or R₄₃ and R₄₄ together are pyrrolidino, piperidino, morpholino or thiomorpholino, each of which may be mono- or poly-substituted by methyl groups;
or Q is Q₃ 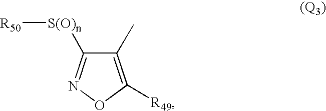
   wherein
R₄₉ is C₁-C₄alkyl, C₁-C₄haloalkyl, C₃-C₆cycloalkyl or halo-substituted C₃-C₆cycloalkyl;
R₅₀ is C₁-C₃alkylene, which may be substituted by halogen, hydroxy, C₁-C₆alkoxy, C₂-C₆-alkenyl, C₂-C₆alkynyl, C₃-C₆cycloalkyl, C₁-C₆alkoxy-C₁-C₆alkoxy, C₁-C₆alkoxy-C₁-C₆alkoxy-C₁-C₆alkoxy, (3-oxetanyl)-oxy, or by (3-oxetanyl)-oxy substituted by C₁-C₆alkyl, or by benzylthio, benzylsulfinyl, benzylsulfonyl, phenyl, phenoxy, phenylthio, phenylsulfinyl or by phenylsulfonyl, wherein the phenyl- and benzyl-containing groups may in turn be substituted by one or more C₁-C₆alkyl, C₁-C₆haloalkyl, C₁-C₆alkoxy, C₁-C₆haloalkoxy, halogen, cyano, hydroxy or nitro groups;
or R₅₀ is phenyl, wherein the phenyl-containing group may in turn be substituted by one or more C₁-C₆alkyl, C₁-C₆haloalkyl, C₁-C₆alkoxy, C₁-C₆haloalkoxy, halogen, cyano, hydroxy or nitro substituents,
or R₅₀ is C₃-C₆cycloalkyl, C₃-C₆cycloalkyl substituted by C₁-C₆alkoxy or by C₁-C₆alkyl, 3-oxetanyl or 3-oxetanyl substituted by C₁-C₆alkyl; and
n is 0, 1 or 2; or of an agronomically acceptable salt/N-oxide/isomer/enantiomer of such a compound except for the compound 4-hydroxy-3-[2-(2-methoxyethoxyethoxymethyl)-6-trifluoromethylpyridine-3-carbonyl]-bicyclo[3.2.1]oct-3-en-2-one, and with the provisos that —R₁—X₁—R₂ is other than C₁-C₄alkoxy-C₁-C₄alkoxy-C₁-C₄alkyl when
a) Q is Q₁ wherein A₁ is C(R₁₄R₁₅) and A₂ is C(R₁₇R₁₈), R₁₅, R₁₇ and R₁₈ are hydrogen and R₁₄ and R₂₂ together form a C₂-C₃alkylene chain; and when
b) Q is Q₁, R₁₄ and R₂₂ do not together form a C₂-C₃alkylene chain, A₁ is C(R₁₄R₁₅), or A₁ is NR₁₆ and A₂ is oxygen; and when
c) Q is Q₃,
and
b) a synergistically effective amount of one or more compounds selected from a compound of formula 2.1 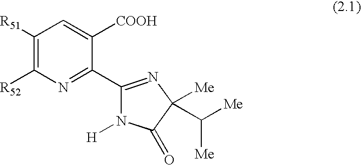
   wherein R₅₁ is CH₂—OMe, ethyl or hydrogen;
R₅₂ is hydrogen, or R₅₁ and R₅₂ together are the group —CH═CH—CH═CH—; and a compound of formula 2.2 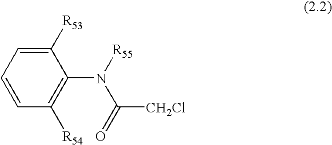
   wherein R₅₃ is ethyl, R₅₄ is methyl or ethyl, and R₅₅ is —CH(Me)—CH₂OMe, <S>—CH(Me)—CH₂OMe, CH₂OMe or CH₂O—CH₂CH₃; and a compound of formula 2.3 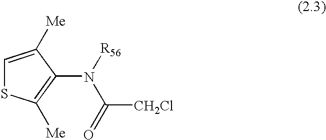
   wherein R₅₆ is CH(Me)—CH₂OMe or <S>CH(Me)—CH₂OMe; and a compound of formula 2.4 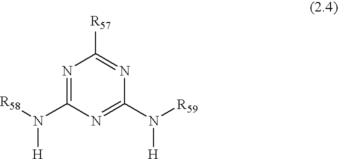
   wherein R₅₇ is chlorine, methoxy or methylthio, R₅₈ is ethyl or isopropyl, and R₅₉ is ethyl, isopropyl, —C(CN)(CH₃)—CH₃ or tert-butyl;
and a compound of formula 2.5 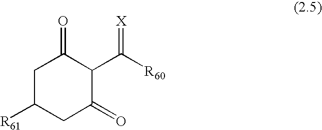
   wherein R₆₀ is ethyl or n-propyl, R₆₁ is COO⁻½ Ca⁺⁺, —CH₂—CH(Me)S—CH₂CH₃, the group 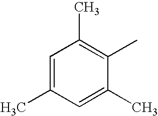
   or the group 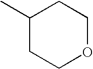
   and X is oxygen, N—O—CH₂CH₃ or N—O—CH₂CH═CH—Cl;
and a compound of formula 2.6 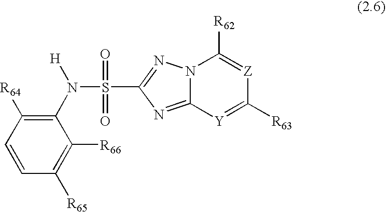
   wherein R₆₂ is hydrogen, methoxy or ethoxy, R₆₃ is hydrogen, methyl, methoxy or fluorine, R₆₄ is COOMe, fluorine or chlorine, R₆₅ is hydrogen or methyl, Y is methine, C—F or nitrogen, Z is methine or nitrogen, and R₆₆ is fluorine or chlorine;
and a compound of formula 2.7 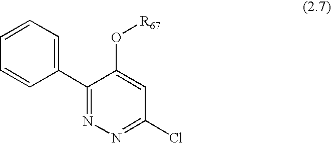
   wherein R₆₇ is hydrogen or —C(O)—S-n-octyl;
and a compound of formula 2.8 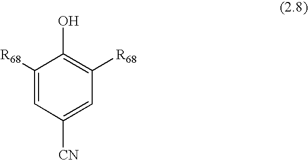
   wherein R₆₈ is either bromine or iodine;
and a compound of formula 2.9 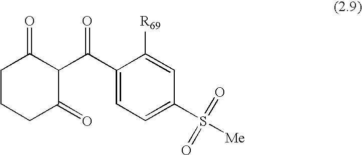
   wherein R₆₉ is chlorine or nitro;
and a compound of formula 2.10 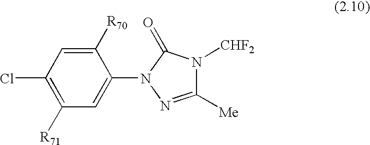
   wherein R₇₀ is fluorine or chlorine, and R₇₁ is —CH₂—CH(Cl)—COOCH₂CH₃ or —NH—SO₂Me;
and a compound of formula 2.11 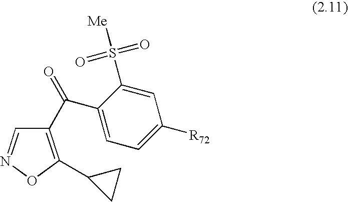
   wherein R₇₂ is trifluoromethyl or chlorine;
and a compound of formula 2.12 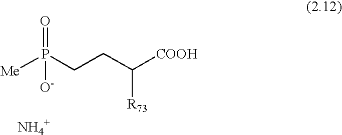
   wherein R₇₃ is NH₂ or <S>NH₂;
and a compound of formula 2.13 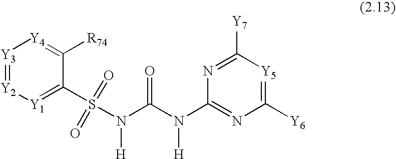
   wherein Y₂ is nitrogen, methine, C—NH—CHO, C—CH₂—NH—SO₂CH₃ or N-Me, Y₁ is nitrogen, methine, C—Cl or C—I, Y₃ is methine, Y₄ is methine or Y₃ and Y₄ together are sulfur or C—Cl, Y₅ is nitrogen or methine, Y₆ is methyl, difluoromethoxy, trifluoromethyl or methoxy, Y₇ is methoxy or difluoromethoxy and R₇₄ is CONMe₂, COOMe, COOC₂H₅, trifluoromethyl, CH₂—CH₂CF₃, O—CH₂—CH₂C₁ or SO₂CH₂CH₃, or a sodium salt thereof (“Me” being in each case the methyl group);
and the compound of formula 2.13.c 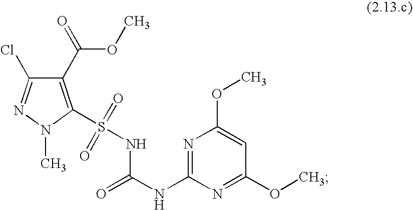
   and the compound of formula 2.14 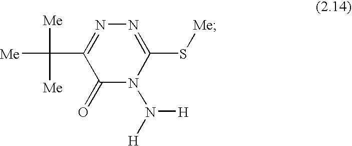
   and the compound of formula 2.15 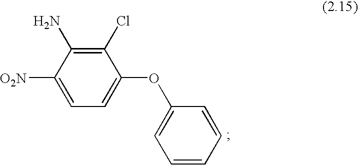
   and the compound of formula 2.16 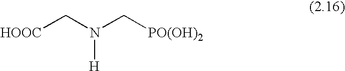
   and ammonium, isopropylammonium, sodium and trimesium salts thereof;
and the compound of formula 2.17 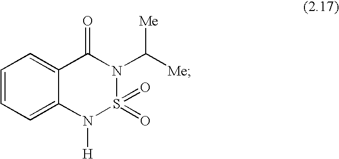
   and the compound of formula 2.18 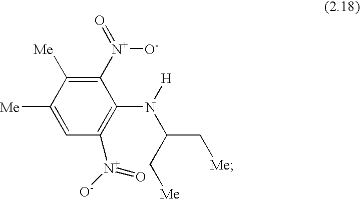
   and the compound of formula 2.19 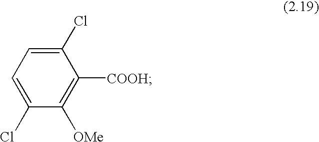
   and the compound of formula 2.20 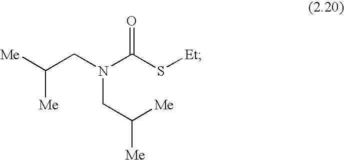
   and the compound of formula 2.21 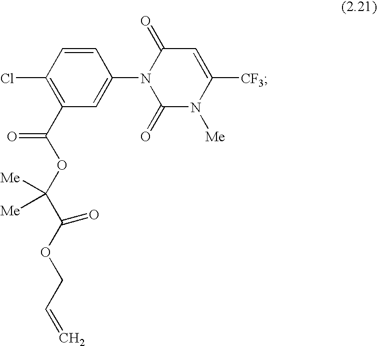
   and the compound of formula 2.22 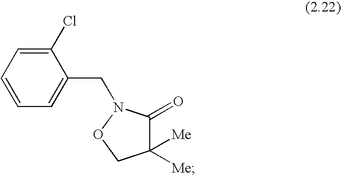
   and the compound of formula 2.23 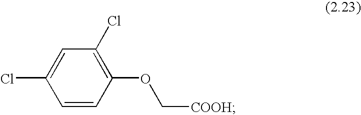
   and the compound of formula 2.24 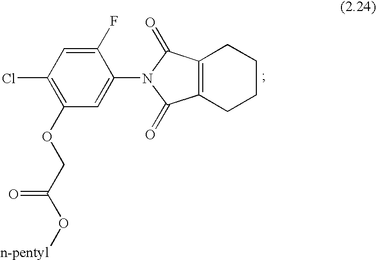
   and the compound of formula 2.25 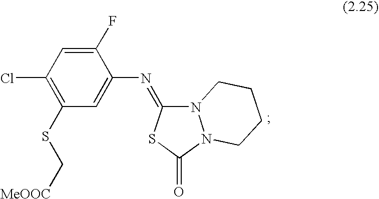
   and the compound of formula 2.26 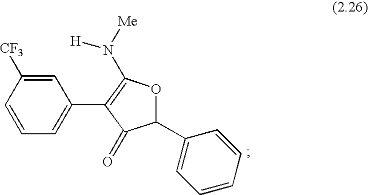
   and the compound of formula 2.27 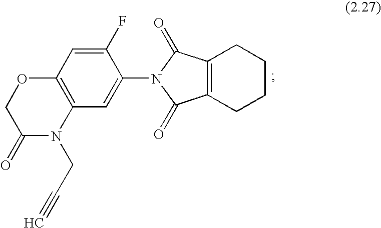
   and the compound of formula 2.28 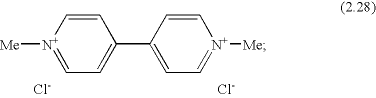
   the compound of formula 2.29 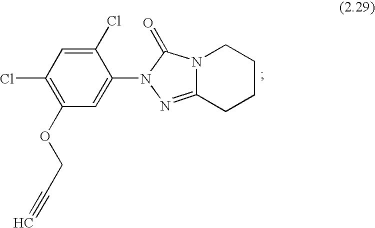
   and the compound of formula 2.30 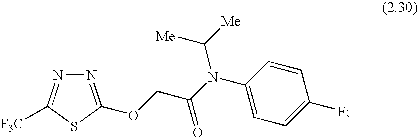
   and the compound of formula 2.31 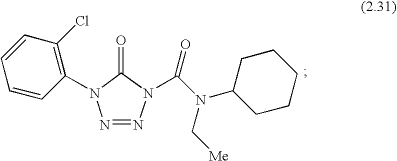
   and the compound of formula 2.32 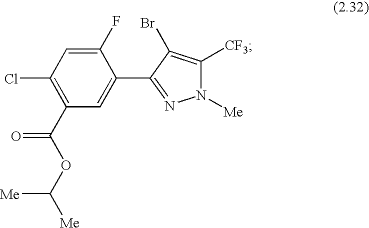
   and the compound of formula 2.33 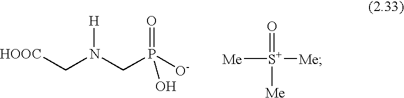
   and the compound of formula 2.34 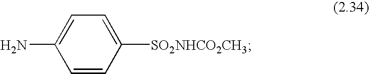
   and the compound of formula 2.35 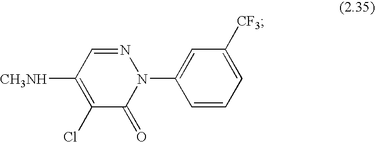
   and the compound of formula 2.36 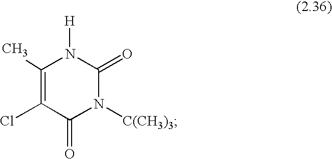
   and the compound of formula 2.37 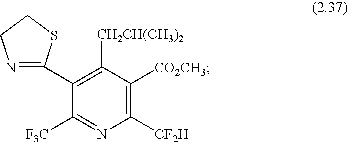
   and the compound of formula 2.38 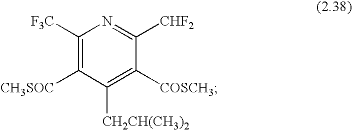
   and the compound of formula 2.39 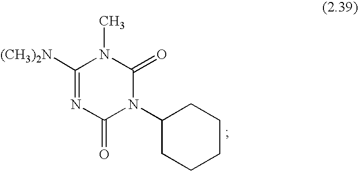
   and the compound of formula 2.40 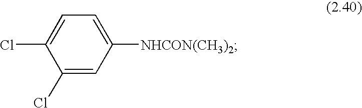
   and the compound of formula 2.41 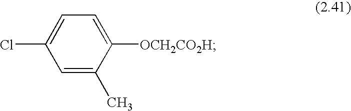
   and the compound of formula 2.42 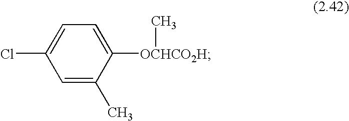
   and the compound of formula 2.43 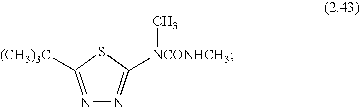
   and the compound of formula 2.44 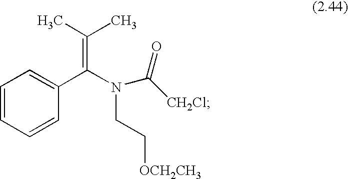
   and the compound of formula 2.45 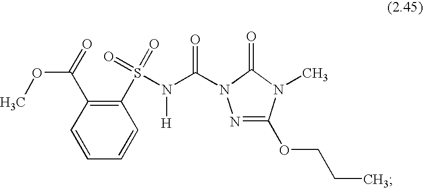
   and the compound of formula 2.46 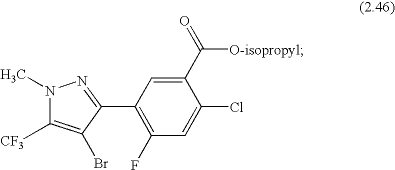
   and the compound of formula 2.47 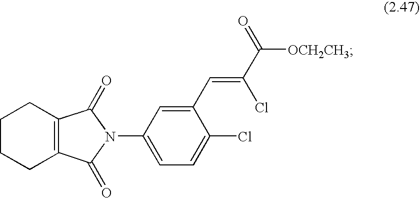
   and the compound of formula 2.48 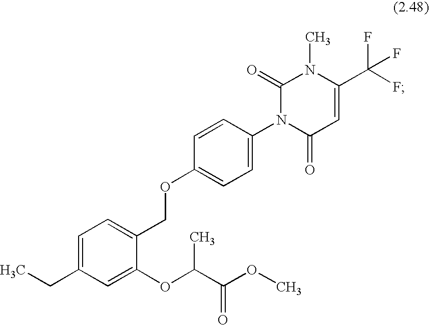
   and the compound of formula 2.49 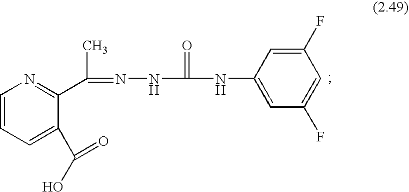
   and the compound of formula 2.50 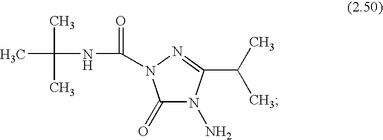
   and the compound of formula 2.51 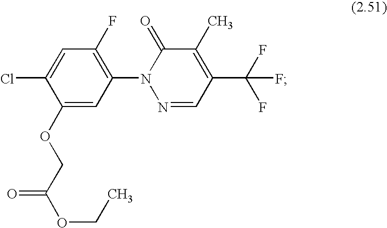
   and a compound of formula 2.52 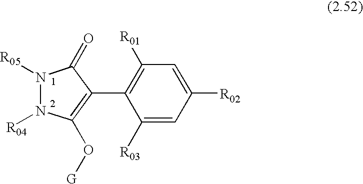
   wherein
R₀₁, R₀₂ and R₀₃ are each independently of the others halogen, nitro, cyano, C₁-C₄alkyl, C₂-C₄alkenyl, C₂-C₄alkynyl, C₁-C₄haloalkyl, C₂-C₆haloalkenyl, C₃-C₆cycloalkyl, halo-substituted C₃-C₆cycloalkyl, C₁-C₆alkoxyalkyl, C₁-C₆alkylthioalkyl, hydroxy, mercapto, C₁-C₆alkoxy, C₃-C₆alkenyloxy, C₃-C₆alkynyloxy, C₁-C₄alkylcarbonyl, C₁-C₄alkoxycarbonyl, C₁-C₄alkylthio, C₁-C₄alkylsulfinyl, C₁-C₄alkylsulfonyl, amino, C₁-C₄alkylamino or di(C₁-C₄alkyl)amino;
R₀₄ and R₀₅ together are a group
   —C—R₀₆(R₀₇)—O—C—R₀₈(R₀₉)—C—R₀₁₀(R₀₁₁)—C—R₀₁₂(R₀₁₃)— (Z₁),
   —C—R₀₁₄(R₀₁₅)—C—R₀₁₆(R₀₁₇)—O—C—R₀₁₈(R₀₁₉)—C—R₀₂₀(R₀₂₁)— (Z₂) or
   —C—R₀₂₂(R₀₂₃)—C—R₀₂₄(R₀₂₅)—C—R₀₂₆(R₀₂₇)—O—C—R₀₂₈(R₀₂₉)— (Z₃),
   wherein R₀₆, R₀₇, R₀₈, R₀₉, R₀₁₀, R₀₁₁, R₀₁₂, R₀₁₃, R₀₁₄, R₀₁₅, R₀₁₆, R₀₁₇, R₀₁₈, R₀₁₉, R₀₂₀, R₀₂₁, R₀₂₂, R₀₂₃, R₀₂₄, R₀₂₅, R₀₂₆, R₀₂₇, R₀₂₈ and R₀₂₉ are, each independently of the others, hydrogen, halogen, C₁-C₄alkyl or C₁-C₄haloalkyl, it being possible for an alkylene ring, which together with the carbon atoms of the group Z₁, Z₂ or Z₃ contains from 2 to 6 carbon atoms and which may be interrupted by oxygen, to be either fused or spiro-bound to the carbon atoms of the group Z₁, Z₂ or Z₃ or that alkylene ring bridges at least one ring atom of the group Z₁, Z₂ or Z₃;
G is hydrogen, —C(X₁)—R₀₃₀, —C(X₂)—X₃—R₀₃₁, —C(X₄)—N(R₀₃₂)—R₀₃₃, —SO₂—R₀₃₄, an alkali metal cation, alkaline earth metal cation, sulfonium cation or ammonium cation or —P(X₅)(R₀₃₅)—R₀₃₆; X₁, X₂, X₃, X₄ and X₅ are each independently of the others oxygen or sulfur; and R₀₃₀, R₀₃₁, R₀₃₂, R₀₃₃, R₀₃₄, R₀₃₅ and R₀₃₆ are each independently of the others hydrogen, C₁-C₅alkyl, C₁-C₅haloalkyl, C₂-C₅alkenyl, C₁-C₅alkoxyalkyl, C₃-C₆cycloalkyl or phenyl, and R₀₃₄ may additionally be C₂-C₂₀alkenyl; C₂-C₂₀alkenyl substituted by halogen, C₁-C₆alkylcarbonyl, C₁-C₆alkoxycarbonyl, C₁-C₆alkylcarbonyloxy, C₁-C₆alkoxy, C₁-C₆thioalkyl, C₁-C₆alkylthiocarbonyl, C₁-C₆alkylcarbonylthio, C₁-C₆alkylsulfonyl, C₁-C₆alkylsulfoxyl, C₁-C₆alkylaminosulfonyl, C₁-C₆(di)alkylaminosulfonyl, C₁-C₆C₁-C₆ alkylsulfonyloxy, C₁-C₆alkyl-sulfonylamino, C₁-C₆alkylamino, C₁-C₆(di)alkylamino, C₁-C₆alkylcarbonylamino, di-C₁-C₆ alkylcarbonylamino, C₁-C₆alkylalkylcarbonylamino, cyano, (C₃-C₇)cycloalkyl, (C₃-C₇)heterocyclyl, tri-C₁-C₆alkylsilyl, tri-C₁-C₆alkylsilyloxy, phenyl or heteroaryl; or R₀₃₄ is C₂-C₂₀alkynyl; C₂-C₂₀alkynyl substituted by halogen, C₁-C₆alkylcarbonyl, C₁-C₆ alkoxycarbonyl, C₁-C₆alkylcarbonyloxy, C₁-C₆alkoxy, C₁-C₆thioalkyl, C₁-C₆alkylthiocarbonyl, C₁-C₆alkylcarbonylthio, C₁-C₆alkylsulfonyl, C₁-C₆alkylsulfoxyl, C₁-C₆alkylaminosulfonyl, di-C₁-C₆ alkylaminosulfonyl, C₁-C₆alkylsulfonyloxy, C₁-C₆alkylsulfonylamino, C₁-C₆alkylamino, di-C₁-C₆alkylamino, C₁-C₆alkylcarbonylamino, di-C₁-C₆alkylcarbonylamino, C₁-C₆alkylcarbonylamino, cyano, (C₃-C₇)cycloalkyl, (C₃-C₇)heterocyclyl, tri-C₁-C₆alkylsilyl, tri-C₁-C₆alkylsilyloxy, phenyl or heteroaryl; or R₀₃₄ is (C₁-C₇)cycloalkyl; (C₁-C₇)cycloalkyl substituted by halogen, haloalkyl, C₁-C₆alkyl, C₁-C₆alkoxy, C₁-C₆alkylcarbonyloxy, C₁-C₆thioalkyl, C₁-C₆alkylcarbonylthio, C₁-C₆alkylamino, C₁-C₆alkylcarbonylamino, tri-C₁-C₆alkylsilyl or by tri-C₁-C₆alkylsilyloxy; or R₀₃₄ is heteroaryl; heteroaryl substituted by halogen, C₁-C₆haloalkyl, nitro, cyano, C₁-C₆alkyl, C₁-C₆alkoxy, C₁-C₆alkylcarbonyloxy, C₁-C₆thioalkyl, C₁-C₆alkylcarbonylthio, C₁-C₆alkylamino, C₁-C₆alkylcarbonylamino, tri-C₁-C₆alkylsilyl or by tri-C₁-C₆alkylsilyloxy; heteroaryloxy, heteroarylthio, heteroarylamino, di-heteroarylamino, phenylamino, diphenylamino, C₂-C₆cycloalkylamino, di-C₂-C₆cycloalkylamino or C₂-C₆cycloalkoxy and salts and diastereoisomers of compounds of formula 2.52;
and the compound of formula 2.53 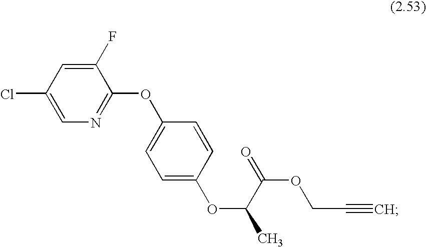
   and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin.

In the above formulae, “Me” is a methyl group.

The invention also includes the salts that the compounds of formula I are able to form with amines, alkali metal and alkaline earth metal bases or quaternary ammonium bases. Among the alkali metal and alkaline earth metal hydroxides used as salt formers, emphasis is to be given to the hydroxides of lithium, sodium, potassium, magnesium and calcium, but especially to those of sodium and potassium.

Examples of suitable amines for ammonium salt formation that come into consideration are ammonia as well as primary, secondary and tertiary C₁-C₁₈alkylamines, C₁-C₄hydroxyalkyl-amines and C₂-C₄alkoxyalkylamines, for example methylamine, ethylamine, n-propylamine, isopropylamine, the four butylamine isomers, n-amylamine, isoamylamine, hexylamine, heptylamine, octylamine, nonylamine, decylamine, pentadecylamine, hexadecylamine, heptadecylamine, octadecylamine, methyl-ethylamine, methyl-isopropylamine, methyl-hexylamine, methyl-nonylamine, methyl-pentadecylamine, methyl-octadecylamine, ethyl-butylamine, ethyl-heptylamine, ethyl-octylamine, hexyl-heptylamine, hexyl-octylamine, dimethylamine, diethylamine, di-n-propylamine, diisopropylamine, di-n-butylamine, di-n-amylamine, diisoamylamine, dihexylamine, diheptylamine, dioctylamine, ethanolamine, n-propanolamine, isopropanolamine, N,N-diethanolamine, N-ethylpropanolamine, N-butyl-ethanolamine, allylamine, n-butenyl-2-amine, n-pentenyl-2-amine, 2,3-dimethylbutenyl-2-amine, dibutenyl-2-amine, n-hexenyl-2-amine, propylenediamine, trimethylamine, triethyl-amine, tri-n-propylamine, triisopropylamine, tri-n-butylamine, triisobutylamine, tri-sec-butyl-amine, tri-n-amylamine, methoxyethylamine and ethoxyethylamine; heterocyclic amines, for example pyridine, quinoline, isoquinoline, morpholine, piperidine, pyrrolidine, indoline, quinuclidine and azepine; primary arylamines, for example anilines, methoxyanilines, ethoxyanilines, o-, m- and p-toluidines, phenylenediamines, benzidines, naphthylamines and o-, m- and p-chloroanilines; but especially triethylamine, isopropylamine and diisopropyl-amine.

Compounds of formula I wherein p is 0 are preferred.

Preference is given to compounds of formula I wherein
R₁ is —CH₂—, —CH₂CH₂—, —CF₂, —CH═CHCH₂—, —CH(CH₃)— or —C≡CCH₂—, but especially —CH₂—, in each case the left-hand free valency being attached to the pyridine ring.

Preference is also given to those compounds of formula I wherein X₁ is oxygen, sulfonyl or a group —NR₅₂SO₂—, especially oxygen.

Of special interest are compounds of formula I wherein R₂ is —CH₂OCH₃, —CH₂OCH₂CH₃, —CH₂CH₂OCH₃, —CH₂CH₂SO₂CH₃ or —CH₂CH₂OCH₂CH₂OCH₃, preferably —CH₂CH₂OCH₃, with prominence being given to those compounds wherein X₁ is oxygen and R₁ is —CH₂—. In that group of compounds preference is given to those wherein Q is Q₁ and R₁₃ is hydroxy.

Emphasis is also given to compounds of formula I wherein R₂ is

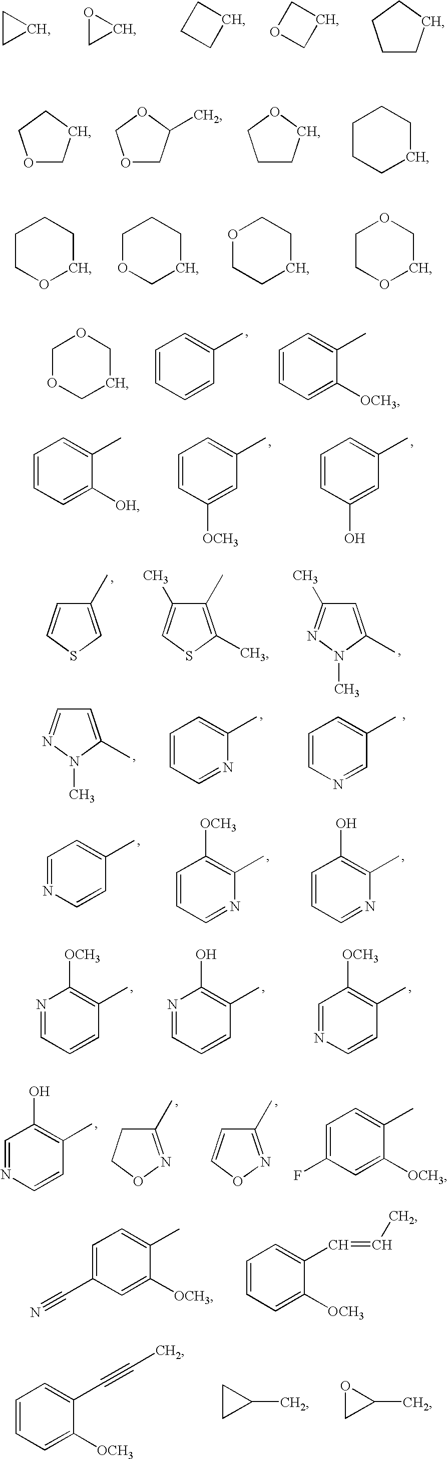

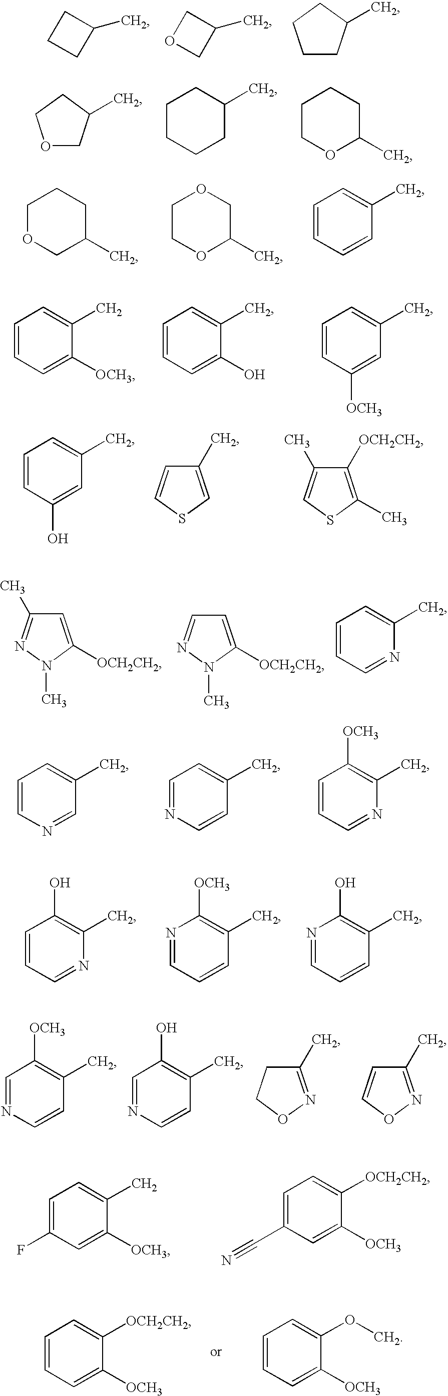

Where no free valency is indicated in the case of those preferred meanings of R₂, for example in the case of 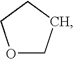
the attachment position is located at the carbon atom identified by “CH”.

In a further preferred group of compounds of formula I, R₃ is CF₃, CF₂CF₃, CF₂Cl, CF₂H or CCl₃, especially CF₃, R₄ preferably being hydrogen or methyl, especially hydrogen.

R₆, R₇, R₈, R₉, R₁₀, R₁₁, R₁₂, R₅₁ and R₅₂ are each independently of the others especially hydrogen, C₁-C₄alkyl, C₁-C₆alkoxy-C₁-C₆alkyl, or C₁-C₆alkoxy-C₁-C₆alkyl substituted by C₁-C₆alkoxy, while in addition, in a preferred group of compounds of formula I, Q is Q₂ and R₁ is methylene.

Very special preference is given to Q being Q₁, and R₁₃ being hydroxy or halogen, especially hydroxy. In that group of compounds, emphasis is to be given to those wherein
a) A₁ is C(R₁₄R₁₅) or NR₁₆, and A₂ is C(R₁₇R₁₈), C(O) or oxygen, or
b) A₁ is C(R₁₄R₁₅) and A₂ is C(R₁₇R₁₈), and R₁₄ and R₂₂ together form a C₂-C₃alkylene chain, preferably an ethylene chain, R₁₅, R₁₇, R₁₈ and R₂₁ being especially hydrogen; or
c) A₂ is C(O) or C(R₁₇R₁₈), A₁ is C(R₁₄R₁₅), and R₁₄, R₁₅, R₁₇ and R₁₈ are each independently of the others hydrogen, methyl, ethyl, methoxycarbonyl or ethoxycarbonyl; or
d) R₁₄ and R₁₅ together or R₂₁ and R₂₂ together form a C₂alkylene chain (cyclopropyl ring), A₂ is CH₂, and R₂₁ and R₂₂, or R₁₄ and R₁₅, are each independently of the other hydrogen, C₁-C₄alkyl, methoxycarbonyl or ethoxycarbonyl; or
e) A₂ is C(R₁₇R₁₈) and A₁ is C(R₁₄R₁₅), and R₁₈ and R₁₄ together form a C₂-C₃alkylene chain.

In a further group of compounds of formula I to which prominence is given, Q is Q₃, R₄₉ is cyclopropyl, and R₅₀—S(O)ₙ is methylthio, ethylthio, methylsulfinyl, ethylsulfinyl, methylsulfonyl or ethylsulfonyl.

Preferred synergistic mixtures according to the invention comprise as active ingredients a compound of formula I and either the compound of formula 2.2.a 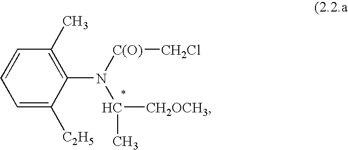
aRS,1′S(-)N-(1′-methyl-2′-methoxyethyl)-N-chloroacetyl-2-ethyl-6-methylaniline), or the racemic compound of formula 2.2.b 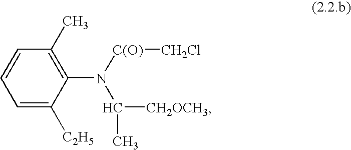
or the compound of formula 2.2 wherein R₅₃ is ethyl, R₅₄ is methyl and R₅₅ is ethoxymethyl, or the compound of formula 2.2. wherein R₅₃ is ethyl, R₅₄ is ethyl and R₅₅ is methoxymethyl, or a compound of formula 2.3, or a compound of formula 2.30, or a compound of formula 2.4, or a compound of formula 2.13, or the compound of formula 2.14, or the compound of formula 2.6 wherein R₆₂ is hydrogen, Z is methine, R₆₃ is methyl, Y is nitrogen, R₆₄ is fluorine, R₆₅ is hydrogen and R₆₆ is fluorine or wherein R₆₂ is methoxy, Z is methine, R₆₃ is methoxy, Y is methine, R₆₄ is chlorine, R₆₅ is methyl and R₆₆ is chlorine, or the compound of formula 2.7 wherein R₆₇ is —C(O)—S-n-octyl, or a compound of formula 2.12, or the compound of formula 2.18, or the compound of formula 2.19, or the compound of formula 2.21, or the compound of formula 2.25, or the compound of formula 2.33, or the compound of formula 2.45, or a compound of formula 2.1.

Especially preferred synergistic mixtures according to the invention comprise as active ingredients a compound of formula I and either the compound of formula 2.2.a 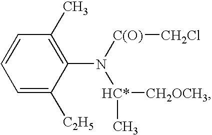
(2.2.a, aRS,1′S(-)N-(1′-methyl-2′-methoxyethyl)-N-=chloroacetyl-2-ethyl-6-methylaniline), or the racemic compound of formula 2.2.b 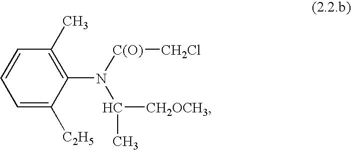
or a mixture of the compounds of formulae 2.2.a and 2.2.b wherein the compound of formula 2.2.a is present in excess, preferably in a ratio by weight of from 2.5:1 to 3:1, with respect to the compound of formula 2.2.b, or the compound of formula 2.2 wherein R₅₃ is ethyl, R₅₄ is methyl and R₅₅ is ethoxymethyl, or the compound of formula 2.2 wherein R₅₃ is ethyl, R₅₄ is ethyl and R₅₅ is methoxymethyl, or a compound of formula 2.3, or the compound of formula 2.30.

Further especially preferred synergistic mixtures according to the invention comprise as active ingredients a compound of formula I and a compound of formula 2.52a as indicated in Table 1:

TABLE 1
Compounds of formula 2.52a:

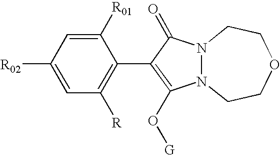

(2.52a)

| Comp. | | | | | |
|---|---|---|---|---|---|
| No. | R₀₁ | R₀₂ | R₀₃ | G | Phys. data |
| 1.001 | CH₃ | CH₃ | CH₃ | H | m.p. 245° C. |
| 1.002 | CH₃ | CH₃ | CH₃ | C(O)C(CH₃)₃ | m.p. 135- |
| | | | | | 136° C. |
| 1.003 | CH₃ | CH₃ | CH₃ | C(O)OCH₂CH₃ | |
| 1.004 | CH₂CH₃ | CH₃ | CH₃ | H | m.p. 182- |
| | | | | | 185° C. |
| 1.005 | CH₂CH₃ | CH₃ | CH₃ | C(O)C(CH₃)₃ | m.p. 110- |
| | | | | | 113° C. |
| 1.006 | CH₂CH₃ | CH₃ | CH₃ | C(O)OCH₂CH₃ | |
| 1.007 | CH₂CH₃ | CH₃ | CH₂CH₃ | H | m.p. 189- |
| | | | | | 191° C. |
| 1.008 | CH₂CH₃ | CH₃ | CH₂CH₃ | C(O)C(CH₃)₃ | m.p. 122- |
| | | | | | 124° C. |
| 1.009 | CH₂CH₃ | CH₃ | CH₂CH₃ | C(O)OCH₂CH₃ | m.p. 114- |
| | | | | | 116° C. |
| 1.010 | CH═CH₂ | CH₃ | CH₃ | H | m.p. 165- |
| | | | | | 170° C. |
| 1.011 | CH═CH₂ | CH₃ | CH₃ | C(O)C(CH₃)₃ | m.p. 111- |
| | | | | | 113° C. |
| 1.012 | CH═CH₂ | CH₃ | CH₂CH₃ | H | |
| 1.013 | CH═CH₂ | CH₃ | CH═CH₂ | H | |
| 1.014 | CH═CH₂ | CH₃ | CH═CH₂ | C(O)C(CH₃)₃ | |
| 1.015 | C≡CH | CH₃ | CH₃ | H | m.p. 179- |
| | | | | | 184° C. |
| 1.016 | C≡CH | CH₃ | CH₃ | C(O)C(CH₃)₃ | m.p. 109- |
| | | | | | 111° C. |
| 1.017 | C≡CH | CH₃ | CH₃ | C(O)OCH₂CH₃ | |
| 1.018 | C≡CH | CH₃ | CH₂CH₃ | H | m.p. 189- |
| | | | | | 193° C. |
| 1.019 | C≡CH | CH₃ | CH₂CH₃ | C(O)C(CH₃)₃ | |
| 1.020 | O≡CH | CH₃ | CH₂CH₃ | C(O)OCH₂CH₃ | |
| 1.021 | C≡CH | CH₃ | C≡CH | H | m.p. 300° C. |
| 1.022 | C≡CH | CH₃ | C≡CH | C(O)C(CH₃)₃ | m.p. 183- |
| | | | | | 185° C. |
| 1.023 | C≡CH | CH₃ | C≡CH | C(O)OCH₂CH₃ | |
| 1.024 | C≡CH | CH₃ | CH═CH₂ | H | |
| 1.025 | C≡CCH₃ | CH₃ | CH₃ | H | m.p. 179- |
| | | | | | 181° C. |
| 1.026 | C≡CCH₃ | CH₃ | CH₃ | C(O)C(CH₃)₃ | m.p. 128- |
| | | | | | 129° C. |
| 1.027 | C≡CCH₃ | CH₃ | CH₃ | C(O)OCH₂CH₃ | |
| 1.028 | C≡CCH₃ | CH₃ | CH₂CH₃ | H | |
| 1.029 | C≡CCH₃ | CH₃ | CH₂CH₃ | C(O)C(CH₃)₃ | |
| 1.030 | C≡CCH₃ | CH₃ | C≡CCH₃ | H | |
| 1.031 | C≡CCH₃ | CH₃ | C≡CCH₃ | C(O)C(CH₃)₃ | |
| 1.032 | CH₂CH₂CH₃ | CH₃ | CH₃ | H | m.p. 136- |
| | | | | | 138° C. |
| 1.033 | CH₂CH₂CH₃ | CH₃ | CH₃ | C(O)C(CH₃)₃ | m.p. 65- |
| | | | | | 67° C. |
| 1.034 | CH₂CH₂CH₃ | CH₃ | CH₃ | C(O)OCH₂CH₃ | |
| 1.035 | CH₂CH₂CH₃ | CH₃ | CH₂CH₃ | H | |
| 1.036 | CH₂CH₂CH₃ | CH₃ | CH₂CH₂CH₃ | H | |
| 1.037 | CH₂CH₂CH₃ | CH₃ | CH₂CH₂CH₃ | C(O)C(CH₃)₃ | |
| 1.038 | CH₂CH₂CH₃ | CH₃ | CH₂CH₂CH₃ | C(O)OCH₂CH₃ | |
| 1.039 | CH₂CH₂CH₃ | CH₃ | C≡CH | H | |
| 1.040 | CH(CH₃)₂ | CH₃ | CH₃ | H | m.p. 214- |
| | | | | | 216° C. |
| 1.041 | CH(CH₃)₂ | CH₃ | CH₃ | C(O)C(CH₃)₃ | m.p. 148- |
| | | | | | 151° C. |
| 1.042 | CH(CH₃)₂ | CH₃ | CH₂CH₃ | H | |
| 1.043 | CH(CH₃)₂ | CH₃ | C≡CH | H | |
| 1.044 | 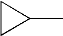 | CH₃ | CH₃ | H | |
| 1.045 | 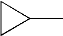 | CH₃ | CH₂CH₃ | H | |
| 1.046 | 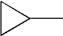 | CH₃ | C≡CH | H | |
| 1.047 | CH₂CH═CH₂ | CH₃ | CH₃ | H | |
| 1.048 | CH₂CH═CH₂ | CH₃ | CH₂CH₃ | H | |
| 1.049 | CH₂CH═CH₂ | CH₃ | C≡CH | H | |
| 1.050 | CH₂CH₂CH₂CH₃ | CH₃ | CH₃ | H | |
| 1.051 | CH₂CH₂CH₂CH₃ | CH₃ | CH₂CH₃ | H | |
| 1.052 | N(CH₂CH₃)₂ | CH₃ | CH₃ | H | |
| 1.053 | N(CH₂CH₃)₂ | CH₃ | CH₂CH₃ | H | |
| 1.054 | CH₂CH | CH₃ | CH₃ | H | |
| 1.055 | CH₂OCH₃ | CH₃ | CH₃ | H | |
| 1.056 | CH₂OC(CH₃)₃ | CH₃ | CH₃ | H | |
| 1.057 | CH₃ | CH₂CH₃ | CH₃ | H | |
| 1.058 | CH₂CH₃ | CH₂CH₃ | CH₃ | H | |
| 1.059 | CH₂CH₃ | CH₂CH₃ | CH₂CH₃ | H | m.p. 185- |
| | | | | | 187° C. |
| 1.060 | CH₂CH₃ | CH₂CH₃ | CH₂CH₃ | C(O)C(CH₃)₃ | m.p. 126- |
| | | | | | 128° C. |
| 1.061 | CH₂CH₃ | CH₂CH₃ | CH₂CH₃ | C(O)OCH₂CH₃ | m.p. 105- |
| | | | | | 107° C. |
| 1.062 | CH═CH₂ | CH₂CH₃ | CH═CH₂ | H | |
| 1.063 | C≡CH | CH₂CH₃ | C≡CH | H | |
| 1.064 | CH₃ | CH═CH₂ | CH₃ | H | |
| 1.065 | CH₂CH₃ | CH═CH₂ | CH₂CH₃ | H | |
| 1.066 | CH₂CH₃ | CH═CH₂ | CH₃ | H | |
| 1.067 | CH₂CH₃ | CH═CH₂ | CH₃ | C(O)C(CH₃)₃ | m.p. 108- |
| | | | | | 110° C. |
| 1.068 | C≡CH | CH═CH₂ | C≡CH | H | |
| 1.069 | CH₃ | C≡CH | CH₃ | H | |
| 1.070 | CH₂CH₃ | C≡CH | CH₃ | H | m.p. 240- |
| | | | | | 243° C. |
| 1.071 | CH₂CH₃ | C≡CH | CH₃ | C(O)C(CH₃)₃ | m.p. 138- |
| | | | | | 140° C. |
| 1.072 | CH₂CH₃ | C≡CH | CH₃ | C(O)OCH₂CH₃ | |
| 1.073 | CH₂CH₃ | C≡CH | CH₂CH₃ | H | |
| 1.074 | CH₂CH₃ | C≡CH | C≡CH | H | |
| 1.075 | C≡CH | C≡CH | C≡CH | H | |
| 1.076 | CH₃ | CH₂CH═CH₂ | CH₃ | H | |
| 1.077 | CH₃ | CH₂CH═CH₂ | CH₂CH₃ | H | |
| 1.078 | CH₃ | CH₃ | Br | H | m.p. 234- |
| | | | | | 237° C. |
| 1.079 | CH₃ | CH₃ | Br | C(O)C(CH₃)₃ | m.p. 76- |
| | | | | | 78° C. |
| 1.080 | CH₃ | CH₃ | Br | C(O)OCH₂CH₃ | |
| 1.081 | CH₂CH₃ | CH₃ | Br | H | |
| 1.082 | C≡CH | CH₃ | Br | H | |
| 1.083 | CH₃ | Br | CH₃ | H | m.p. 298- |
| | | | | | 299° C. |
| 1.084 | CH₂CH₃ | Br | CH₃ | H | m.p. 261- |
| | | | | | 263° C. |
| 1.085 | CH₂CH₃ | Br | CH₃ | C(O)C(CH₃)₃ | m.p. 127- |
| | | | | | 130° C. |
| 1.086 | CH₂CH₃ | Br | CH₃ | C(O)OCH₂CH₃ | |
| 1.087 | CH₂CH₃ | Br | CH₂CH₃ | H | |
| 1.088 | Br | CH₃ | Br | H | m.p. 238- |
| | | | | | 241 ° C. |
| 1.089 | Br | CH₃ | Br | C(O)C(CH₃)₃ | solid |
| 1.090 | Br | CH₃ | Br | C(O)OCH₂CH₃ | |
| 1.091 | CH₃ | Br | Br | H | |
| 1.092 | CH₂CH₃ | Br | Br | H | |
| 1.093 | CH₃ | CH₃ | Cl | H | |
| 1.094 | CH₂CH₃ | CH₃ | Cl | H | |
| 1.095 | CH₃ | Cl | CH₃ | H | |
| 1.096 | CH₂CH₃ | Cl | CH₃ | H | |
| 1.097 | CH₂CH₃ | Cl | CH₂CH₃ | H | |
| 1.098 | CH₂CH₃ | F | CH₂CH₃ | H | |
| 1.099 | OH2CH₃ | F | C≡CH | H | |
| 1.100 | CH₂CH₃ | F | OCH₃ | H | |
| 1.101 | Cl | CH₃ | Cl | H | |
| 1.102 | CH₃ | Cl | Cl | H | |
| 1.103 | CH₂CH₃ | Cl | Cl | H | |
| 1.104 | Br | CH₃ | Cl | H | |
| 1.105 | CH₃ | Br | Cl | H | |
| 1.106 | CH₃ | Cl | Br | H | |
| 1.107 | CH₂CH₃ | Br | Cl | H | |
| 1.108 | CH₂CH₃ | Cl | Br | H | |
| 1.109 | OCH₃ | CH₃ | CH₃ | H | |
| 1.110 | OCH₃ | CH₃ | CH₂CH₃ | H | m.p. 178- |
| | | | | | 179° C. |
| 1.111 | OCH₃ | CH₃ | CH₂CH₃ | C(O)C(CH₃)₃ | m.p. 146- |
| | | | | | 147° C. |
| 1.112 | OCH₃ | CH₃ | CH₂CH₃ | C(O)OCH₂CH₃ | |
| 1.113 | OCH₃ | CH₃ | CH₂CH₂CH₃ | H | |
| 1.114 | OCH₃ | CH₃ | C≡CH | H | |
| 1.115 | OCH₃ | CH₃ | Br | H | |
| 1.116 | OCH₃ | CH₃ | OCH₃ | H | |
| 1.117 | C(O)CH₃ | CH₃ | CH₃ | H | solid |
| 1.118 | C(O)CH₃ | CH₃ | CH₂CH₃ | H | |
| 1.119 | CH₃ | C(O)CH₃ | CH₂CH₃ | C(O)C(CH₃)₃ | m.p. 163- |
| | | | | | 165° C. |
| 1.120 | CH₃ | CH₂OH | CH₂CH₃ | H | |
| 1.121 | CH₃ | CH₃ | CH₃ | SO₂CH₂CHCH₂ | |
| 1.122 | CH₃ | CH₃ | CH₃ | SO₂CH₂CHCHCl | |
| 1.123 | CH₃ | CH₃ | CH₃ | SO₂CH₂CHCHCH₃ | |
| 1.124 | CH₂CH₃ | CH₃ | CH₂CH₃ | SO₂CH₂CHCH₂ | |
| 1.125 | CH₂CH₃ | CH₃ | CH₂CH₃ | SO₂CH₂CHCHCl | |
| 1.126 | CH₂CH₃ | CH₃ | CH₂CH₃ | SO₂CH₂CHCHCH₃ | |

Combinations of the compounds of formula I with the compound of formula 2.2a 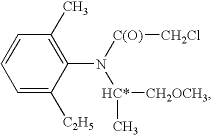
(2.2a, aRS,1′S(−)N-(1′-methyl-2′-methoxyethyl)-N-=chloroacetyl-2-ethyl-6-methylaniline) have been found to be very especially effective compositions.

The Tables that follow list especially preferred compounds of formula I for the composition according to the invention.

In the Table that follows, the left-hand valency of the radical R₁ is attached to the pyridine ring. When no free valency is indicated in the case of the substituent R₂, for example in the case of 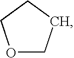
the attachment position is located at the carbon atom identified by “CH”.

In the Table that follows, the compounds of formula I are represented as follows:

### A-Q

wherein formula A

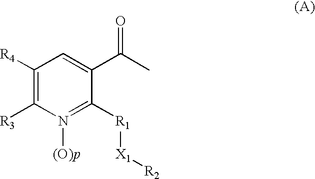

denotes the following radicals:

| Radical | R₁ | R₂ | R₄ | R₃ | X₁ | p |
|---|---|---|---|---|---|---|
| A1 | CH₂ | CH₃ | H | CF₃ | O | 0 |
| A2 | CH₂ | CH₃CH₂ | H | CF₃ | O | 0 |
| A3 | CH₂ | (CH₂)₃CH | H | CF₃ | O | 0 |
| A4 | CH₂ | PhCH₂ | H | CF₃ | O | 0 |
| A5 | CH₂ | CH₃ | H | CF₃ | S | 0 |
| A6 | CH₂ | CH₃ | H | CF₃ | SO | 0 |
| A7 | CH₂ | CH₃ | H | CF₃ | SO₂ | 0 |
| A8 | CH₂ | CH₃OCH₂ | H | CF₃ | O | 0 |
| A9 | CH₂ | CH₃CH₂OCH₂ | H | CF₃ | O | 0 |
| A10 | CH₂ | CH₃OCH₂CH₂ | H | CF₃ | O | 0 |
| A11 | CH₂ | CH₃CH₂OCH₂CH₂ | H | CF₃ | O | 0 |
| A12 | CH₂ | CH₃OC(CH₃)₂CH₂ | H | CF₃ | O | 0 |
| A13 | CH₂ | CH₃OCH(CH₃)CH₂ | H | CF₃ | O | 0 |
| A14 | CH₂ | CH₃OCH₂CH(CH₃) | H | CF₃ | O | 0 |
| A15 | CH₂ | CH₃OCH₂C(CH₃)₂ | H | CF₃ | O | 0 |
| A16 | CH₂ | CH₃OCH(CH₃) | H | CF₃ | O | 0 |
| A17 | CH₂ | CH₃OC(CH₃)₂ | H | CF₃ | O | 0 |
| A18 | CH₂ | HC≡CCH₂ | H | CF₃ | O | 0 |
| A19 | CH₂ | H₂C═CHCH₂ | H | CF₃ | O | 0 |
| A20 | CH₂ | CH₃C≡CCH₂ | H | CF₃ | O | 0 |
| A21 | CH₂ | 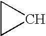 | H | CF₃ | O | 0 |
| A22 | CH₂ | 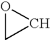 | H | CF₃ | O | 0 |
| A23 | CH₂ | 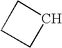 | H | CF₃ | O | 0 |
| A24 | CH₂ | 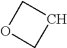 | H | CF₃ | O | 0 |
| A25 | CH₂ | 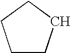 | H | CF₃ | O | 0 |
| A26 | CH₂ | 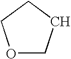 | H | CF₃ | O | 0 |
| A27 | CH₂ | 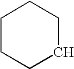 | H | CF₃ | O | 0 |
| A28 | CH₂ | 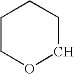 | H | CF₃ | O | 0 |
| A29 | CH₂ | 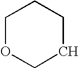 | H | CF₃ | O | 0 |
| A30 | CH₂ | 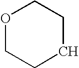 | H | CF₃ | O | 0 |
| A31 | CH₂ | 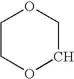 | H | CF₃ | O | 0 |
| A32 | CH₂ | 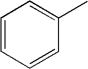 | H | CF₃ | O | 0 |
| A33 | CH₂ | 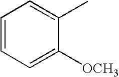 | H | CF₃ | O | 0 |
| A34 | CH₂ | 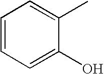 | H | CF₃ | O | 0 |
| A35 | CH₂ | 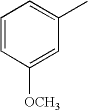 | H | CF₃ | O | 0 |
| A36 | CH₂ | 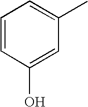 | H | CF₃ | O | 0 |
| A37 | CH₂ | 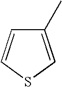 | H | CF₃ | O | 0 |
| A38 | CH₂ | 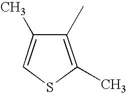 | H | CF₃ | O | 0 |
| A39 | CH₂ | 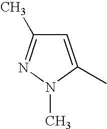 | H | CF₃ | O | 0 |
| A40 | CH₂ | 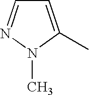 | H | CF₃ | O | 0 |
| A41 | CH₂ | 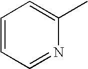 | H | CF₃ | O | 0 |
| A42 | CH₂ | 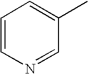 | H | CF₃ | O | 0 |
| A43 | CH₂ | 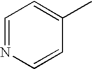 | H | CF₃ | O | 0 |
| A44 | CH₂ | 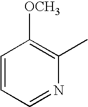 | H | CF₃ | O | 0 |
| A45 | CH₂ | 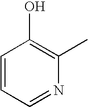 | H | CF₃ | O | 0 |
| A46 | CH₂ | 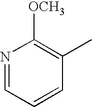 | H | CF₃ | O | 0 |
| A47 | CH₂ | 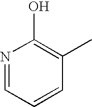 | H | CF₃ | O | 0 |
| A48 | CH₂ | 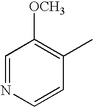 | H | CF₃ | O | 0 |
| A49 | CH₂ | 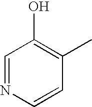 | H | CF₃ | O | 0 |
| A50 | CH₂ | 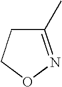 | H | CF₃ | O | 0 |
| A51 | CH₂ | 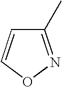 | H | CF₃ | O | 0 |
| A52 | CH₂ | 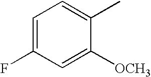 | H | CF₃ | O | 0 |
| A53 | CH₂ | 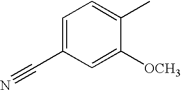 | H | CF₃ | O | 0 |
| A54 | CH₂ | 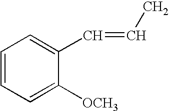 | H | CF₃ | O | 0 |
| A55 | CH₂ | 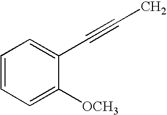 | H | CF₃ | O | 0 |
| A56 | CH₂ | 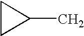 | H | CF₃ | O | 0 |
| A57 | CH₂ | 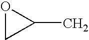 | H | CF₃ | O | 0 |
| A58 | CH₂ | 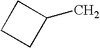 | H | CF₃ | O | 0 |
| A59 | CH₂ | 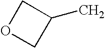 | H | CF₃ | O | 0 |
| A60 | CH₂ | 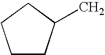 | H | CF₃ | O | 0 |
| A61 | CH₂ | 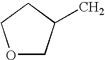 | H | CF₃ | O | 0 |
| A62 | CH₂ | 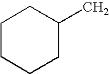 | H | CF₃ | O | 0 |
| A63 | CH₂ | 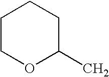 | H | CF₃ | O | 0 |
| A64 | CH₂ | 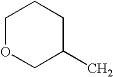 | H | CF₃ | O | 0 |
| A65 | CH₂ | 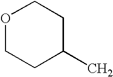 | H | CF₃ | O | 0 |
| A66 | CH₂ | 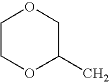 | H | CF₃ | O | 0 |
| A67 | CH₂ | 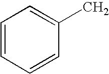 | H | CF₃ | O | 0 |
| A68 | CH₂ | 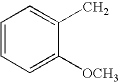 | H | CF₃ | O | 0 |
| A69 | CH₂ | 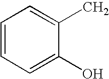 | H | CF₃ | O | 0 |
| A70 | CH₂ | 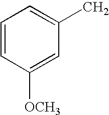 | H | CF₃ | O | 0 |
| A71 | CH₂ | 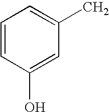 | H | CF₃ | O | 0 |
| A72 | CH₂ | 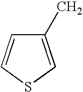 | H | CF₃ | O | 0 |
| A73 | CH₂ | 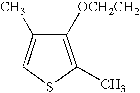 | H | CF₃ | O | 0 |
| A74 | CH₂ | 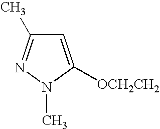 | H | CF₃ | O | 0 |
| A75 | CH₂ | 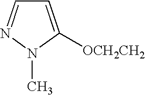 | H | CF₃ | O | 0 |
| A76 | CH₂ | 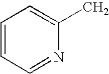 | H | CF₃ | O | 0 |
| A77 | CH₂ | 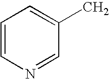 | H | CF₃ | O | 0 |
| A78 | CH₂ | 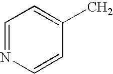 | H | CF₃ | O | 0 |
| A79 | CH₂ | 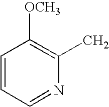 | H | CF₃ | O | 0 |
| A80 | CH₂ | 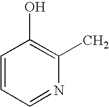 | H | CF₃ | O | 0 |
| A81 | CH₂ | 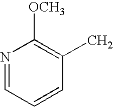 | H | CF₃ | O | 0 |
| A82 | CH₂ | 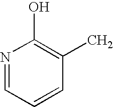 | H | CF₃ | O | 0 |
| A83 | CH₂ | 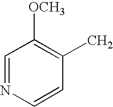 | H | CF₃ | O | 0 |
| A84 | CH₂ | 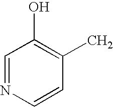 | H | CF₃ | O | 0 |
| A85 | CH₂ | 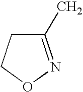 | H | CF₃ | O | 0 |
| A86 | CH₂ | 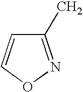 | H | CF₃ | O | 0 |
| A87 | CH₂ | 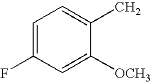 | H | CF₃ | O | 0 |
| A88 | CH₂ | 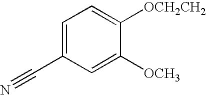 | H | CF₃ | O | 0 |
| A89 | CH₂ | 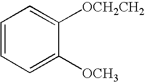 | H | CF₃ | O | 0 |
| A90 | CH₂ | 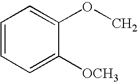 | H | CF₃ | O | 0 |
| A91 | CH₂CH₂ | CH₃ | H | CF₃ | O | 0 |
| A92 | CH₂CH₂ | CH₃CH₂ | H | CF₃ | O | 0 |
| A93 | CH₂CH₂ | (CH₃)₂CH | H | CF₃ | O | 0 |
| A94 | CH₂CH₂ | PhCH₂ | H | CF₃ | O | 0 |
| A95 | CH₂CH₂ | CH₃ | H | CF₃ | S | 0 |
| A96 | CH₂CH₂ | CH₃ | H | CF₃ | SO | 0 |
| A97 | CH₂CH₂ | CH₃ | H | CF₃ | SO₂ | 0 |
| A98 | CH₂CH₂ | (CH₃)₂CHCH₂ | H | CF₃ | O | |
| A99 | CH₂CH₂ | CH₃OCH₂ | H | CF₃ | O | 0 |
| A100 | CH₂CH₂ | CH₃CH₂OCH₂ | H | CF₃ | O | 0 |
| A101 | CH₂CH₂ | CH₃OCH₂CH₂ | H | CF₃ | O | 0 |
| A102 | CH₂CH₂ | CH₃CH₂OCH₂CH₂ | H | CF₃ | O | 0 |
| A103 | CH₂CH₂ | CH₃OC(CH₃)₂CH₂ | H | CF₃ | O | 0 |
| A104 | CH₂CH₂ | CH₃OCH(CH₃)CH₂ | H | CF₃ | O | 0 |
| A105 | CH₂CH₂ | CH₃OCH₂CH(CH₃) | H | CF₃ | O | 0 |
| A106 | CH₂CH₂ | CH₃OCH₂C(CH₃)₂ | H | CF₃ | O | 0 |
| A107 | CH₂CH₂ | CH₃OCH(CH₃) | H | CF₃ | O | 0 |
| A108 | CH₂CH₂ | CH₃OC(CH₃)₂ | H | CF₃ | O | 0 |
| A109 | CH₂CH₂ | HC≡CCH₂ | H | CF₃ | O | 0 |
| A110 | CH₂CH₂ | H₂C═CHCH₂ | H | CF₃ | O | 0 |
| A111 | CH₂CH₂ | CH₃C≡CCH₂ | H | CF₃ | O | 0 |
| A112 | CH₂CH₂ | 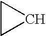 | H | CF₃ | O | 0 |
| A113 | CH₂CH₂ | 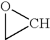 | H | CF₃ | O | 0 |
| A114 | CH₂CH₂ | 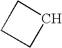 | H | CF₃ | O | 0 |
| A115 | CH₂CH₂ | 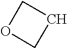 | H | CF₃ | O | 0 |
| A116 | CH₂CH₂ | 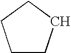 | H | CF₃ | O | 0 |
| A117 | CH₂CH₂ | 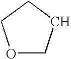 | H | CF₃ | O | 0 |
| A118 | CH₂CH₂ | 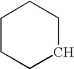 | H | CF₃ | O | 0 |
| A119 | CH₂CH₂ | 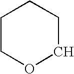 | H | CF₃ | O | 0 |
| A120 | CH₂CH₂ | 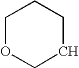 | H | CF₃ | O | 0 |
| A121 | CH₂CH₂ | 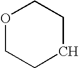 | H | CF₃ | O | 0 |
| A122 | CH₂CH₂ | 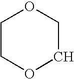 | H | CF₃ | O | 0 |
| A123 | CH₂CH₂ | 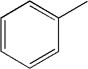 | H | CF₃ | O | 0 |
| A124 | CH₂CH₂ | 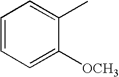 | H | CF₃ | O | 0 |
| A125 | CH₂CH₂ | 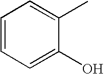 | H | CF₃ | O | 0 |
| A126 | CH₂CH₂ | 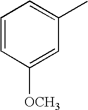 | H | CF₃ | O | 0 |
| A127 | CH₂CH₂ | 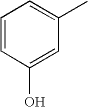 | H | CF₃ | O | 0 |
| A128 | CH₂CH₂ | 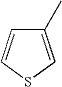 | H | CF₃ | O | 0 |
| A129 | CH₂CH₂ | 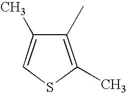 | H | CF₃ | O | 0 |
| A130 | CH₂CH₂ | 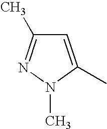 | H | CF₃ | O | 0 |
| A131 | CH₂CH₂ | 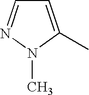 | H | CF₃ | O | 0 |
| A132 | CH₂CH₂ | 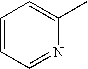 | H | CF₃ | O | 0 |
| A133 | CH₂CH₂ | 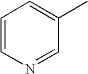 | H | CF₃ | O | 0 |
| A134 | CH₂CH₂ | 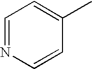 | H | CF₃ | O | 0 |
| A135 | CH₂CH₂ | 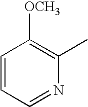 | H | CF₃ | O | 0 |
| A136 | CH₂CH₂ | 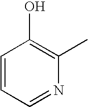 | H | CF₃ | O | 0 |
| A137 | CH₂CH₂ | 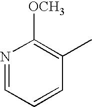 | H | CF₃ | O | 0 |
| A138 | CH₂CH₂ | 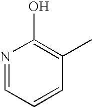 | H | CF₃ | O | 0 |
| A139 | CH₂CH₂ | 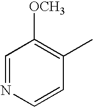 | H | CF₃ | O | 0 |
| A140 | CH₂CH₂ | 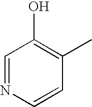 | H | CF₃ | O | 0 |
| A141 | CH₂CH₂ | 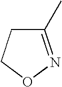 | H | CF₃ | O | 0 |
| A142 | CH₂CH₂ | 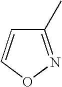 | H | CF₃ | O | 0 |
| A143 | CH₂CH₂ | 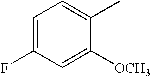 | H | CF₃ | O | 0 |
| A144 | CH₂CH₂ | 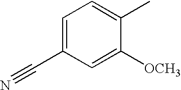 | H | CF₃ | O | 0 |
| A145 | CH₂CH₂ | 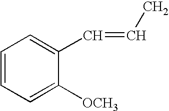 | H | CF₃ | O | 0 |
| A146 | CH₂CH₂ | 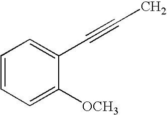 | H | CF₃ | O | 0 |
| A147 | CH₂CH₂ | 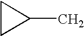 | H | CF₃ | O | 0 |
| A148 | CH₂CH₂ | 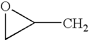 | H | CF₃ | O | 0 |
| A149 | CH₂CH₂ | 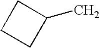 | H | CF₃ | O | 0 |
| A150 | CH₂CH₂ | 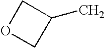 | H | CF₃ | O | 0 |
| A151 | CH₂CH₂ | 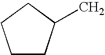 | H | CF₃ | O | 0 |
| A152 | CH₂CH₂ | 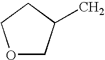 | H | CF₃ | O | 0 |
| A153 | CH₂CH₂ | 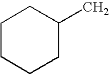 | H | CF₃ | O | 0 |
| A154 | CH₂CH₂ | 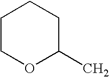 | H | CF₃ | O | 0 |
| A155 | CH₂CH₂ | 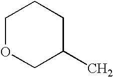 | H | CF₃ | O | 0 |
| A156 | CH₂CH₂ | 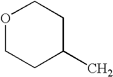 | H | CF₃ | O | 0 |
| A157 | CH₂CH₂ | 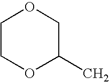 | H | CF₃ | O | 0 |
| A158 | CH₂CH₂ | 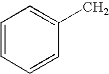 | H | CF₃ | O | 0 |
| A159 | CH₂CH₂ | 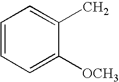 | H | CF₃ | O | 0 |
| A160 | CH₂CH₂ | 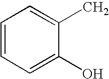 | H | CF₃ | O | 0 |
| A161 | CH₂CH₂ | 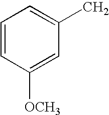 | H | CF₃ | O | 0 |
| A162 | CH₂CH₂ | 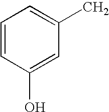 | H | CF₃ | O | 0 |
| A163 | CH₂CH₂ | 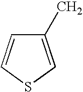 | H | CF₃ | O | 0 |
| A164 | CH₂CH₂ | 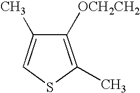 | H | CF₃ | O | 0 |
| A165 | CH₂CH₂ | 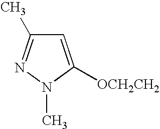 | H | CF₃ | O | 0 |
| A166 | CH₂CH₂ | 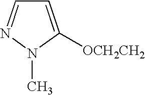 | H | CF₃ | O | 0 |
| A167 | CH₂CH₂ | 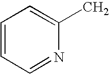 | H | CF₃ | O | 0 |
| A168 | CH₂CH₂ | 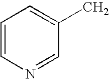 | H | CF₃ | O | 0 |
| A169 | CH₂CH₂ | 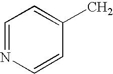 | H | CF₃ | O | 0 |
| A170 | CH₂CH₂ | 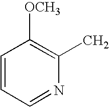 | H | CF₃ | O | 0 |
| A171 | CH₂CH₂ | 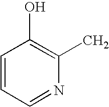 | H | CF₃ | O | 0 |
| A172 | CH₂CH₂ | 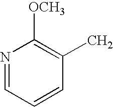 | H | CF₃ | O | 0 |
| A173 | CH₂CH₂ | 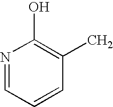 | H | CF₃ | O | 0 |
| A174 | CH₂CH₂ | 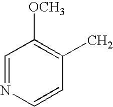 | H | CF₃ | O | 0 |
| A175 | CH₂CH₂ | 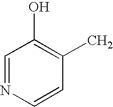 | H | CF₃ | O | 0 |
| A176 | CH₂CH₂ | 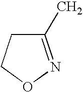 | H | CF₃ | O | 0 |
| A177 | CH₂CH₂ | 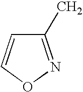 | H | CF₃ | O | 0 |
| A178 | CH₂CH₂ | 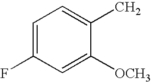 | H | CF₃ | O | 0 |
| A179 | CH₂CH₂ | 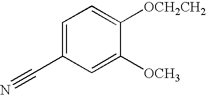 | H | CF₃ | O | 0 |
| A180 | CH₂CH₂ | 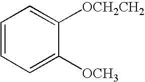 | H | CF₃ | O | 0 |
| A181 | CH₂CH₂ | 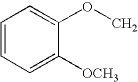 | H | CF₃ | O | 0 |
| A182 | CH(OCH₃)CH₂ | CH₃ | H | CF₃ | O | 0 |
| A183 | CH(OCH₃)CH₂ | CH₃CH₂ | H | CF₃ | O | 0 |
| A184 | CH(OCH₃)CH₂ | (CH₃)₂CH | H | CF₃ | O | 0 |
| A185 | CH(OCH₃)CH₂ | PhCH₂ | H | CF₃ | O | 0 |
| A186 | CH(OCH₃)CH₂ | CH₃ | H | CF₃ | S | 0 |
| A187 | CH(OCH₃)CH₂ | CH₃ | H | CF₃ | SO | 0 |
| A188 | CH(OCH₃)CH₂ | CH₃ | H | CF₃ | SO₂ | 0 |
| A189 | CH(OCH₃)CH₂ | CH₃CH₂CH₂ | H | CF₃ | O | |
| A190 | CH(OCH₃)CH₂ | CH₃OCH₂ | H | CF₃ | O | 0 |
| A191 | CH(OCH₃)CH₂ | CH₃CH₂OCH₂ | H | CF₃ | O | 0 |
| A192 | CH(OCH₃)CH₂ | CH₃OCH₂CH₂ | H | CF₃ | O | 0 |
| A193 | CH(OCH₃)CH₂ | CH₃CH₂OCH₂CH₂ | H | CF₃ | O | 0 |
| A194 | CH(OCH₃)CH₂ | CH₃OC(CH₃)₂CH₂ | H | CF₃ | O | 0 |
| A195 | CH(OCH₃)CH₂ | CH₃OCH(CH₃)CH₂ | H | CF₃ | O | 0 |
| A196 | CH(OCH₃)CH₂ | CH₃OCH₂CH(CH₃) | H | CF₃ | O | 0 |
| A197 | CH(OCH₃)CH₂ | CH₃OCH₂C(CH₃)₂ | H | CF₃ | O | 0 |
| A198 | CH(OCH₃)CH₂ | CH₃OCH(CH₃) | H | CF₃ | O | 0 |
| A199 | CH(OCH₃)CH₂ | CH₃OC(CH₃)₂ | H | CF₃ | O | 0 |
| A200 | CH(OCH₃)CH₂ | HC≡CCH₂ | H | CF₃ | O | 0 |
| A201 | CH(OCH₃)CH₂ | H₂C═CHCH₂ | H | CF₃ | O | 0 |
| A202 | CH(OCH₃)CH₂ | CH₃C≡CCH₂ | H | CF₃ | O | 0 |
| A203 | CH(OCH₃)CH₂ | 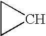 | H | CF₃ | O | 0 |
| A204 | CH(OCH₃)CH₂ | 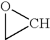 | H | CF₃ | O | 0 |
| A205 | CH(OCH₃)CH₂ | 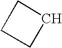 | H | CF₃ | O | 0 |
| A206 | CH(OCH₃)CH₂ | 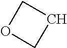 | H | CF₃ | O | 0 |
| A207 | CH(OCH₃)CH₂ | 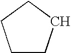 | H | CF₃ | O | 0 |
| A208 | CH(OCH₃)CH₂ | 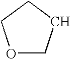 | H | CF₃ | O | 0 |
| A209 | CH(OCH₃)CH₂ | 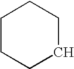 | H | CF₃ | O | 0 |
| A210 | CH(OCH₃)CH₂ | 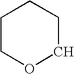 | H | CF₃ | O | 0 |
| A211 | CH(OCH₃)CH₂ | 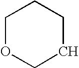 | H | CF₃ | O | 0 |
| A212 | CH(OCH₃)CH₂ | 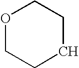 | H | CF₃ | O | 0 |
| A213 | CH(OCH₃)CH₂ | 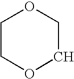 | H | CF₃ | O | 0 |
| A214 | CH(OCH₃)CH₂ | 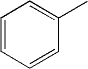 | H | CF₃ | O | 0 |
| A215 | CH(OCH₃)CH₂ | 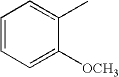 | H | CF₃ | O | 0 |
| A216 | CH(OCH₃)CH₂ | 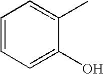 | H | CF₃ | O | 0 |
| A217 | CH(OCH₃)CH₂ | 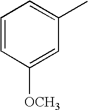 | H | CF₃ | O | 0 |
| A218 | CH(OCH₃)CH₂ | 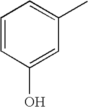 | H | CF₃ | O | 0 |
| A219 | CH(OCH₃)CH₂ | 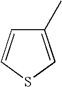 | H | CF₃ | O | 0 |
| A220 | CH(OCH₃)CH₂ | 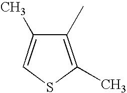 | H | CF₃ | O | 0 |
| A221 | CH(OCH₃)CH₂ | 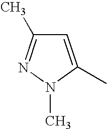 | H | CF₃ | O | 0 |
| A222 | CH(OCH₃)CH₂ | 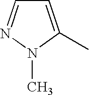 | H | CF₃ | O | 0 |
| A223 | CH(OCH₃)CH₂ | 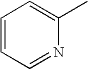 | H | CF₃ | O | 0 |
| A224 | CH(OCH₃)CH₂ | 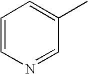 | H | CF₃ | O | 0 |
| A225 | CH(OCH₃)CH₂ | 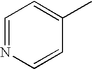 | H | CF₃ | O | 0 |
| A226 | CH(OCH₃)CH₂ | 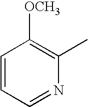 | H | CF₃ | O | 0 |
| A227 | CH(OCH₃)CH₂ | 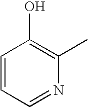 | H | CF₃ | O | 0 |
| A228 | CH(OCH₃)CH₂ | 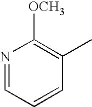 | H | CF₃ | O | 0 |
| A229 | CH(OCH₃)CH₂ | 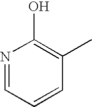 | H | CF₃ | O | 0 |
| A230 | CH(OCH₃)CH₂ | 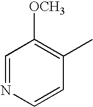 | H | CF₃ | O | 0 |
| A231 | CH(OCH₃)CH₂ | 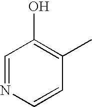 | H | CF₃ | O | 0 |
| A232 | CH(OCH₃)CH₂ | 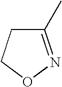 | H | CF₃ | O | 0 |
| A233 | CH(OCH₃)CH₂ | 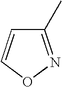 | H | CF₃ | O | 0 |
| A234 | CH(OCH₃)CH₂ | 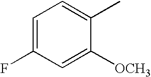 | H | CF₃ | O | 0 |
| A235 | CH(OCH₃)CH₂ | 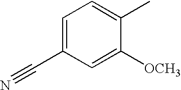 | H | CF₃ | O | 0 |
| A236 | CH(OCH₃)CH₂ | 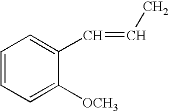 | H | CF₃ | O | 0 |
| A237 | CH(OCH₃)CH₂ | 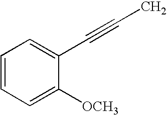 | H | CF₃ | O | 0 |
| A238 | CH(OCH₃)CH₂ | 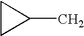 | H | CF₃ | O | 0 |
| A239 | CH(OCH₃)CH₂ | 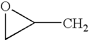 | H | CF₃ | O | 0 |
| A240 | CH(OCH₃)CH₂ | 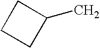 | H | CF₃ | O | 0 |
| A241 | CH(OCH₃)CH₂ | 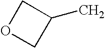 | H | CF₃ | O | 0 |
| A242 | CH(OCH₃)CH₂ | 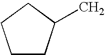 | H | CF₃ | O | 0 |
| A243 | CH(OCH₃)CH₂ | 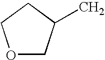 | H | CF₃ | O | 0 |
| A244 | CH(OCH₃)CH₂ | 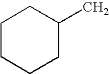 | H | CF₃ | O | 0 |
| A245 | CH(OCH₃)CH₂ | 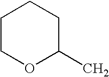 | H | CF₃ | O | 0 |
| A246 | CH(OCH₃)CH₂ | 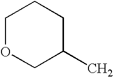 | H | CF₃ | O | 0 |
| A247 | CH(OCH₃)CH₂ | 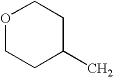 | H | CF₃ | O | 0 |
| A248 | CH(OCH₃)CH₂ | 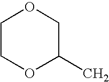 | H | CF₃ | O | 0 |
| A249 | CH(OCH₃)CH₂ | 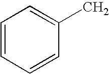 | H | CF₃ | O | 0 |
| A250 | CH(OCH₃)CH₂ | 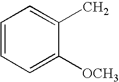 | H | CF₃ | O | 0 |
| A251 | CH(OCH₃)CH₂ | 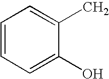 | H | CF₃ | O | 0 |
| A252 | CH(OCH₃)CH₂ | 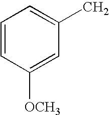 | H | CF₃ | O | 0 |
| A253 | CH(OCH₃)CH₂ | 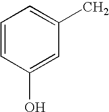 | H | CF₃ | O | 0 |
| A254 | CH(OCH₃)CH₂ | 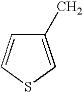 | H | CF₃ | O | 0 |
| A255 | CH(OCH₃)CH₂ | 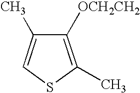 | H | CF₃ | O | 0 |
| A256 | CH(OCH₃)CH₂ | 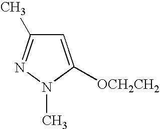 | H | CF₃ | O | 0 |
| A257 | CH(OCH₃)CH₂ | 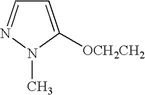 | H | CF₃ | O | 0 |
| A258 | CH(OCH₃)CH₂ | 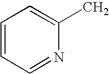 | H | CF₃ | O | 0 |
| A259 | CH(OCH₃)CH₂ | 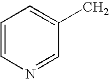 | H | CF₃ | O | 0 |
| A260 | CH(OCH₃)CH₂ | 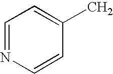 | H | CF₃ | O | 0 |
| A261 | CH(OCH₃)CH₂ | 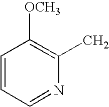 | H | CF₃ | O | 0 |
| A262 | CH(OCH₃)CH₂ | 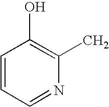 | H | CF₃ | O | 0 |
| A263 | CH(OCH₃)CH₂ | 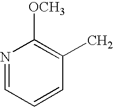 | H | CF₃ | O | 0 |
| A264 | CH(OCH₃)CH₂ | 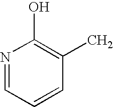 | H | CF₃ | O | 0 |
| A265 | CH(OCH₃)CH₂ | 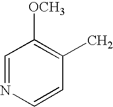 | H | CF₃ | O | 0 |
| A266 | CH(OCH₃)CH₂ | 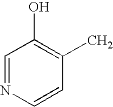 | H | CF₃ | O | 0 |
| A267 | CH(OCH₃)CH₂ | 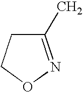 | H | CF₃ | O | 0 |
| A268 | CH(OCH₃)CH₂ | 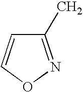 | H | CF₃ | O | 0 |
| A269 | CH(OCH₃)CH₂ | 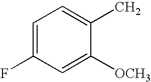 | H | CF₃ | O | 0 |
| A270 | CH(OCH₃)CH₂ | 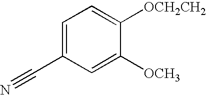 | H | CF₃ | O | 0 |
| A271 | CH(OCH₃)CH₂ | 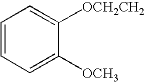 | H | CF₃ | O | 0 |
| A272 | CH(OCH₃)CH₂ | 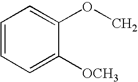 | H | CF₃ | O | 0 |
| A273 | CH₂CH(OCH₃)CH₂ | CH₃ | H | CF₃ | O | 0 |
| A274 | CH₂CH(OCH₂)CH₃ | CH₂CH₃ | H | CF₃ | O | 0 |
| A275 | CH₂CH(OCH₃)CH₂ | (CH₃)₂CH | H | CF₃ | O | 0 |
| A276 | CH₂CH(OCH₃)CH₂ | PhCH₂ | H | CF₃ | O | 0 |
| A277 | CH₂CH(OCH₃)CH₂ | CH₃ | H | CF₃ | S | 0 |
| A278 | CH₂CH(OCH₃)CH₂ | CH₃ | H | CF₃ | SO | 0 |
| A279 | CH₂CH(OCH₃)CH₂ | CH₃ | H | CF₃ | SO₂ | 0 |
| A280 | CH₂CH(OCH₃)CH₂ | CH₃CH₂CH₂ | H | CF₃ | O | |
| A281 | CH₂CH(OCH₃)CH₂ | CH₃OCH₂ | H | CF₃ | O | 0 |
| A282 | CH₂CH(OCH₃)CH₂ | CH₃CH₂OCH₂ | H | CF₃ | O | 0 |
| A283 | CH₂CH(OCH₃)CH₂ | CH₃OCH₂CH₂ | H | CF₃ | O | 0 |
| A284 | CH₂CH(OCH₃)CH₂ | CH₃CH₂OCH₂CH₂ | H | CF₃ | O | 0 |
| A285 | CH₂CH(OCH₃)CH₂ | CH₃OC(CH₃)₂CH₂ | H | CF₃ | O | 0 |
| A286 | CH₂CH(OCH₃)CH₂ | CH₃OCH(CH₃)CH₂ | H | CF₃ | O | 0 |
| A287 | CH₂CH(OCH₃)CH₂ | CH₃OCH₂CH(CH₃) | H | CF₃ | O | 0 |
| A288 | CH₂CH(OCH₃)CH₂ | CH₃OCH₂C(CH₃)₂ | H | CF₃ | O | 0 |
| A289 | CH₂CH(OCH₃)CH₂ | CH₃OCH(CH₃) | H | CF₃ | O | 0 |
| A290 | CH₂CH(OCH₃)CH₂ | CH₃OC(CH₃)₂ | H | CF₃ | O | 0 |
| A291 | CH₂CH(OCH₃)CH₂ | HC≡CCH₂ | H | CF₃ | O | 0 |
| A292 | CH₂CH(OCH₃)CH₂ | H₂C═CHCH₂ | H | CF₃ | O | 0 |
| A293 | CH₂CH(OCH₃)CH₂ | CH₃C≡CCH₂ | H | CF₃ | O | 0 |
| A294 | CH₂CH(OCH₃)CH₂ | 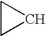 | H | CF₃ | O | 0 |
| A295 | CH₂CH(OCH₃)CH₂ | 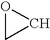 | H | CF₃ | O | 0 |
| A296 | CH₂CH(OCH₃)CH₂ | 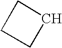 | H | CF₃ | O | 0 |
| A297 | CH₂CH(OCH₃)CH₂ | 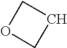 | H | CF₃ | O | 0 |
| A298 | CH₂CH(OCH₃)CH₂ | 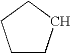 | H | CF₃ | O | 0 |
| A299 | CH₂CH(OCH₃)CH₂ | 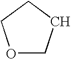 | H | CF₃ | O | 0 |
| A300 | CH₂CH(OCH₃)CH₂ | 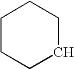 | H | CF₃ | O | 0 |
| A301 | CH₂CH(OCH₃)CH₂ | 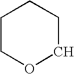 | H | CF₃ | O | 0 |
| A302 | CH₂CH(OCH₃)CH₂ | 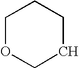 | H | CF₃ | O | 0 |
| A303 | CH₂CH(OCH₃)CH₂ | 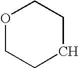 | H | CF₃ | O | 0 |
| A304 | CH₂CH(OCH₃)CH₂ | 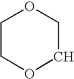 | H | CF₃ | O | 0 |
| A305 | CH₂CH(OCH₃)CH₂ | 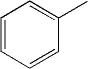 | H | CF₃ | O | 0 |
| A306 | CH₂CH(OCH₃)CH₂ | 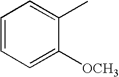 | H | CF₃ | O | 0 |
| A307 | CH₂CH(OCH₃)CH₂ | 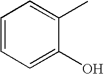 | H | CF₃ | O | 0 |
| A308 | CH₂CH(OCH₃)CH₂ | 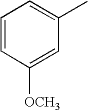 | H | CF₃ | O | 0 |
| A309 | CH₂CH(OCH₃)CH₂ | 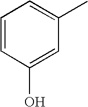 | H | CF₃ | O | 0 |
| A310 | CH₂CH(OCH₃)CH₂ | 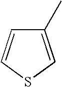 | H | CF₃ | O | 0 |
| A311 | CH₂CH(OCH₃)CH₂ | 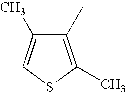 | H | CF₃ | O | 0 |
| A312 | CH₂CH(OCH₃)CH₂ | 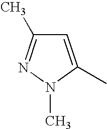 | H | CF₃ | O | 0 |
| A313 | CH₂CH(OCH₃)CH₂ | 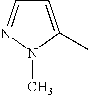 | H | CF₃ | O | 0 |
| A314 | CH₂CH(OCH₃)CH₂ | 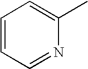 | H | CF₃ | O | 0 |
| A315 | CH₂CH(OCH₃)CH₂ | 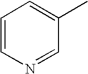 | H | CF₃ | O | 0 |
| A316 | CH₂CH(OCH₃)CH₂ | 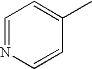 | H | CF₃ | O | 0 |
| A317 | CH₂CH(OCH₃)CH₂ | 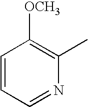 | H | CF₃ | O | 0 |
| A318 | CH₂CH(OCH₃)CH₂ | 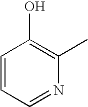 | H | CF₃ | O | 0 |
| A319 | CH₂CH(OCH₃)CH₂ | 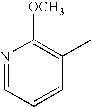 | H | CF₃ | O | 0 |
| A320 | CH₂CH(OCH₃)CH₂ | 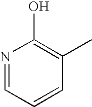 | H | CF₃ | O | 0 |
| A321 | CH₂CH(OCH₃)CH₂ | 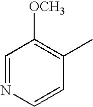 | H | CF₃ | O | 0 |
| A322 | CH₂CH(OCH₃)CH₂ | 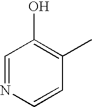 | H | CF₃ | O | 0 |
| A323 | CH₂CH(OCH₃)CH₂ | 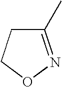 | H | CF₃ | O | 0 |
| A324 | CH₂CH(OCH₃)CH₂ | 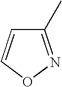 | H | CF₃ | O | 0 |
| A325 | CH₂CH(OCH₃)CH₂ | 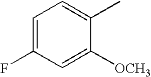 | H | CF₃ | O | 0 |
| A326 | CH₂CH(OCH₃)CH₂ | 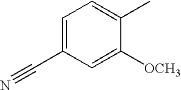 | H | CF₃ | O | 0 |
| A327 | CH₂CH(OCH₃)CH₂ | 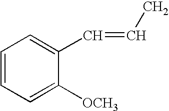 | H | CF₃ | O | 0 |
| A328 | CH₂CH(OCH₃)CH₂ | 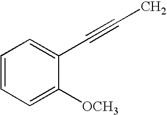 | H | CF₃ | O | 0 |
| A329 | CH₂CH(OCH₃)CH₂ | 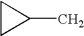 | H | CF₃ | O | 0 |
| A330 | CH₂CH(OCH₃)CH₂ | 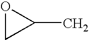 | H | CF₃ | O | 0 |
| A331 | CH₂CH(OCH₃)CH₂ | 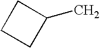 | H | CF₃ | O | 0 |
| A332 | CH₂CH(OCH₃)CH₂ | 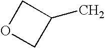 | H | CF₃ | O | 0 |
| A333 | CH₂CH(OCH₃)CH₂ | 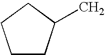 | H | CF₃ | O | 0 |
| A334 | CH₂CH(OCH₃)CH₂ | 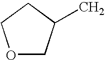 | H | CF₃ | O | 0 |
| A335 | CH₂CH(OCH₃)CH₂ | 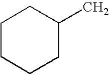 | H | CF₃ | O | 0 |
| A336 | CH₂CH(OCH₃)CH₂ | 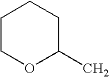 | H | CF₃ | O | 0 |
| A337 | CH₂CH(OCH₃)CH₂ | 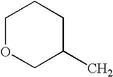 | H | CF₃ | O | 0 |
| A338 | CH₂CH(OCH₃)CH₂ | 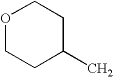 | H | CF₃ | O | 0 |
| A339 | CH₂CH(OCH₃)CH₂ | 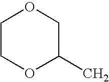 | H | CF₃ | O | 0 |
| A340 | CH₂CH(OCH₃)CH₂ | 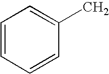 | H | CF₃ | O | 0 |
| A341 | CH₂CH(OCH₃)CH₂ | 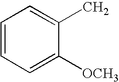 | H | CF₃ | O | 0 |
| A342 | CH₂CH(OCH₃)CH₂ | 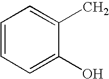 | H | CF₃ | O | 0 |
| A343 | CH₂CH(OCH₃)CH₂ | 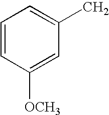 | H | CF₃ | O | 0 |
| A344 | CH₂CH(OCH₃)CH₂ | 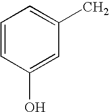 | H | CF₃ | O | 0 |
| A345 | CH₂CH(OCH₃)CH₂ | 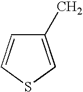 | H | CF₃ | O | 0 |
| A346 | CH₂CH(OCH₃)CH₂ | 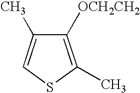 | H | CF₃ | O | 0 |
| A347 | CH₂CH(OCH₃)CH₂ | 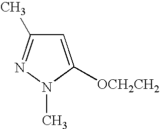 | H | CF₃ | O | 0 |
| A348 | CH₂CH(OCH₃)CH₂ | 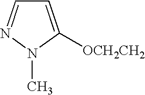 | H | CF₃ | O | 0 |
| A349 | CH₂CH(OCH₃)CH₂ | 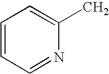 | H | CF₃ | O | 0 |
| A350 | CH₂CH(OCH₃)CH₂ | 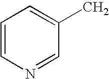 | H | CF₃ | O | 0 |
| A351 | CH₂CH(OCH₃)CH₂ | 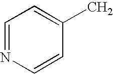 | H | CF₃ | O | 0 |
| A352 | CH₂CH(OCH₃)CH₂ | 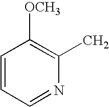 | H | CF₃ | O | 0 |
| A353 | CH₂CH(OCH₃)CH₂ | 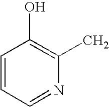 | H | CF₃ | O | 0 |
| A354 | CH₂CH(OCH₃)CH₂ | 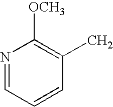 | H | CF₃ | O | 0 |
| A355 | CH₂CH(OCH₃)CH₂ | 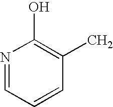 | H | CF₃ | O | 0 |
| A356 | CH₂CH(OCH₃)CH₂ | 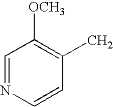 | H | CF₃ | O | 0 |
| A357 | CH₂CH(OCH₃)CH₂ | 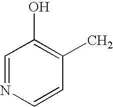 | H | CF₃ | O | 0 |
| A358 | CH₂CH(OCH₃)CH₂ | 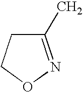 | H | CF₃ | O | 0 |
| A359 | CH₂CH(OCH₃)CH₂ | 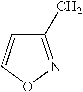 | H | CF₃ | O | 0 |
| A360 | CH₂CH(OCH₃)CH₂ | 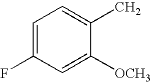 | H | CF₃ | O | 0 |
| A361 | CH₂CH(OCH₃)CH₂ | 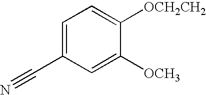 | H | CF₃ | O | 0 |
| A362 | CH₂CH(OCH₃)CH₂ | 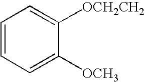 | H | CF₃ | O | 0 |
| A363 | CH₂CH(OCH₃)CH₂ | 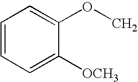 | H | CF₃ | O | 0 |
| A364 | CH═CHCH₂ | CH₃ | H | CF₃ | O | 0 |
| A365 | CH═CHCH₂ | CH₃CH₂ | H | CF₃ | O | 0 |
| A366 | CH═CHCH₂ | (CH₃)₂CH | H | CF₃ | O | 0 |
| A367 | CH═CHCH₂ | PhCH₂ | H | CF₃ | O | 0 |
| A368 | CH═CHCH₂ | CH₃ | H | CF₃ | S | 0 |
| A369 | CH═CHCH₂ | CH₃ | H | CF₃ | SO | 0 |
| A370 | CH═CHCH₂ | CH₃ | H | CF₃ | SO₂ | 0 |
| A371 | CH═CHCH₂ | CH₃CH₂CH₂ | H | CF₃ | O | |
| A372 | CH═CHCH₂ | CH₃OCH₂ | H | CF₃ | O | 0 |
| A373 | CH═CHCH₂ | CH₃CH₂OCH₂ | H | CF₃ | O | 0 |
| A374 | CH═CHCH₂ | CH₃OCH₂CH₂ | H | CF₃ | O | 0 |
| A375 | CH═CHCH₂ | CH₃CH₂OCH₂CH₂ | H | CF₃ | O | 0 |
| A376 | CH═CHCH₂ | CH₃OC(CH₃)₂CH₂ | H | CF₃ | O | 0 |
| A377 | CH═CHCH₂ | CH₃OCH(CH₃)CH₂ | H | CF₃ | O | 0 |
| A378 | CH═CHCH₂ | CH₃OCH₂CH(CH₃) | H | CF₃ | O | 0 |
| A379 | CH═CHCH₂ | CH₃OCH₂C(CH₃)₂ | H | CF₃ | O | 0 |
| A380 | CH═CHCH₂ | CH₃OCH(CH₃) | H | CF₃ | O | 0 |
| A381 | CH═CHCH₂ | CH₃OC(CH₃)₂ | H | CF₃ | O | 0 |
| A382 | CH═CHCH₂ | HC≡CCH₂ | H | CF₃ | O | 0 |
| A383 | CH═CHCH₂ | H₂C═CHCH₂ | H | CF₃ | O | 0 |
| A384 | CH═CHCH₂ | CH₃C≡CCH₂ | H | CF₃ | O | 0 |
| A385 | CH═CHCH₂ | 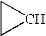 | H | CF₃ | O | 0 |
| A386 | CH═CHCH₂ | 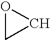 | H | CF₃ | O | 0 |
| A387 | CH═CHCH₂ | 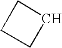 | H | CF₃ | O | 0 |
| A388 | CH═CHCH₂ | 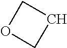 | H | CF₃ | O | 0 |
| A389 | CH═CHCH₂ | 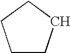 | H | CF₃ | O | 0 |
| A390 | CH═CHCH₂ | 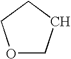 | H | CF₃ | O | 0 |
| A391 | CH═CHCH₂ | 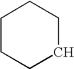 | H | CF₃ | O | 0 |
| A392 | CH═CHCH₂ | 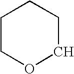 | H | CF₃ | O | 0 |
| A393 | CH═CHCH₂ | 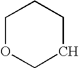 | H | CF₃ | O | 0 |
| A394 | CH═CHCH₂ | 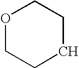 | H | CF₃ | O | 0 |
| A395 | CH═CHCH₂ | 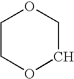 | H | CF₃ | O | 0 |
| A396 | CH═CHCH₂ | 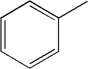 | H | CF₃ | O | 0 |
| A397 | CH═CHCH₂ | 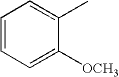 | H | CF₃ | O | 0 |
| A398 | CH═CHCH₂ | 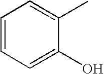 | H | CF₃ | O | 0 |
| A399 | CH═CHCH₂ | 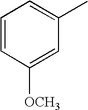 | H | CF₃ | O | 0 |
| A400 | CH═CHCH₂ | 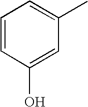 | H | CF₃ | O | 0 |
| A401 | CH═CHCH₂ | 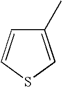 | H | CF₃ | O | 0 |
| A402 | CH═CHCH₂ | 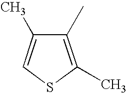 | H | CF₃ | O | 0 |
| A403 | CH═CHCH₂ | 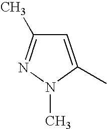 | H | CF₃ | O | 0 |
| A404 | CH═CHCH₂ | 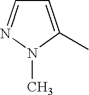 | H | CF₃ | O | 0 |
| A405 | CH═CHCH₂ | 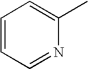 | H | CF₃ | O | 0 |
| A406 | CH═CHCH₂ | 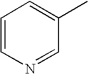 | H | CF₃ | O | 0 |
| A407 | CH═CHCH₂ | 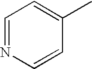 | H | CF₃ | O | 0 |
| A408 | CH═CHCH₂ | 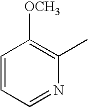 | H | CF₃ | O | 0 |
| A409 | CH═CHCH₂ | 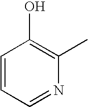 | H | CF₃ | O | 0 |
| A410 | CH═CHCH₂ | 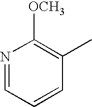 | H | CF₃ | O | 0 |
| A411 | CH═CHCH₂ | 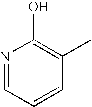 | H | CF₃ | O | 0 |
| A412 | CH═CHCH₂ | 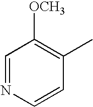 | H | CF₃ | O | 0 |
| A413 | CH═CHCH₂ | 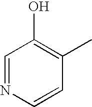 | H | CF₃ | O | 0 |
| A414 | CH═CHCH₂ | 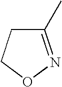 | H | CF₃ | O | 0 |
| A415 | CH═CHCH₂ | 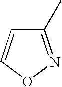 | H | CF₃ | O | 0 |
| A416 | CH═CHCH₂ | 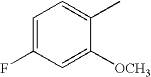 | H | CF₃ | O | 0 |
| A417 | CH═CHCH₂ | 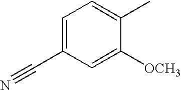 | H | CF₃ | O | 0 |
| A418 | CH═CHCH₂ | 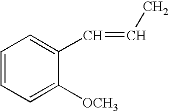 | H | CF₃ | O | 0 |
| A419 | CH═CHCH₂ | 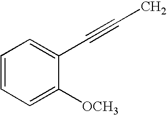 | H | CF₃ | O | 0 |
| A420 | CH═CHCH₂ | 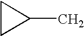 | H | CF₃ | O | 0 |
| A421 | CH═CHCH₂ | 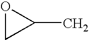 | H | CF₃ | O | 0 |
| A422 | CH═CHCH₂ | 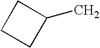 | H | CF₃ | O | 0 |
| A423 | CH═CHCH₂ | 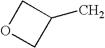 | H | CF₃ | O | 0 |
| A424 | CH═CHCH₂ | 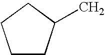 | H | CF₃ | O | 0 |
| A425 | CH═CHCH₂ | 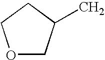 | H | CF₃ | O | 0 |
| A426 | CH═CHCH₂ | 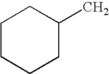 | H | CF₃ | O | 0 |
| A427 | CH═CHCH₂ | 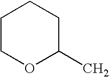 | H | CF₃ | O | 0 |
| A428 | CH═CHCH₂ | 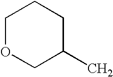 | H | CF₃ | O | 0 |
| A429 | CH═CHCH₂ | 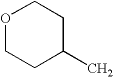 | H | CF₃ | O | 0 |
| A430 | CH═CHCH₂ | 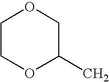 | H | CF₃ | O | 0 |
| A431 | CH═CHCH₂ | 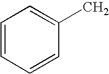 | H | CF₃ | O | 0 |
| A432 | CH═CHCH₂ | 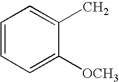 | H | CF₃ | O | 0 |
| A433 | CH═CHCH₂ | 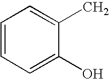 | H | CF₃ | O | 0 |
| A434 | CH═CHCH₂ | 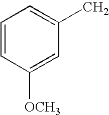 | H | CF₃ | O | 0 |
| A435 | CH═CHCH₂ | 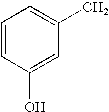 | H | CF₃ | O | 0 |
| A436 | CH═CHCH₂ | 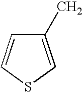 | H | CF₃ | O | 0 |
| A437 | CH═CHCH₂ | 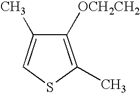 | H | CF₃ | O | 0 |
| A438 | CH═CHCH₂ | 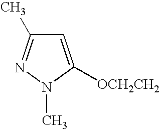 | H | CF₃ | O | 0 |
| A439 | CH═CHCH₂ | 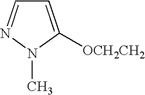 | H | CF₃ | O | 0 |
| A440 | CH═CHCH₂ | 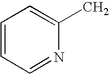 | H | CF₃ | O | 0 |
| A441 | CH═CHCH₂ | 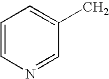 | H | CF₃ | O | 0 |
| A442 | CH═CHCH₂ | 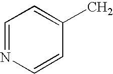 | H | CF₃ | O | 0 |
| A443 | CH═CHCH₂ | 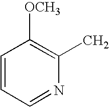 | H | CF₃ | O | 0 |
| A444 | CH═CHCH₂ | 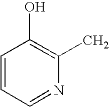 | H | CF₃ | O | 0 |
| A445 | CH═CHCH₂ | 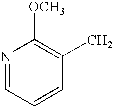 | H | CF₃ | O | 0 |
| A446 | CH═CHCH₂ | 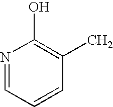 | H | CF₃ | O | 0 |
| A447 | CH═CHCH₂ | 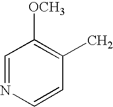 | H | CF₃ | O | 0 |
| A448 | CH═CHCH₂ | 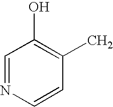 | H | CF₃ | O | 0 |
| A449 | CH═CHCH₂ | 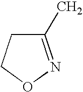 | H | CF₃ | O | 0 |
| A450 | CH═CHCH₂ | 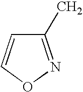 | H | CF₃ | O | 0 |
| A451 | CH═CHCH₂ | 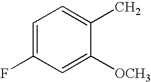 | H | CF₃ | O | 0 |
| A452 | CH═CHCH₂ | 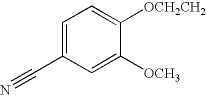 | H | CF₃ | O | 0 |
| A453 | CH═CHCH₂ | 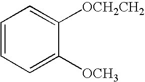 | H | CF₃ | O | 0 |
| A454 | CH═CHCH₂ | 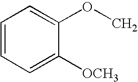 | H | CF₃ | O | 0 |
| A455 | C≡CCH₂ | CH₃ | H | CF₃ | O | 0 |
| A456 | C≡CCH₂ | CH₃CH₂ | H | CF₃ | O | 0 |
| A457 | C≡CCH₂ | (CH₃)₂CH | H | CF₃ | O | 0 |
| A458 | C≡CCH₂ | PhCH₂ | H | CF₃ | O | 0 |
| A459 | C≡CCH₂ | CH₃ | H | CF₃ | S | 0 |
| A460 | C≡CCH₂ | CH₃ | H | CF₃ | SO | 0 |
| A461 | C≡CCH₂ | CH₃ | H | CF₃ | SO₂ | 0 |
| A462 | C≡CCH₂ | CH₃CH₂CH₂ | H | CF₃ | O | 0 |
| A463 | C≡CCH₂ | CH₃OCH₂ | H | CF₃ | O | 0 |
| A464 | C≡CCH₂ | CH₃CH₂OCH₂ | H | CF₃ | O | 0 |
| A465 | C≡CCH₂ | CH₃OCH₂CH₂ | H | CF₃ | O | 0 |
| A466 | C≡CCH₂ | CH₃CH₂OCH₂CH₂ | H | CF₃ | O | 0 |
| A467 | C≡CCH₂ | CH₃OC(CH₃)₂CH₂ | H | CF₃ | O | 0 |
| A468 | C≡CCH₂ | CH₃OCH(CH₃)CH₂ | H | CF₃ | O | 0 |
| A469 | C≡CCH₂ | CH₃OCH₂CH(CH₃) | H | CF₃ | O | 0 |
| A470 | C≡CCH₂ | CH₃OCH₂C(CH₃)₂ | H | CF₃ | O | 0 |
| A471 | C≡CCH₂ | CH₃OCH(CH₃) | H | CF₃ | O | 0 |
| A472 | C≡CCH₂ | CH₃OC(CH₃)₂ | H | CF₃ | O | 0 |
| A473 | C≡CCH₂ | HC≡CCH₂ | H | CF₃ | O | 0 |
| A474 | C≡CCH₂ | H₂C═CHCH₂ | H | CF₃ | O | 0 |
| A475 | C≡CCH₂ | CH₃C≡CCH₂ | H | CF₃ | O | 0 |
| A476 | C≡CCH₂ | 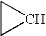 | H | CF₃ | O | 0 |
| A477 | C≡CCH₂ | 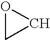 | H | CF₃ | O | 0 |
| A478 | C≡CCH₂ | 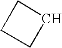 | H | CF₃ | O | 0 |
| A479 | C≡CCH₂ | 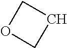 | H | CF₃ | O | 0 |
| A480 | C≡CCH₂ | 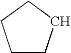 | H | CF₃ | O | 0 |
| A481 | C≡CCH₂ | 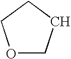 | H | CF₃ | O | 0 |
| A482 | C≡CCH₂ | 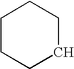 | H | CF₃ | O | 0 |
| A483 | C≡CCH₂ | 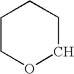 | H | CF₃ | O | 0 |
| A484 | C≡CCH₂ | 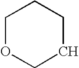 | H | CF₃ | O | 0 |
| A485 | C≡CCH₂ | 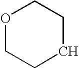 | H | CF₃ | O | 0 |
| A486 | C≡CCH₂ | 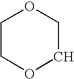 | H | CF₃ | O | 0 |
| A487 | C≡CCH₂ | 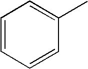 | H | CF₃ | O | 0 |
| A488 | C≡CCH₂ | 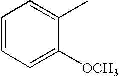 | H | CF₃ | O | 0 |
| A489 | C≡CCH₂ | 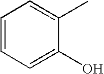 | H | CF₃ | O | 0 |
| A490 | C≡CCH₂ | 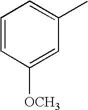 | H | CF₃ | O | 0 |
| A491 | C≡CCH₂ | 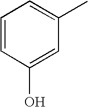 | H | CF₃ | O | 0 |
| A492 | C≡CCH₂ | 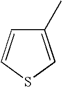 | H | CF₃ | O | 0 |
| A493 | C≡CCH₂ | 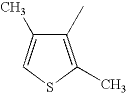 | H | CF₃ | O | 0 |
| A494 | C≡CCH₂ | 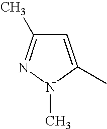 | H | CF₃ | O | 0 |
| A495 | C≡CCH₂ | 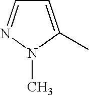 | H | CF₃ | O | 0 |
| A496 | C≡CCH₂ | 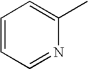 | H | CF₃ | O | 0 |
| A497 | C≡CCH₂ | 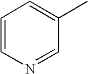 | H | CF₃ | O | 0 |
| A498 | C≡CCH₂ | 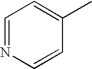 | H | CF₃ | O | 0 |
| A499 | C≡CCH₂ | 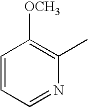 | H | CF₃ | O | 0 |
| A500 | C≡CCH₂ | 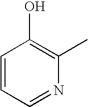 | H | CF₃ | O | 0 |
| A501 | C≡CCH₂ | 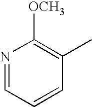 | H | CF₃ | O | 0 |
| A502 | C≡CCH₂ | 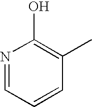 | H | CF₃ | O | 0 |
| A503 | C≡CCH₂ | 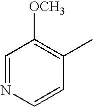 | H | CF₃ | O | 0 |
| A504 | C≡CCH₂ | 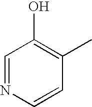 | H | CF₃ | O | 0 |
| A505 | C≡CCH₂ | 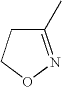 | H | CF₃ | O | 0 |
| A506 | C≡CCH₂ | 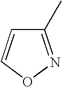 | H | CF₃ | O | 0 |
| A507 | C≡CCH₂ | 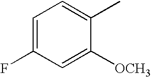 | H | CF₃ | O | 0 |
| A508 | C≡CCH₂ | 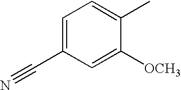 | H | CF₃ | O | 0 |
| A509 | C≡CCH₂ | 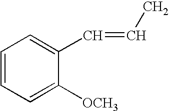 | H | CF₃ | O | 0 |
| A510 | C≡CCH₂ | 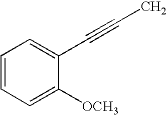 | H | CF₃ | O | 0 |
| A511 | C≡CCH₂ | 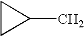 | H | CF₃ | O | 0 |
| A512 | C≡CCH₂ | 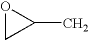 | H | CF₃ | O | 0 |
| A513 | C≡CCH₂ | 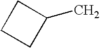 | H | CF₃ | O | 0 |
| A514 | C≡CCH₂ | 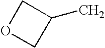 | H | CF₃ | O | 0 |
| A515 | C≡CCH₂ | 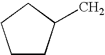 | H | CF₃ | O | 0 |
| A516 | C≡CCH₂ | 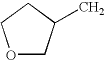 | H | CF₃ | O | 0 |
| A517 | C≡CCH₂ | 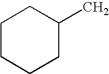 | H | CF₃ | O | 0 |
| A518 | C≡CCH₂ | 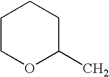 | H | CF₃ | O | 0 |
| A519 | C≡CCH₂ | 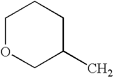 | H | CF₃ | O | 0 |
| A520 | C≡CCH₂ | 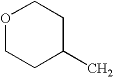 | H | CF₃ | O | 0 |
| A521 | C≡CCH₂ | 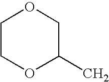 | H | CF₃ | O | 0 |
| A522 | C≡CCH₂ | 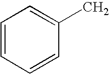 | H | CF₃ | O | 0 |
| A523 | C≡CCH₂ | 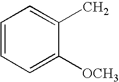 | H | CF₃ | O | 0 |
| A524 | C≡CCH₂ | 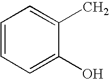 | H | CF₃ | O | 0 |
| A525 | C≡CCH₂ | 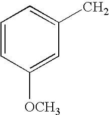 | H | CF₃ | O | 0 |
| A526 | C≡CCH₂ | 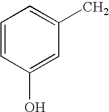 | H | CF₃ | O | 0 |
| A527 | C≡CCH₂ | 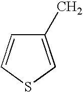 | H | CF₃ | O | 0 |
| A528 | C≡CCH₂ | 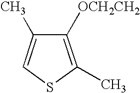 | H | CF₃ | O | 0 |
| A529 | C≡CCH₂ | 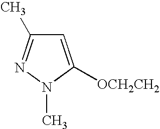 | H | CF₃ | O | 0 |
| A530 | C≡CCH₂ | 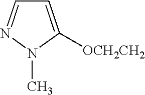 | H | CF₃ | O | 0 |
| A531 | C≡CCH₂ | 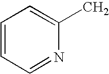 | H | CF₃ | O | 0 |
| A532 | C≡CCH₂ | 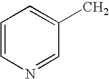 | H | CF₃ | O | 0 |
| A533 | C≡CCH₂ | 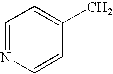 | H | CF₃ | O | 0 |
| A534 | C≡CCH₂ | 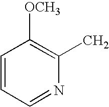 | H | CF₃ | O | 0 |
| A535 | C≡CCH₂ | 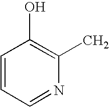 | H | CF₃ | O | 0 |
| A536 | C≡CCH₂ | 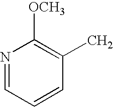 | H | CF₃ | O | 0 |
| A537 | C≡CCH₂ | 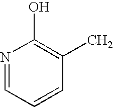 | H | CF₃ | O | 0 |
| A538 | C≡CCH₂ | 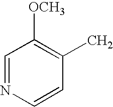 | H | CF₃ | O | 0 |
| A539 | C≡CCH₂ | 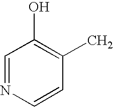 | H | CF₃ | O | 0 |
| A540 | C≡CCH₂ | 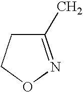 | H | CF₃ | O | 0 |
| A541 | C≡CCH₂ | 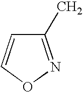 | H | CF₃ | O | 0 |
| A542 | C≡CCH₂ | 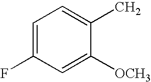 | H | CF₃ | O | 0 |
| A543 | C≡CCH₂ | 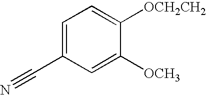 | H | CF₃ | O | 0 |
| A544 | C≡CCH₂ | 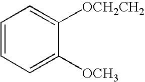 | H | CF₃ | O | 0 |
| A545 | C≡CCH₂ | 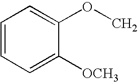 | H | CF₃ | O | 0 |
| A546 | CH₂ | CH₃ | H | CF₂Cl | O | 0 |
| A547 | CH₂ | CH₃CH₂ | H | CF₂Cl | O | 0 |
| A548 | CH₂ | (CH₃)₂CH | H | CF₂Cl | O | 0 |
| A549 | CH₂ | PhCH₂ | H | CF₂Cl | O | 0 |
| A550 | CH₂ | CH₃ | H | CF₂Cl | S | 0 |
| A551 | CH₂ | CH₃ | H | CF₂Cl | SO | 0 |
| A552 | CH₂ | CH₃ | H | CF₂Cl | SO₂ | 0 |
| A553 | CH₂ | CH₃CH₂CH₂ | H | CF₂Cl | O | 0 |
| A554 | CH₂ | CH₃OCH₂ | H | CF₂Cl | O | 0 |
| A555 | CH₂ | CH₃CH₂OCH₂ | H | CF₂Cl | O | 0 |
| A556 | CH₂ | CH₃OCH₂CH₂ | H | CF₂Cl | O | 0 |
| A557 | CH₂ | CH₃CH₂OCH₂CH₂ | H | CF₂Cl | O | 0 |
| A558 | CH₂ | CH₃OC(CH₃)₂CH₂ | H | CF₂Cl | O | 0 |
| A559 | CH₂ | CH₃OCH(CH₃)CH₂ | H | CF₂Cl | O | 0 |
| A560 | CH₂ | CH₃OCH₂CH(CH₃) | H | CF₂Cl | O | 0 |
| A561 | CH₂ | CH₃OCH₂C(CH₃)₂ | H | CF₂Cl | O | 0 |
| A562 | CH₂ | CH₃OCH(CH₃) | H | CF₂Cl | O | 0 |
| A563 | CH₂ | CH₃OC(CH₃)₂ | H | CF₂Cl | O | 0 |
| A564 | CH₂ | HC≡CCH₂ | H | CF₂Cl | O | 0 |
| A565 | CH₂ | H₂C═CHCH₂ | H | CF₂Cl | O | 0 |
| A566 | CH₂ | CH₃C≡CCH₂ | H | CF₂Cl | O | 0 |
| A567 | CH₂ | 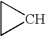 | H | CF₂Cl | O | 0 |
| A568 | CH₂ | 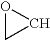 | H | CF₂Cl | O | 0 |
| A569 | CH₂ | 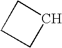 | H | CF₂Cl | O | 0 |
| A570 | CH₂ | 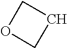 | H | CF₂Cl | O | 0 |
| A571 | CH₂ | 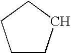 | H | CF₂Cl | O | 0 |
| A572 | CH₂ | 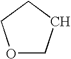 | H | CF₂Cl | O | 0 |
| A573 | CH₂ | 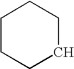 | H | CF₂Cl | O | 0 |
| A574 | CH₂ | 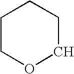 | H | CF₂Cl | O | 0 |
| A575 | CH₂ | 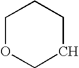 | H | CF₂Cl | O | 0 |
| A576 | CH₂ | 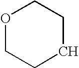 | H | CF₂Cl | O | 0 |
| A577 | CH₂ | 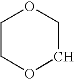 | H | CF₂Cl | O | 0 |
| A578 | CH₂ | 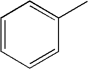 | H | CF₂Cl | O | 0 |
| A579 | CH₂ | 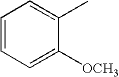 | H | CF₂Cl | O | 0 |
| A580 | CH₂ | 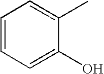 | H | CF₂Cl | O | 0 |
| A581 | CH₂ | 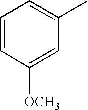 | H | CF₂Cl | O | 0 |
| A582 | CH₂ | 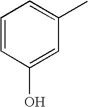 | H | CF₂Cl | O | 0 |
| A583 | CH₂ | 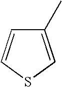 | H | CF₂Cl | O | 0 |
| A584 | CH₂ | 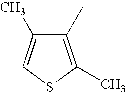 | H | CF₂Cl | O | 0 |
| A585 | CH₂ | 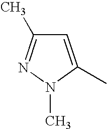 | H | CF₂Cl | O | 0 |
| A586 | CH₂ | 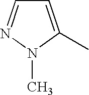 | H | CF₂Cl | O | 0 |
| A587 | CH₂ | 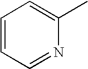 | H | CF₂Cl | O | 0 |
| A588 | CH₂ | 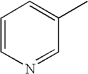 | H | CF₂Cl | O | 0 |
| A589 | CH₂ | 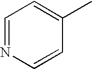 | H | CF₂Cl | O | 0 |
| A590 | CH₂ | 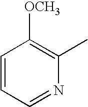 | H | CF₂Cl | O | 0 |
| A591 | CH₂ | 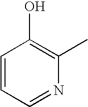 | H | CF₂Cl | O | 0 |
| A592 | CH₂ | 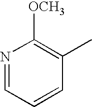 | H | CF₂Cl | O | 0 |
| A593 | CH₂ | 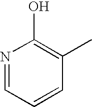 | H | CF₂Cl | O | 0 |
| A594 | CH₂ | 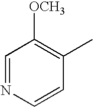 | H | CF₂Cl | O | 0 |
| A595 | CH₂ | 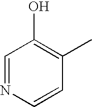 | H | CF₂Cl | O | 0 |
| A596 | CH₂ | 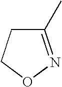 | H | CF₂Cl | O | 0 |
| A597 | CH₂ | 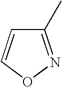 | H | CF₂Cl | O | 0 |
| A598 | CH₂ | 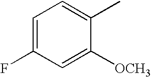 | H | CF₂Cl | O | 0 |
| A599 | CH₂ | 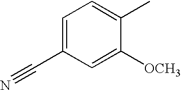 | H | CF₂Cl | O | 0 |
| A600 | CH₂ | 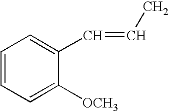 | H | CF₂Cl | O | 0 |
| A601 | CH₂ | 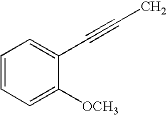 | H | CF₂Cl | O | 0 |
| A602 | CH₂ | 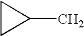 | H | CF₂Cl | O | 0 |

| Radical | R₁ | R₂ | R₄ | R₃ | X₁ | p |
|---|---|---|---|---|---|---|
| A603 | CH₂ | 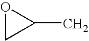 | H | CF₂Cl | O | 0 |
| A604 | CH₂ | 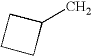 | H | CF₂Cl | O | 0 |
| A605 | CH₂ | 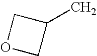 | H | CF₂Cl | O | 0 |
| A606 | CH₂ | 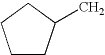 | H | CF₂Cl | O | 0 |
| A607 | CH₂ | 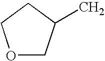 | H | CF₂Cl | O | 0 |
| A608 | CH₂ | 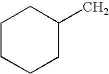 | H | CF₂Cl | O | 0 |
| A609 | CH₂ | 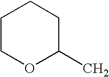 | H | CF₂Cl | O | 0 |
| A610 | CH₂ | 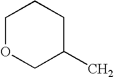 | H | CF₂Cl | O | 0 |
| A611 | CH₂ | 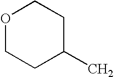 | H | CF₂Cl | O | 0 |
| A612 | CH₂ | 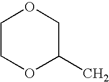 | H | CF₂Cl | O | 0 |
| A613 | CH₂ | 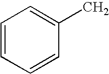 | H | CF₂Cl | O | 0 |
| A614 | CH₂ | 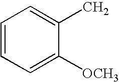 | H | CF₂Cl | O | 0 |
| A615 | CH₂ | 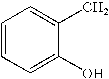 | H | CF₂Cl | O | 0 |
| A616 | CH₂ | 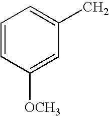 | H | CF₂Cl | O | 0 |
| A617 | CH₂ | 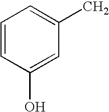 | H | CF₂Cl | O | 0 |
| A618 | CH₂ | 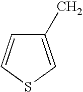 | H | CF₂Cl | O | 0 |
| A619 | CH₂ | 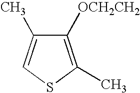 | H | CF₂Cl | O | 0 |
| A620 | CH₂ | 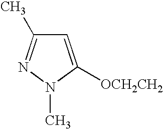 | H | CF₂Cl | O | 0 |
| A621 | CH₂ | 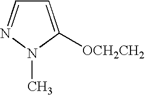 | H | CF₂Cl | O | 0 |
| A622 | CH₂ | 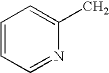 | H | CF₂Cl | O | 0 |
| A623 | CH₂ | 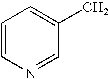 | H | CF₂Cl | O | 0 |
| A624 | CH₂ | 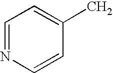 | H | CF₂Cl | O | 0 |
| A625 | CH₂ | 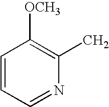 | H | CF₂Cl | O | 0 |
| A626 | CH₂ | 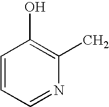 | H | CF₂Cl | O | 0 |
| A627 | CH₂ | 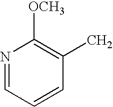 | H | CF₂Cl | O | 0 |
| A628 | CH₂ | 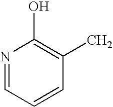 | H | CF₂Cl | O | 0 |
| A629 | CH₂ | 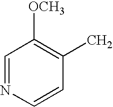 | H | CF₂Cl | O | 0 |
| A630 | CH₂ | 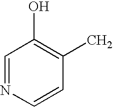 | H | CF₂Cl | O | 0 |
| A631 | CH₂ | 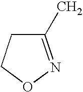 | H | CF₂Cl | O | 0 |
| A632 | CH₂ | 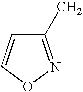 | H | CF₂Cl | O | 0 |
| A633 | CH₂ | 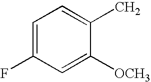 | H | CF₂Cl | O | 0 |
| A634 | CH₂ | 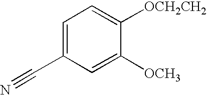 | H | CF₂Cl | O | 0 |
| A635 | CH₂ | 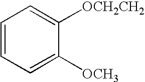 | H | CF₂Cl | O | 0 |
| A636 | CH₂ | 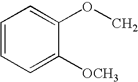 | H | CF₂Cl | O | 0 |
| A637 | CH₂ | CH₃ | H | CHF₂ | O | 0 |
| A638 | CH₂ | CH₂CH₃ | H | CHF₂ | O | 0 |
| A639 | CH₂ | (CH₃)₂CH | H | CHF₂ | O | 0 |
| A640 | CH₂ | PhCH₂ | H | CHF₂ | O | 0 |
| A641 | CH₂ | CH₃ | H | CHF₂ | O | 0 |
| A642 | CH₂ | CH₃ | H | CHF₂ | O | 0 |
| A643 | CH₂ | CH₃ | H | CHF₂ | O | 0 |
| A644 | CH₂ | CH₃OCH₂ | H | CHF₂ | O | 0 |
| A645 | CH₂ | CH₃CH₂OCH₂ | H | CHF₂ | O | 0 |
| A646 | CH₂ | CH₃OCH₂CH₂ | H | CHF₂ | O | 0 |
| A647 | CH₂ | CH₃CH₂OCH₂CH₂ | H | CHF₂ | O | 0 |
| A648 | CH₂ | CH₃OC(CH₃)₂CH₂ | H | CHF₂ | O | 0 |
| A649 | CH₂ | CH₃OCH(CH₃)CH₂ | H | CHF₂ | O | 0 |
| A650 | CH₂ | CH₃OCH₂CH(CH₃) | H | CHF₂ | O | 0 |
| A651 | CH₂ | CH₃OCH₂C(CH₃)₂ | H | CHF₂ | O | 0 |
| A652 | CH₂ | CH₃OCH(CH₃) | H | CHF₂ | O | 0 |
| A653 | CH₂ | CH₃OC(CH₃)₂ | H | CHF₂ | O | 0 |
| A654 | CH₂ | HC≡CCH₂ | H | CHF₂ | O | 0 |
| A655 | CH₂ | H₃C═CHCH₂ | H | CHF₂ | O | 0 |
| A656 | CH₂ | CH₃C≡CCH₂ | H | CHF₂ | O | 0 |
| A657 | CH₂ | 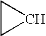 | H | CHF₂ | O | 0 |
| A658 | CH₂ | 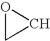 | H | CHF₂ | O | 0 |
| A659 | CH₂ | 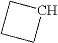 | H | CHF₂ | O | 0 |
| A660 | CH₂ | 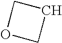 | H | CHF₂ | O | 0 |
| A661 | CH₂ | 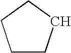 | H | CHF₂ | O | 0 |
| A662 | CH₂ | 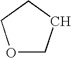 | H | CHF₂ | O | 0 |
| A663 | CH₂ | 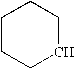 | H | CHF₂ | O | 0 |
| A664 | CH₂ | 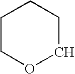 | H | CHF₂ | O | 0 |
| A665 | CH₂ | 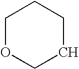 | H | CHF₂ | O | 0 |
| A666 | CH₂ | 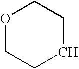 | H | CHF₂ | O | 0 |
| A667 | CH₂ | 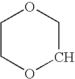 | H | CHF₂ | O | 0 |
| A668 | CH₂ | 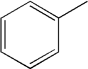 | H | CHF₂ | O | 0 |
| A669 | CH₂ | 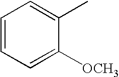 | H | CHF₂ | O | 0 |
| A670 | CH₂ | 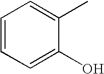 | H | CHF₂ | O | 0 |
| A671 | CH₂ | 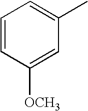 | H | CHF₂ | O | 0 |
| A672 | CH₂ | 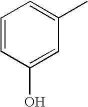 | H | CHF₂ | O | 0 |
| A673 | CH₂ | 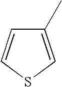 | H | CHF₂ | O | 0 |
| A674 | CH₂ | 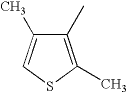 | H | CHF₂ | O | 0 |
| A675 | CH₂ | 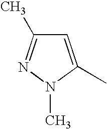 | H | CHF₂ | O | 0 |
| A676 | CH₂ | 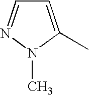 | H | CHF₂ | O | 0 |
| A677 | CH₂ | 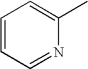 | H | CHF₂ | O | 0 |
| A678 | CH₂ | 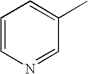 | H | CHF₂ | O | 0 |
| A679 | CH₂ | 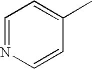 | H | CHF₂ | O | 0 |
| A680 | CH₂ | 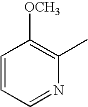 | H | CHF₂ | O | 0 |
| A681 | CH₂ | 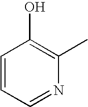 | H | CHF₂ | O | 0 |
| A682 | CH₂ | 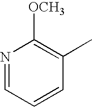 | H | CHF₂ | S | 0 |
| A683 | CH₂ | 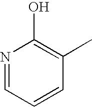 | H | CHF₂ | SO | 0 |
| A684 | CH₂ | 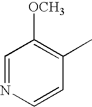 | H | CHF₂ | SO₂ | 0 |
| A685 | CH₂ | 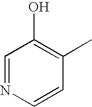 | H | CHF₂ | O | 0 |
| A686 | CH₂ | 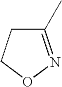 | H | CHF₂ | O | 0 |
| A687 | CH₂ | 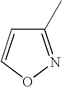 | H | CHF₂ | O | 0 |
| A688 | CH₂ | 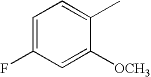 | H | CHF₂ | O | 0 |
| A689 | CH₂ | 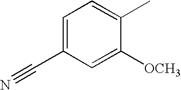 | H | CHF₂ | O | 0 |
| A690 | CH₂ | 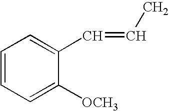 | H | CHF₂ | O | 0 |
| A691 | CH₂ | 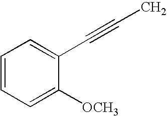 | H | CHF₂ | O | 0 |
| A692 | CH₂ | 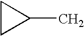 | H | CHF₂ | O | 0 |
| A693 | CH₂ | 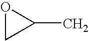 | H | CHF₂ | O | 0 |
| A694 | CH₂ | 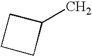 | H | CHF₂ | O | 0 |
| A695 | CH₂ | 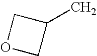 | H | CHF₂ | O | 0 |
| A696 | CH₂ | 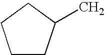 | H | CHF₂ | O | 0 |
| A697 | CH₂ | 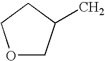 | H | CHF₂ | O | 0 |
| A698 | CH₂ | 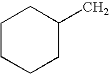 | H | CHF₂ | O | 0 |
| A699 | CH₂ | 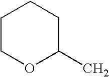 | H | CHF₂ | O | 0 |
| A700 | CH₂ | 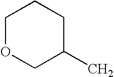 | H | CHF₂ | O | 0 |
| A701 | CH₂ | 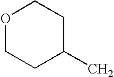 | H | CHF₂ | O | 0 |
| A702 | CH₂ | 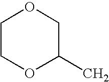 | H | CHF₂ | O | 0 |
| A703 | CH₂ | 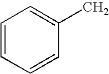 | H | CHF₂ | O | 0 |
| A704 | CH₂ | 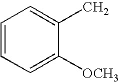 | H | CHF₂ | O | 0 |
| A705 | CH₂ | 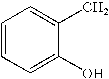 | H | CHF₂ | O | 0 |
| A706 | CH₂ | 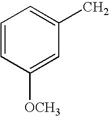 | H | CHF₂ | O | 0 |
| A707 | CH₂ | 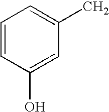 | H | CHF₂ | O | 0 |
| A708 | CH₂ | 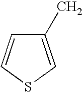 | H | CHF₂ | O | 0 |
| A709 | CH₂ | 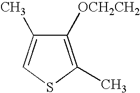 | H | CHF₂ | O | 0 |
| A710 | CH₂ | 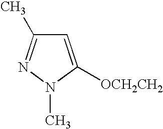 | H | CHF₂ | O | 0 |
| A711 | CH₂ | 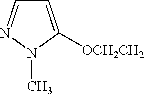 | H | CHF₂ | O | 0 |
| A712 | CH₂ | 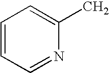 | H | CHF₂ | O | 0 |
| A713 | CH₂ | 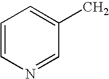 | H | CHF₂ | O | 0 |
| A714 | CH₂ | 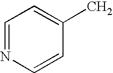 | H | CHF₂ | O | 0 |
| A715 | CH₂ | 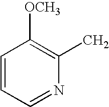 | H | CHF₂ | O | 0 |
| A716 | CH₂ | 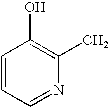 | H | CHF₂ | O | 0 |
| A717 | CH₂ | 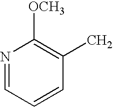 | H | CHF₂ | O | 0 |
| A718 | CH₂ | 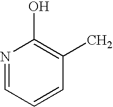 | H | CHF₂ | O | 0 |
| A719 | CH₂ | 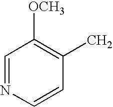 | H | CHF₂ | O | 0 |
| A720 | CH₂ | 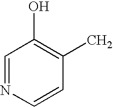 | H | CHF₂ | O | 0 |
| A721 | CH₂ | 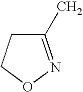 | H | CHF₂ | O | 0 |
| A722 | CH₂ | 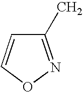 | H | CHF₂ | O | 0 |
| A723 | CH₂ | 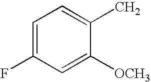 | H | CHF₂ | O | 0 |
| A724 | CH₂ | 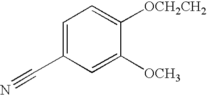 | H | CHF₂ | O | 0 |
| A725 | CH₂ | 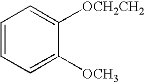 | H | CHF₂ | O | 0 |
| A726 | CH₂ | 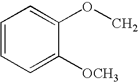 | H | CHF₂ | O | 0 |
| A727 | CH₂ | CH₃ | H | CF₃ | O | 1 |
| A728 | CH₂ | CH₂CH₃ | H | CF₃ | O | 1 |
| A729 | CH₂ | (CH₃)₂CH | H | CF₃ | O | 1 |
| A730 | CH₂ | PhCH₂ | H | CF₃ | O | 1 |
| A731 | CH₂ | CH₃ | H | CF₃ | S | 1 |
| A732 | CH₂ | CH₃ | H | CF₃ | SO | 1 |
| A733 | CH₂ | CH₃ | H | CF₃ | SO₂ | 1 |
| A734 | CH₂ | CH₃OCH₂ | H | CF₃ | O | 1 |
| A735 | CH₂ | CH₃CH₂OCH₂ | H | CF₃ | O | 1 |
| A736 | CH₂ | CH₃OCH₂CH₂ | H | CF₃ | O | 1 |
| A737 | CH₂ | CH₃CH₂OCH₂CH₂ | H | CF₃ | O | 1 |
| A738 | CH₂ | CH₃OC(CH₃)₂CH₂ | H | CF₃ | O | 1 |
| A739 | CH₂ | CH₃OCH(CH₃)CH₂ | H | CF₃ | O | 1 |
| A740 | CH₂ | CH₃OCH₂CH(CH₃) | H | CF₃ | O | 1 |
| A741 | CH₂ | CH₃OCH₂C(CH₃)₂ | H | CF₃ | O | 1 |
| A742 | CH₂ | CH₃OCH(CH₃) | H | CF₃ | O | 1 |
| A743 | CH₂ | CH₃OC(CH₃)₂ | H | CF₃ | O | 1 |
| A744 | CH₂ | HC≡CCH₂ | H | CF₃ | O | 1 |
| A745 | CH₂ | H₃C═CHCH₂ | H | CF₃ | O | 1 |
| A746 | CH₂ | CH₃C≡CCH₂ | H | CF₃ | O | 1 |
| A747 | CH₂ | 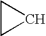 | H | CF₃ | O | 1 |
| A748 | CH₂ | 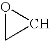 | H | CF₃ | O | 1 |
| A749 | CH₂ | 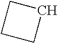 | H | CF₃ | O | 1 |
| A750 | CH₂ | 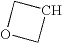 | H | CF₃ | O | 1 |
| A751 | CH₂ | 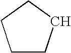 | H | CF₃ | O | 1 |
| A752 | CH₂ | 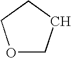 | H | CF₃ | O | 1 |
| A753 | CH₂ | 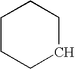 | H | CF₃ | O | 1 |
| A754 | CH₂ | 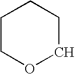 | H | CF₃ | O | 1 |
| A755 | CH₂ | 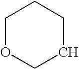 | H | CF₃ | O | 1 |
| A756 | CH₂ | 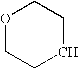 | H | CF₃ | O | 1 |
| A757 | CH₂ | 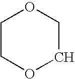 | H | CF₃ | O | 1 |
| A758 | CH₂ | 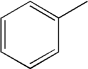 | H | CF₃ | O | 1 |
| A759 | CH₂ | 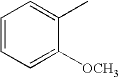 | H | CF₃ | O | 1 |
| A760 | CH₂ | 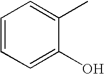 | H | CF₃ | O | 1 |
| A761 | CH₂ | 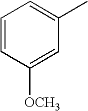 | H | CF₃ | O | 1 |
| A762 | CH₂ | 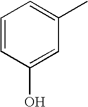 | H | CF₃ | O | 1 |
| A763 | CH₂ | 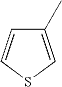 | H | CF₃ | O | 1 |
| A764 | CH₂ | 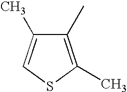 | H | CF₃ | O | 1 |
| A765 | CH₂ | 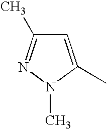 | H | CF₃ | O | 1 |
| A766 | CH₂ | 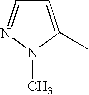 | H | CF₃ | O | 1 |
| A767 | CH₂ | 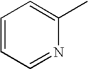 | H | CF₃ | O | 1 |
| A768 | CH₂ | 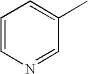 | H | CF₃ | O | 1 |
| A769 | CH₂ | 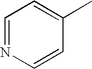 | H | CF₃ | O | 1 |
| A770 | CH₂ | 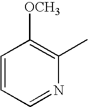 | H | CF₃ | O | 1 |
| A771 | CH₂ | 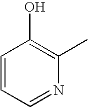 | H | CF₃ | O | 1 |
| A772 | CH₂ | 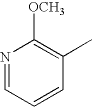 | H | CF₃ | O | 1 |
| A773 | CH₂ | 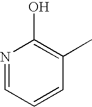 | H | CF₃ | O | 1 |
| A774 | CH₂ | 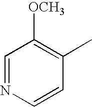 | H | CF₃ | O | 1 |
| A775 | CH₂ | 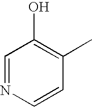 | H | CF₃ | O | 1 |
| A776 | CH₂ | 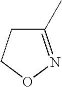 | H | CF₃ | O | 1 |
| A777 | CH₂ | 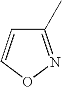 | H | CF₃ | O | 1 |
| A778 | CH₂ | 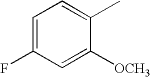 | H | CF₃ | O | 1 |
| A779 | CH₂ | 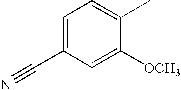 | H | CF₃ | O | 1 |
| A780 | CH₂ | 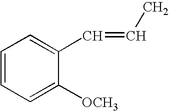 | H | CF₃ | O | 1 |
| A781 | CH₂ | 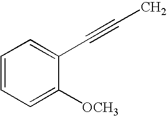 | H | CF₃ | O | 1 |
| A782 | CH₂ | 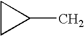 | H | CF₃ | O | 1 |
| A783 | CH₂ | 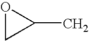 | H | CF₃ | O | 1 |
| A784 | CH₂ | 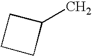 | H | CF₃ | O | 1 |
| A785 | CH₂ | 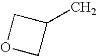 | H | CF₃ | O | 1 |
| A786 | CH₂ | 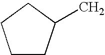 | H | CF₃ | O | 1 |
| A787 | CH₂ | 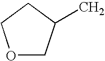 | H | CF₃ | O | 1 |
| A788 | CH₂ | 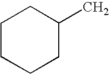 | H | CF₃ | O | 1 |
| A789 | CH₂ | 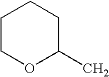 | H | CF₃ | O | 1 |
| A790 | CH₂ | 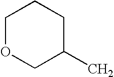 | H | CF₃ | O | 1 |
| A791 | CH₂ | 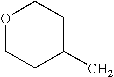 | H | CF₃ | O | 1 |
| A792 | CH₂ | 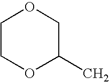 | H | CF₃ | O | 1 |
| A793 | CH₂ | 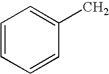 | H | CF₃ | O | 1 |
| A794 | CH₂ | 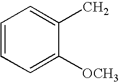 | H | CF₃ | O | 1 |
| A795 | CH₂ | 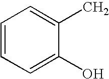 | H | CF₃ | O | 1 |
| A796 | CH₂ | 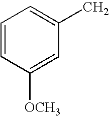 | H | CF₃ | O | 1 |
| A797 | CH₂ | 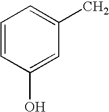 | H | CF₃ | O | 1 |
| A798 | CH₂ | 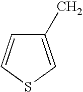 | H | CF₃ | O | 1 |
| A799 | CH₂ | 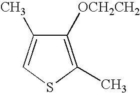 | H | CF₃ | O | 1 |
| A800 | CH₂ | 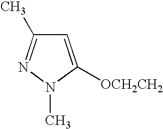 | H | CF₃ | O | 1 |
| A801 | CH₂ | 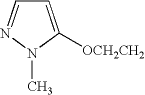 | H | CF₃ | O | 1 |
| A802 | CH₂ | 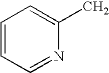 | H | CF₃ | O | 1 |
| A803 | CH₂ | 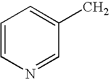 | H | CF₃ | O | 1 |
| A804 | CH₂ | 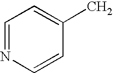 | H | CF₃ | O | 1 |
| A805 | CH₂ | 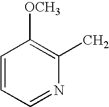 | H | CF₃ | O | 1 |
| A806 | CH₂ | 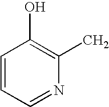 | H | CF₃ | O | 1 |
| A807 | CH₂ | 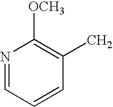 | H | CF₃ | O | 1 |
| A808 | CH₂ | 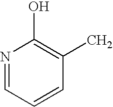 | H | CF₃ | O | 1 |
| A809 | CH₂ | 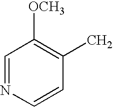 | H | CF₃ | O | 1 |
| A810 | CH₂ | 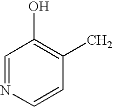 | H | CF₃ | O | 1 |
| A811 | CH₂ | 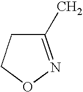 | H | CF₃ | O | 1 |
| A812 | CH₂ | 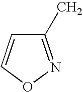 | H | CF₃ | O | 1 |
| A813 | CH₂ | 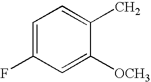 | H | CF₃ | O | 1 |
| A814 | CH₂ | 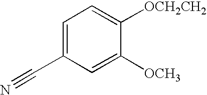 | H | CF₃ | O | 1 |
| A815 | CH₂ | 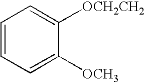 | H | CF₃ | O | 1 |
| A816 | CH₂ | 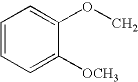 | H | CF₃ | O | 1 |
| A817 | CH₂ | CH₃SCH₂CH₂ | H | CF₃ | O | 0 |
| A818 | CH₂ | CH₃SOCH₂CH₂ | H | CF₃ | O | 0 |
| A819 | CH₂ | CH₃SO₂CH₂CH₂ | H | CF₃ | O | 0 |
| A820 | CH₂ | CH₃OCH₂CH₂ | H | CF₂Cl | O | 1 |
| A821 | CH₂ | CH₃OCH₂CH₂ | H | CF₂H | O | 1 |
| A822 | CH₂ | CH₃OCH₂CH₂ | F | CF₃ | O | 0 |
| A823 | CH₂ | CH₃OCH₂CH₂ | CH₃ | CF₃ | O | 0 |
| A824 | CH₂ | CH₃OCH₂CH₂ | CH₃ | CF₃ | O | 1 |
| A825 | CH₂ | CH₃OCH₂CH₂ | H | CF₃ | S | 0 |
| A826 | CH₂ | CH₃OCH₂CH₂ | H | CF₃ | SO | 0 |
| A827 | CH₂ | CH₃OCH₂CH₂ | CH₃ | CF₃ | SO₂ | 0 |
| A828 | CH₂ | CH₃SO₂CH₂CH₂ | CH₃ | CF₃ | O | 0 |
| A829 | CH₂ | 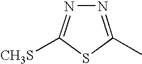 | H | CF₃ | S | 0 |
| A830 | CH₂ | 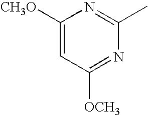 | H | CF₃ | S | 0 |
| A831 | CH₂ | 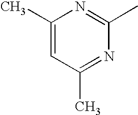 | CH₃ | CF₃ | S | 0 |
| A832 | CH₂ | 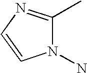 | CH₃ | CF₃ | S | 0 |
| A833 | CH₂ | CH₃C(O) | H | CF₃ | O | 0 |
| A834 | CH₂ | CF₃CH₂ | H | CF₃ | O | 0 |
| A835 | CH₂ | CH₃OCH₂CH₂OCH₂CH₂ | H | CF₃ | O | 0 |
| A836 | CH₂ | HC≡CCH₂CH₂ | H | CF₃ | O | 0 |
| A837 | CH₂ | 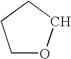 | H | CF₃ | O | 0 |
| A838 | CH₂ | CH₃CH₂C(OCH₃)HOCH₂CH₂ | H | CF₃ | O | 0 |
| A839 | CH₂ | (CH₃)₃CC(O) | H | CF₃ | O | 0 |
| A840 | CH₂ | CH₂═CHCH₂OCH₂CH₂ | H | CF₃ | O | 0 |
| A841 | CH₂ | CH₃CH₂CH₂OCH₂CH₂ | H | CF₃ | O | 0 |
| A842 | CH₂ | 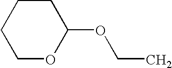 | H | CF₃ | O | 0 |
| A843 | CH₂ | n-heptyl-C(O) | H | CF₃ | O | 0 |
| A844 | CH₂ | phenyl-C(O) | H | CF₃ | O | 0 |
| A845 | CH₂ | CF₃CH₂OCH₂CH₂ | H | CF₃ | O | 0 |
| A846 | CH₂ | CH₃OCH₂CH₂CH₂ | H | CF₃ | O | 0 |
| A847 | CH₂ | HOCH₂CH₂CH₂ | H | CF₃ | O | 0 |
| A848 | CH₂ | 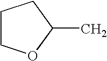 | H | CF₃ | O | 0 |
| A849 | CH₂ | N≡CCH₂CH₂ | H | CF₃ | O | 0 |
| A850 | CH₂ | ClCH₂CH₂ | H | CF₃ | O | 0 |
| A851 | CH₂ | 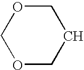 | H | CF₃ | O | 0 |
| A852 | CH₂ | 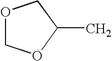 | H | CF₃ | O | 0 |
| A853 | CH₂ | CH₃OCH₂C(Br)HCH₂ | H | CF₃ | O | 0 |
| A854 | CH₂ | 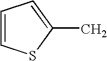 | H | CF₃ | O | 0 |
| A855 | CH₂ | 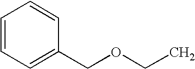 | H | CF₃ | O | 0 |
| A856 | CH₂ | HOCH₂CH₂ | H | CF₃ | O | 0 |
| A857 | CH₂ | 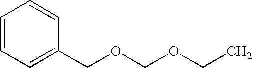 | H | CF₃ | O | 0 |
| A858 | CH₂ | CH₃(OCH₂CH₂)₃ | H | CF₃ | O | 0 |
| A859 | CH₂ | CH₃CH₂OC(CH₃)HOCH₂CH₂ | H | CF₃ | O | 0 |
| A860 | CH₂ | n-heptyl-C(O)OCH₂CH₂ | H | CF₃ | O | 0 |
| A861 | CH₂ | CH₃C(O)OCH₂CH₂ | H | CF₃ | O | 0 |
| A862 | CH₂ | CH₃SO₂OCH₂CH₂ | H | CF₃ | O | 0 |
| A863 | CH₂ | 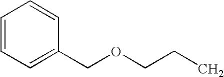 | H | CF₃ | O | 0 |
| A864 | CH₂ | CH₃ | H | CF₃ | —NCH₃SO₂— | 0 |
| A865 | CH₂ | HOCH₂C(OH)HCH₂ | H | CF₃ | O | 0 |
| A866 | CH₂ | phenyl-C(O)OCH₂CH₂ | H | CF₃ | O | 0 |
| A867 | CH₂ | tert-butyl-C(O)OCH₂CH₂ | H | CF₃ | O | 0 |
| A868 | CH₂ | CH₃OC(O)CH₂ | H | CF₃ | O | 0 |

In the Table that follows, when the substituents A₁ and A₂ are rings the ring attachment positions are at the carbon atom identified by “C”, for example 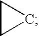
in the case of open-chain structures, “(CH₃)₂C”, for example, is

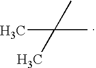

Q in the formula A-Q denotes Q₁

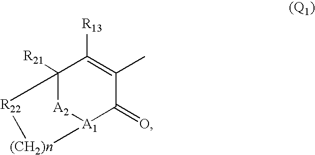

and Q₁ denotes the following radicals B:

| Radical | A₁ | A₂ | n | R₂₁ | R₂₂ | R₁₃ |
|---|---|---|---|---|---|---|
| B1 | CH₂ | CH₂ | 0 | H | H | OH |
| B2 | CH₂ | CH₂ | 0 | CH₃ | H | OH |
| B3 | CH₂ | CH₂ | 0 | CH₃ | CH₃ | OH |
| B4 | (CH₃)CH | CH₂ | 0 | CH₃ | CH₃ | OH |
| B5 | (CH₂)₂C | CH₂ | 0 | CH₃ | CH₃ | OH |
| B6 | CH | CH | 0 | CH₃ | — | OH |
| B7 | CH₂ | CH₂ | 0 | CH₃ | CH₂═CHCH₂ | OH |
| B8 | CH₂ | CH₂ | 0 | CH₃ | HC≡CCH₂ | OH |
| B9 | CH₂ | CH₂ | 0 | CH₃ | CH₃S | OH |
| B10 | CH₂ | CH₂ | 0 | CH₃ | CH₃SO | OH |
| B11 | CH₂ | CH₂ | 0 | CH₃ | CH₃SO₂ | OH |
| B12 | CH₂ | CH₂ | 0 | CH₃ | CH₃O | OH |
| B13 | CH₂ | CH₂ | 0 | CH₃ | CH₃OC(O) | OH |
| B14 | CH₂ | CH₂ | 0 | CH₃ | CH₃CH₂OC(O) | OH |
| B15 | CH₂ | (CH₃)₂C | 0 | H | H | OH |
| B16 | 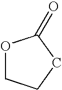 | CH₂ | 0 | H | H | OH |
| B17 | 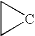 | CH₂ | 0 | H | H | OH |
| B18 | 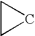 | CH₂ | 0 | CH₃ | H | OH |
| B19 | 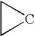 | CH₂ | 0 | CH₃ | CH₃ | OH |
| B20 | 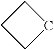 | CH₂ | 0 | H | H | OH |
| B21 | 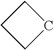 | CH₂ | 0 | CH₃ | H | OH |
| B22 | 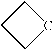 | CH₂ | 0 | CH₃ | CH₃ | OH |
| B23 | (CH₃)₂C | O | 0 | CH₃ | CH₃ | OH |
| B24 | CH₂ | O | 0 | CH₃ | CH₃ | OH |
| B25 | CH₃N | O | 0 | CH₃ | CH₃ | OH |
| B26 | 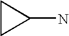 | O | 0 | CH₃ | CH₃ | OH |
| B27 | CH₃N | CH₂ | 0 | CH₃ | CH₃ | OH |
| B28 | CH₃N | (CH₃CH | 0 | H | H | OH |
| B29 | CH₃N | (CH₃CH | 0 | CH₃ | H | OH |
| B30 | NH | (CH₃C | 0 | H | — | OH |
| B31 | NH | CH | 0 | CH₃ | — | OH |
| B32 | CH₃N | (CH₃C | 0 | H | — | OH |
| B33 | CH₃N | CH | 0 | CH₃ | — | OH |
| B34 | O | (CH₃)₂C | 0 | H | — | OH |
| B35 | O | (CH₃)₂C | 0 | CH₃ | CH₃ | OH |
| B36 | O | (CH₃)₂C | 0 | CH₃ | H | OH |
| B37 | O | (CH₃)₂C | 0 | H | — | OH |
| B38 | O | CH | 0 | CH₃ | — | OH |
| B39 | (CH₃)₂C | C═O | 0 | CH₃ | CH₃ | OH |
| B40 | (CH₃)₂C | (OH)CH | 0 | CH₃ | CH₃ | OH |
| B41 | 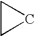 | C═O | 0 | CH₃ | CH₃ | OH |
| B42 | 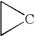 | C═O | 0 | CH₂ | CH₂ | OH |
| B43 | (CH₃)₂C | 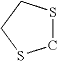 | 0 | CH₃ | CH₃ | OH |
| B44 | (CH₃)₂C | 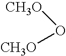 | 0 | CH₃ | CH₃ | OH |
| B45 | (CH₃)₂C | 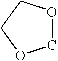 | 0 | CH₃ | CH₃ | OH |
| B46 | (CH₃)₂C | 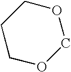 | 0 | CH₃ | CH₃ | OH |
| B47 | (CH₃)₂C | HON═C | 0 | CH₃ | CH₃ | OH |
| B48 | (CH₃)₂C | CH₃ON═C | 0 | CH₃ | CH₃ | OH |
| B49 | (CH₃)₂C | BnON═C | 0 | CH₃ | CH₃ | OH |
| B50 | CH | O | 1 | H | CH₂ | OH |
| B51 | CH | C═O | 1 | H | CH₂ | OH |
| B52 | CH | CH₂ | 1 | H | CH₂ | OH |
| B53 | CH | CH₃N | 1 | H | CH₂ | OH |
| B54 | CH | CH₂CH₂ | 1 | H | CH₂ | OH |
| B55 | CH | C═O | 2 | H | CH₂ | OH |
| B56 | CH | CH₂ | 2 | H | CH₂ | OH |
| B57 | CH | CH₂ | 1 | H | CH₂ | Cl |
| B58 | CH | CH₂ | 1 | H | CH₂ | NH₂ |
| B59 | CH | CH₂ | 1 | H | CH₂ | CH₃SO₂NH |
| B60 | CH | CH₂ | 1 | H | CH₂ | CH₃OCH₂CH₂S |
| B61 | CH | CH₂ | 1 | H | CH₂ | CH₃OCH₂CH₂SO |
| B62 | CH | CH₂ | 1 | H | CH₂ | CH₃OCH₂CH₂SO₂ |
| B63 | CH | CH₂ | 1 | H | CH₂ | (CH₃)₂NC(O)NH |
| B64 | CH | CH₂ | 1 | H | CH₂ | PhC(O)O |
| B65 | CH | CH₂ | 1 | H | CH₂ | CH₃OC(O)O |
| B66 | CH | CH₂ | 1 | H | CH₂ | CH₃(CH₂)₇S |
| B67 | CH | CH₂ | 1 | H | CH₂ | CH₃(CH₂)₇SO |
| B68 | CH | CH₂ | 1 | H | CH₂ | CH₃(CH₂)₇SO₂ |
| B69 | CH | CH₂ | 1 | H | CH₂ | (CH₃)₂NSO₂NH |
| B70 | CH | CH₂ | 1 | H | CH₂ | PhS |
| B71 | CH | CH₂ | 1 | H | CH₂ | PhSO |
| B72 | CH | CH₂ | 1 | H | CH₂ | PhSO₂ |
| B73 | CH | CH₂ | 1 | H | CH₂ | 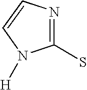 |
| B74 | CH | CH₂ | 1 | H | CH₂ | 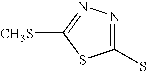 |
| B75 | (CH₃)₂C | C═O | 0 | CH₃ | CH₃ | Cl |
| B76 | (CH₃)₂C | C═O | 0 | CH₃ | CH₃ | NH₂ |
| B77 | (CH₃)₂C | C═O | 0 | CH₃ | CH₃ | CH₃SO₂NH |
| B78 | (CH₃)₂C | C═O | 0 | CH₃ | CH₃ | CH₃OCH₂CH₂S |
| B79 | (CH₃)₂C | C═O | 0 | CH₃ | CH₃ | CH₃OCH₂CH₂SO |
| B80 | (CH₃)₂C | C═O | 0 | CH₃ | CH₃ | CH₃OCH₂CH₂SO₂ |
| B81 | (CH₃)₂C | C═O | 0 | CH₃ | CH₃ | (CH₃)₂NC(O)NH |
| B82 | (CH₃)₂C | C═O | 0 | CH₃ | CH₃ | PhC(O)O |
| B83 | (CH₃)₂C | C═O | 0 | CH₃ | CH₃ | CH₃OC(O)O |
| B84 | (CH₃)₂C | C═O | 0 | CH₃ | CH₃ | CH₃(CH₂)₇S |
| B85 | (CH₃)₂C | C═O | 0 | CH₃ | CH₃ | CH₃(CH₂)₇SO |
| B86 | (CH₃)₂C | C═O | 0 | CH₃ | CH₃ | CH₃(CH₂)₇SO₂ |
| B87 | (CH₃)₂C | C═O | 0 | CH₃ | CH₃ | (CH₃)₂NSO₂NH |
| B88 | (CH₃)₂C | C═O | 0 | CH₃ | CH₃ | PhS |
| B89 | (CH₃)₂C | C═O | 0 | CH₃ | CH₃ | PhSO |
| B90 | (CH₃)₂C | C═O | 0 | CH₃ | CH₃ | PhSO₂ |
| B91 | (CH₃)₂C | C═O | 0 | CH₃ | CH₃ | 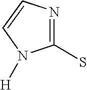 |
| B92 | (CH₃)₂C | C═O | 0 | CH₃ | CH₃ | 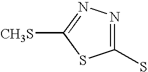 |
| B93 | (CH₃)₂C | CH₂ | 0 | H | H | Cl |
| B94 | (CH₃)₂C | CH₂ | 0 | H | H | NH₂ |
| B96 | (CH₃)₂C | CH₂ | 0 | H | H | CH₃OCH₂CH₂S |
| B97 | (CH₃)₂C | CH₂ | 0 | H | H | CH₃OCH₂CH₂SO |
| B98 | (CH₃)₂C | CH₂ | 0 | H | H | CH₃OCH₂CH₂SO₂ |
| B99 | (CH₃)₂C | CH₂ | 0 | H | H | (CH₃)₂NC(O)NH |
| B100 | (CH₃)₂C | CH₂ | 0 | H | H | PhC(O)O |
| B101 | (CH₃)₂C | CH₂ | 0 | H | H | CH₃OC(O)O |
| B102 | (CH₃)₂C | CH₂ | 0 | H | H | CH₃(CH₂)₇S |
| B103 | (CH₃)₂C | CH₂ | 0 | H | H | CH₃(CH₂)₇SO |
| B104 | (CH₃)₂C | CH₂ | 0 | H | H | CH₃(CH₂)₇SO₂ |
| B105 | (CH₃)₂C | CH₂ | 0 | H | H | (CH₃)₂NSO₂NH |
| B106 | (CH₃)₂C | CH₂ | 0 | H | H | PhS |
| B107 | (CH₃)₂C | CH₂ | 0 | H | H | PhSO |
| B108 | (CH₃)₂C | CH₂ | 0 | H | H | PhSO₂ |
| B109 | (CH₃)₂C | CH₂ | 0 | H | H | 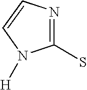 |
| B110 | (CH₃)₂C | CH₂ | 0 | H | H | 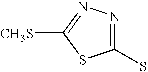 |
| B111 | CH₂ | (CH₃)CH | 0 | H | H | OH |
| B112 | CH₂ | CH₂ | 1 | H | CH₂ | tert-butyl-C(O)O |
| B113 | CH₂ | CH₂ | 1 | H | CH₂ | tert-heptyl-C(O)O |

or Q in the formula A-Q denotes Q₂

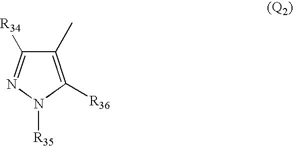

and Q₂ denotes the following radicals C:

| Radical | R₃₄ | R₃₅ | R₃₆ |
|---|---|---|---|
| C1 | CH₃ | H | OH |
| C2 | CH₃ | CH₃ | OH |
| C3 | H | HC≡CCH₂ | OH |
| C4 | H | CH₃SO₂ | OH |
| C5 | H | CH₃ | OH |
| C6 | H | PhCH₂ | OH |
| C7 | CF₃ | CH₃ | OH |
| C8 | 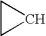 | CH₃ | OH |
| C9 | CH₃OCH₂CH₂OCH₂ | CH₃ | OH |
| C10 | H | CH₃ | Cl |
| C11 | H | CH₃ | NH₂ |
| C12 | H | CH₃ | CH₃SO₂NH |
| C13 | H | CH₃ | CH₃OCH₂CH₂S |
| C14 | H | CH₃ | CH₃OCH₂CH₂SO |
| C15 | H | CH₃ | CH₃OCH₂CH₂SO₂ |
| C16 | H | CH₃ | (CH₃)₂NC(O)NH |
| C17 | H | CH₃ | PhC(O)O |
| C18 | H | CH₃ | CH₃OC(O)O |
| C19 | H | CH₃ | CH₃(CH₂)₇S |
| C20 | H | CH₃ | CH₃(CH₂)₇SO |
| C21 | H | CH₃ | CH₃(CH₂)₇SO₂ |
| C22 | H | CH₃ | (CH₃)₂NSO₂NH |
| C23 | H | CH₃ | PhS |
| C24 | H | CH₃ | PhSO |
| C25 | H | CH₃ | PhSO₂ |
| C26 | H | CH₃ | 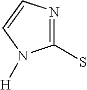 |
| C27 | H | CH₃ | 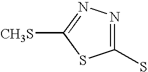 |
| C28 | H | CH₃ | CH₃SO₂O |
| C29 | H | CH₃ | p-tolylSO₂O |

or Q in the formula A-Q denotes Q₃

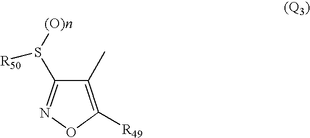

and Q₃ denotes the following radicals D (attachment position of R₄₉ to the heterocycle is the group “CH”):

| Radical | R₄₉ | R₅₀ | n |
|---|---|---|---|
| D1 | 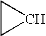 | CH₃ | 0 |
| D2 | 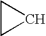 | CH₃ | 1 |
| D3 | 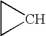 | CH₃ | 2 |
| D4 | 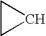 | CF₃ | 0 |
| D5 | 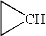 | CF₃ | 1 |
| D6 | 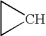 | CF₃ | 2 |
| D7 | 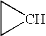 | Ph | 0 |
| D8 | 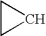 | Ph | 1 |
| D9 | 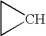 | Ph | 2 |
| D10 | 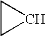 | PhCH₂ | 0 |
| D11 | 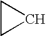 | PhCH₂ | 1 |
| D12 | 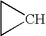 | PhCH₂ | 2 |

TABLE 2
Compounds of formula I, represented as compounds of formula
A-Q
wherein Q is Q₁, and Q₁ is the radical B52:

| B52 | B52 | B52 | B52 | B52 | B52 | B52 | B52 | B52 | B52 | B52 | B52 |
|---|---|---|---|---|---|---|---|---|---|---|---|
| A1 | A2 | A3 | A4 | A5 | A6 | A7 | | | | | |
| | | | | | A18 | A19 | A20 | A21 | A22 | A23 | A24 |
| A25 | A26 | A27 | A28 | A29 | A30 | A31 | A32 | A33 | A34 | A35 | A36 |
| A37 | A38 | A39 | A40 | A41 | A42 | A43 | A44 | A45 | A46 | A47 | A48 |
| A49 | A50 | A51 | A52 | A53 | A54 | A55 | A56 | A57 | A58 | A59 | A60 |
| A61 | A62 | A63 | A64 | A65 | A66 | A67 | A68 | A69 | A70 | A71 | A72 |
| A73 | A74 | A75 | A76 | A77 | A78 | A79 | A80 | A81 | A82 | A83 | A84 |
| A85 | A86 | A87 | A88 | A89 | A90 | A91 | A92 | A93 | A94 | A95 | A96 |
| A97 | A98 | | | | | | | | | | |
| A109 | A110 | A111 | A112 | A113 | A114 | A115 | A116 | A117 | A118 | A119 | A120 |
| A121 | A122 | A123 | A124 | A125 | A126 | A127 | A128 | A129 | A130 | A131 | A132 |
| A133 | A134 | A135 | A136 | A137 | A138 | A139 | A140 | A141 | A142 | A143 | A144 |
| A145 | A146 | A147 | A148 | A149 | A150 | A151 | A152 | A153 | A154 | A155 | A156 |
| A157 | A158 | A159 | A160 | A161 | A162 | A163 | A164 | A165 | A166 | A167 | A168 |
| A169 | A170 | A171 | A172 | A173 | A174 | A175 | A176 | A177 | A178 | A179 | A180 |
| A181 | A182 | A183 | A184 | A185 | A186 | A187 | A188 | A189 | | | |
| | | | | | | | A200 | A201 | A202 | A203 | A204 |
| A205 | A206 | A207 | A208 | A209 | A210 | A211 | A212 | A213 | A214 | A215 | A216 |
| A217 | A218 | A219 | A220 | A221 | A222 | A223 | A224 | A225 | A226 | A227 | A228 |
| A229 | A230 | A231 | A232 | A233 | A234 | A235 | A236 | A237 | A238 | A239 | A240 |
| A241 | A242 | A243 | A244 | A245 | A246 | A247 | A248 | A249 | A250 | A251 | A252 |
| A253 | A254 | A255 | A256 | A257 | A258 | A259 | A260 | A261 | A262 | A263 | A264 |
| A265 | A266 | A267 | A268 | A269 | A270 | A271 | A272 | A273 | A274 | A275 | A276 |
| A277 | A278 | A279 | A280 | | | | | | | | |
| | | A291 | A292 | A293 | A294 | A295 | A296 | A297 | A298 | A299 | A300 |
| A301 | A302 | A303 | A304 | A305 | A306 | A307 | A308 | A309 | A310 | A311 | A312 |
| A313 | A314 | A315 | A316 | A317 | A318 | A319 | A320 | A321 | A322 | A323 | A324 |
| A325 | A326 | A327 | A328 | A329 | A330 | A331 | A332 | A333 | A334 | A335 | A336 |
| A337 | A338 | A339 | A340 | A341 | A342 | A343 | A344 | A345 | A346 | A347 | A348 |
| A349 | A350 | A351 | A352 | A353 | A354 | A355 | A356 | A357 | A358 | A359 | A360 |
| A361 | A362 | A363 | A364 | A365 | A366 | A367 | A368 | A369 | A370 | A371 | |
| | | | | | | | | | A382 | A383 | A384 |
| A385 | A386 | A387 | A388 | A389 | A390 | A391 | A392 | A393 | A394 | A395 | A396 |
| A397 | A398 | A399 | A400 | A401 | A402 | A403 | A404 | A405 | A406 | A407 | A408 |
| A409 | A410 | A411 | A412 | A413 | A414 | A415 | A416 | A417 | A418 | A419 | A420 |
| A421 | A422 | A423 | A424 | A425 | A426 | A427 | A428 | A429 | A430 | A431 | A432 |
| A433 | A434 | A435 | A436 | A437 | A438 | A439 | A440 | A441 | A442 | A443 | A444 |
| A445 | A446 | A447 | A448 | A449 | A450 | A451 | A452 | A453 | A454 | A455 | A456 |
| A457 | A458 | A459 | A460 | A461 | A462 | | | | | | |
| | | | | A473 | A474 | A475 | A476 | A477 | A478 | A479 | A480 |
| A481 | A482 | A483 | A484 | A485 | A486 | A487 | A488 | A489 | A490 | A491 | A492 |
| A493 | A494 | A495 | A496 | A497 | A498 | A499 | A500 | A501 | A502 | A503 | A504 |
| A505 | A506 | A507 | A508 | A509 | A510 | A511 | A512 | A513 | A514 | A515 | A516 |
| A517 | A518 | A519 | A520 | A521 | A522 | A523 | A524 | A525 | A526 | A527 | A528 |
| A529 | A530 | A531 | A532 | A533 | A534 | A535 | A536 | A537 | A538 | A539 | A540 |
| A541 | A542 | A543 | A544 | A545 | A546 | A547 | A548 | A549 | A550 | A551 | A552 |
| A553 | | | | | | | | | | | A564 |
| A565 | A566 | A567 | A568 | A569 | A570 | A571 | A572 | A573 | A574 | A575 | A576 |
| A577 | A578 | A579 | A580 | A581 | A582 | A583 | A584 | A585 | A586 | A587 | A588 |
| A589 | A590 | A591 | A592 | A593 | A594 | A595 | A596 | A597 | A598 | A599 | A600 |
| A601 | A602 | A603 | A604 | A605 | A606 | A607 | A608 | A609 | A610 | A611 | A612 |
| A613 | A614 | A615 | A616 | A617 | A618 | A619 | A620 | A621 | A622 | A623 | A624 |
| A625 | A626 | A627 | A628 | A629 | A630 | A631 | A632 | A633 | A634 | A635 | A636 |
| A637 | A638 | A639 | A640 | A641 | A642 | A643 | | | | | |
| | | | | | A654 | A655 | A656 | A657 | A658 | A659 | A660 |
| A661 | A662 | A663 | A664 | A665 | A666 | A667 | A668 | A669 | A670 | A671 | A672 |
| A673 | A674 | A675 | A676 | A677 | A678 | A679 | A680 | A681 | A682 | A683 | A684 |
| A685 | A686 | A687 | A688 | A689 | A690 | A691 | A692 | A693 | A694 | A695 | A696 |
| A697 | A698 | A699 | A700 | A701 | A702 | A703 | A704 | A705 | A706 | A707 | A708 |
| A709 | A710 | A711 | A712 | A713 | A714 | A715 | A716 | A717 | A718 | A719 | A720 |
| A721 | A722 | A723 | A724 | A725 | A726 | A727 | A728 | A729 | A730 | A731 | A732 |
| A733 | | | | | | | | | | | A744 |
| A745 | A746 | A747 | A748 | A749 | A750 | A751 | A752 | A753 | A754 | A755 | A756 |
| A757 | A758 | A759 | A760 | A761 | A762 | A763 | A764 | A765 | A766 | A767 | A768 |
| A769 | A770 | A771 | A772 | A773 | A774 | A775 | A776 | A777 | A778 | A779 | A780 |
| A781 | A782 | A783 | A784 | A785 | A786 | A787 | A788 | A789 | A790 | A791 | A792 |
| A793 | A794 | A795 | A796 | A797 | A798 | A799 | A800 | A801 | A802 | A803 | A804 |
| A805 | A806 | A807 | A808 | A809 | A810 | A811 | A812 | A813 | A814 | A815 | A816 |
| A817 | A818 | A819 | A820 | A821 | A822 | A823 | A824 | A825 | A826 | A827 | A828 |
| A829 | A830 | A831 | A832 | — | — | — | — | — | — | — | — |

TABLE 3
Compounds of formula I, represented as compounds of formula
A-Q
wherein Q is Q₁, and Q₁ is the radical B39:

| B39 | B39 | B39 | B39 | B39 | B39 | B39 | B39 | B39 | B39 | B39 | B39 |
|---|---|---|---|---|---|---|---|---|---|---|---|
| A1 | A2 | A3 | A4 | A5 | A6 | A7 | | | | | |
| | | | | | A18 | A19 | A20 | A21 | A22 | A23 | A24 |
| A25 | A26 | A27 | A28 | A29 | A30 | A31 | A32 | A33 | A34 | A35 | A36 |
| A37 | A38 | A39 | A40 | A41 | A42 | A43 | A44 | A45 | A46 | A47 | A48 |
| A49 | A50 | A51 | A52 | A53 | A54 | A55 | A56 | A57 | A58 | A59 | A60 |
| A61 | A62 | A63 | A64 | A65 | A66 | A67 | A68 | A69 | A70 | A71 | A72 |
| A73 | A74 | A75 | A76 | A77 | A78 | A79 | A80 | A81 | A82 | A83 | A84 |
| A85 | A86 | A87 | A88 | A89 | A90 | A91 | A92 | A93 | A94 | A95 | A96 |
| A97 | A98 | | | | | | | | | | |
| A109 | A110 | A111 | A112 | A113 | A114 | A115 | A116 | A117 | A118 | A119 | A120 |
| A121 | A122 | A123 | A124 | A125 | A126 | A127 | A128 | A129 | A130 | A131 | A132 |
| A133 | A134 | A135 | A136 | A137 | A138 | A139 | A140 | A141 | A142 | A143 | A144 |
| A145 | A146 | A147 | A148 | A149 | A150 | A151 | A152 | A153 | A154 | A155 | A156 |
| A157 | A158 | A159 | A160 | A161 | A162 | A163 | A164 | A165 | A166 | A167 | A168 |
| A169 | A170 | A171 | A172 | A173 | A174 | A175 | A176 | A177 | A178 | A179 | A180 |
| A181 | A182 | A183 | A184 | A185 | A186 | A187 | A188 | A189 | | | |
| | | | | | | | A200 | A201 | A202 | A203 | A204 |
| A205 | A206 | A207 | A208 | A209 | A210 | A211 | A212 | A213 | A214 | A215 | A216 |
| A217 | A218 | A219 | A220 | A221 | A222 | A223 | A224 | A225 | A226 | A227 | A228 |
| A229 | A230 | A231 | A232 | A233 | A234 | A235 | A236 | A237 | A238 | A239 | A240 |
| A241 | A242 | A243 | A244 | A245 | A246 | A247 | A248 | A249 | A250 | A251 | A252 |
| A253 | A254 | A255 | A256 | A257 | A258 | A259 | A260 | A261 | A262 | A263 | A264 |
| A265 | A266 | A267 | A268 | A269 | A270 | A271 | A272 | A273 | A274 | A275 | A276 |
| A277 | A278 | A279 | A280 | | | | | | | | |
| | | A291 | A292 | A293 | A294 | A295 | A296 | A297 | A298 | A299 | A300 |
| A301 | A302 | A303 | A304 | A305 | A306 | A307 | A308 | A309 | A310 | A311 | A312 |
| A313 | A314 | A315 | A316 | A317 | A318 | A319 | A320 | A321 | A322 | A323 | A324 |
| A325 | A326 | A327 | A328 | A329 | A330 | A331 | A332 | A333 | A334 | A335 | A336 |
| A337 | A338 | A339 | A340 | A341 | A342 | A343 | A344 | A345 | A346 | A347 | A348 |
| A349 | A350 | A351 | A352 | A353 | A354 | A355 | A356 | A357 | A358 | A359 | A360 |
| A361 | A362 | A363 | A364 | A365 | A366 | A367 | A368 | A369 | A370 | A371 | |
| | | | | | | | | | A382 | A383 | A384 |
| A385 | A386 | A387 | A388 | A389 | A390 | A391 | A392 | A393 | A394 | A395 | A396 |
| A397 | A398 | A399 | A400 | A401 | A402 | A403 | A404 | A405 | A406 | A407 | A408 |
| A409 | A410 | A411 | A412 | A413 | A414 | A415 | A416 | A417 | A418 | A419 | A420 |
| A421 | A422 | A423 | A424 | A425 | A426 | A427 | A428 | A429 | A430 | A431 | A432 |
| A433 | A434 | A435 | A436 | A437 | A438 | A439 | A440 | A441 | A442 | A443 | A444 |
| A445 | A446 | A447 | A448 | A449 | A450 | A451 | A452 | A453 | A454 | A455 | A456 |
| A457 | A458 | A459 | A460 | A461 | A462 | | | | | | |
| | | | | A473 | A474 | A475 | A476 | A477 | A478 | A479 | A480 |
| A481 | A482 | A483 | A484 | A485 | A486 | A487 | A488 | A489 | A490 | A491 | A492 |
| A493 | A494 | A495 | A496 | A497 | A498 | A499 | A500 | A501 | A502 | A503 | A504 |
| A505 | A506 | A507 | A508 | A509 | A510 | A511 | A512 | A513 | A514 | A515 | A516 |
| A517 | A518 | A519 | A520 | A521 | A522 | A523 | A524 | A525 | A526 | A527 | A528 |
| A529 | A530 | A531 | A532 | A533 | A534 | A535 | A536 | A537 | A538 | A539 | A540 |
| A541 | A542 | A543 | A544 | A545 | A546 | A547 | A548 | A549 | A550 | A551 | A552 |
| A553 | | | | | | | | | | | A564 |
| A565 | A566 | A567 | A568 | A569 | A570 | A571 | A572 | A573 | A574 | A575 | A576 |
| A577 | A578 | A579 | A580 | A581 | A582 | A583 | A584 | A585 | A586 | A587 | A588 |
| A589 | A590 | A591 | A592 | A593 | A594 | A595 | A596 | A597 | A598 | A599 | A600 |
| A601 | A602 | A603 | A604 | A605 | A606 | A607 | A608 | A609 | A610 | A611 | A612 |
| A613 | A614 | A615 | A616 | A617 | A618 | A619 | A620 | A621 | A622 | A623 | A624 |
| A625 | A626 | A627 | A628 | A629 | A630 | A631 | A632 | A633 | A634 | A635 | A636 |
| A637 | A638 | A639 | A640 | A641 | A642 | A643 | | | | | |
| | | | | | A654 | A655 | A656 | A657 | A658 | A659 | A660 |
| A661 | A662 | A663 | A664 | A665 | A666 | A667 | A668 | A669 | A670 | A671 | A672 |
| A673 | A674 | A675 | A676 | A677 | A678 | A679 | A680 | A681 | A682 | A683 | A684 |
| A685 | A686 | A687 | A688 | A689 | A690 | A691 | A692 | A693 | A694 | A695 | A696 |
| A697 | A698 | A699 | A700 | A701 | A702 | A703 | A704 | A705 | A706 | A707 | A708 |
| A709 | A710 | A711 | A712 | A713 | A714 | A715 | A716 | A717 | A718 | A719 | A720 |
| A721 | A722 | A723 | A724 | A725 | A726 | A727 | A728 | A729 | A730 | A731 | A732 |
| A733 | | | | | | | | | | | A744 |
| A745 | A746 | A747 | A748 | A749 | A750 | A751 | A752 | A753 | A754 | A755 | A756 |
| A757 | A758 | A759 | A760 | A761 | A762 | A763 | A764 | A765 | A766 | A767 | A768 |
| A769 | A770 | A771 | A772 | A773 | A774 | A775 | A776 | A777 | A778 | A779 | A780 |
| A781 | A782 | A783 | A784 | A785 | A786 | A787 | A788 | A789 | A790 | A791 | A792 |
| A793 | A794 | A795 | A796 | A797 | A798 | A799 | A800 | A801 | A802 | A803 | A804 |
| A805 | A806 | A807 | A808 | A809 | A810 | A811 | A812 | A813 | A814 | A815 | A816 |
| A817 | | | | | | | | | | | A828 |
| A829 | A830 | A831 | A832 | — | — | — | — | — | — | — | — |

TABLE 4
Compounds of formula I, represented as compounds of formula
A-Q
wherein Q is Q₁, and Q₁ is the radical B3:

| B3 | B3 | B3 | B3 | B3 | B3 | B3 | B3 | B3 | B3 | B3 | B3 |
|---|---|---|---|---|---|---|---|---|---|---|---|
| — | — | — | — | — | — | — | | | | | |
| | | | | | A18 | A19 | A20 | A21 | A22 | A23 | A24 |
| A25 | A26 | A27 | A28 | A29 | A30 | A31 | A32 | A33 | A34 | A35 | A36 |
| A37 | A38 | A39 | A40 | A41 | A42 | A43 | A44 | A45 | A46 | A47 | A48 |
| A49 | A50 | A51 | A52 | A53 | A54 | A55 | A56 | A57 | A58 | A59 | A60 |
| A61 | A62 | A63 | A64 | A65 | A66 | A67 | A68 | A69 | A70 | A71 | A72 |
| A73 | A74 | A75 | A76 | A77 | A78 | A79 | A80 | A81 | A82 | A83 | A84 |
| A85 | A86 | A87 | A88 | A89 | A90 | — | — | — | — | — | — |
| — | — | | | | | | | | | | |
| A109 | A110 | A111 | A112 | A113 | A114 | A115 | A116 | A117 | A118 | A119 | A120 |
| A121 | A122 | A123 | A124 | A125 | A126 | A127 | A128 | A129 | A130 | A131 | A132 |
| A133 | A134 | A135 | A136 | A137 | A138 | A139 | A140 | A141 | A142 | A143 | A144 |
| A145 | A146 | A147 | A148 | A149 | A150 | A151 | A152 | A153 | A154 | A155 | A156 |
| A157 | A158 | A159 | A160 | A161 | A162 | A163 | A164 | A165 | A166 | A167 | A168 |
| A169 | A170 | A171 | A172 | A173 | A174 | A175 | A176 | A177 | A178 | A179 | A180 |
| A181 | A182 | A183 | A184 | A185 | A186 | A187 | A188 | A189 | | | |
| | | | | | | | A200 | A201 | A202 | A203 | A204 |
| A205 | A206 | A207 | A208 | A209 | A210 | A211 | A212 | A213 | A214 | A215 | A216 |
| A217 | A218 | A219 | A220 | A221 | A222 | A223 | A224 | A225 | A226 | A227 | A228 |
| A229 | A230 | A231 | A232 | A233 | A234 | A235 | A236 | A237 | A238 | A239 | A240 |
| A241 | A242 | A243 | A244 | A245 | A246 | A247 | A248 | A249 | A250 | A251 | A252 |
| A253 | A254 | A255 | A256 | A257 | A258 | A259 | A260 | A261 | A262 | A263 | A264 |
| A265 | A266 | A267 | A268 | A269 | A270 | A271 | A272 | A273 | A274 | A275 | A276 |
| A277 | A278 | A279 | A280 | | | | | | | | |
| | | A291 | A292 | A293 | A294 | A295 | A296 | A297 | A298 | A299 | A300 |
| A301 | A302 | A303 | A304 | A305 | A306 | A307 | A308 | A309 | A310 | A311 | A312 |
| A313 | A314 | A315 | A316 | A317 | A318 | A319 | A320 | A321 | A322 | A323 | A324 |
| A325 | A326 | A327 | A328 | A329 | A330 | A331 | A332 | A333 | A334 | A335 | A336 |
| A337 | A338 | A339 | A340 | A341 | A342 | A343 | A344 | A345 | A346 | A347 | A348 |
| A349 | A350 | A351 | A352 | A353 | A354 | A355 | A356 | A357 | A358 | A359 | A360 |
| A361 | A362 | A363 | A364 | A365 | A366 | A367 | A368 | A369 | A370 | A371 | |
| | | | | | | | | | A382 | A383 | A384 |
| A385 | A386 | A387 | A388 | A389 | A390 | A391 | A392 | A393 | A394 | A395 | A396 |
| A397 | A398 | A399 | A400 | A401 | A402 | A403 | A404 | A405 | A406 | A407 | A408 |
| A409 | A410 | A411 | A412 | A413 | A414 | A415 | A416 | A417 | A418 | A419 | A420 |
| A421 | A422 | A423 | A424 | A425 | A426 | A427 | A428 | A429 | A430 | A431 | A432 |
| A433 | A434 | A435 | A436 | A437 | A438 | A439 | A440 | A441 | A442 | A443 | A444 |
| A445 | A446 | A447 | A448 | A449 | A450 | A451 | A452 | A453 | A454 | A455 | A456 |
| A457 | A458 | A459 | A460 | A461 | A462 | | | | | | |
| | | | | A473 | A474 | A475 | A476 | A477 | A478 | A479 | A480 |
| A481 | A482 | A483 | A484 | A485 | A486 | A487 | A488 | A489 | A490 | A491 | A492 |
| A493 | A494 | A495 | A496 | A497 | A498 | A499 | A500 | A501 | A502 | A503 | A504 |
| A505 | A506 | A507 | A508 | A509 | A510 | A511 | A512 | A513 | A514 | A515 | A516 |
| A517 | A518 | A519 | A520 | A521 | A522 | A523 | A524 | A525 | A526 | A527 | A528 |
| A529 | A530 | A531 | A532 | A533 | A534 | A535 | A536 | A537 | A538 | A539 | A540 |
| A541 | A542 | A543 | A544 | A545 | — | — | — | — | — | — | — |
| — | | | | | | | | | | | A564 |
| A565 | A566 | A567 | A568 | A569 | A570 | A571 | A572 | A573 | A574 | A575 | A576 |
| A577 | A578 | A579 | A580 | A581 | A582 | A583 | A584 | A585 | A586 | A587 | A588 |
| A589 | A590 | A591 | A592 | A593 | A594 | A595 | A596 | A597 | A598 | A599 | A600 |
| A601 | A602 | A603 | A604 | A605 | A606 | A607 | A608 | A609 | A610 | A611 | A612 |
| A613 | A614 | A615 | A616 | A617 | A618 | A619 | A620 | A621 | A622 | A623 | A624 |
| A625 | A626 | A627 | A628 | A629 | A630 | A631 | A632 | A633 | A634 | A635 | A636 |
| — | — | — | — | — | — | — | | | | | |
| | | | | | A654 | A655 | A656 | A657 | A658 | A659 | A660 |
| A661 | A662 | A663 | A664 | A665 | A666 | A667 | A668 | A669 | A670 | A671 | A672 |
| A685 | A686 | A687 | A688 | A689 | A690 | A691 | A692 | A693 | A694 | A695 | A696 |
| A697 | A698 | A699 | A700 | A701 | A702 | A703 | A704 | A705 | A706 | A707 | A708 |
| A709 | A710 | A711 | A712 | A713 | A714 | A715 | A716 | A717 | A718 | A719 | A720 |
| A721 | A722 | A723 | A724 | A725 | A726 | — | — | — | — | — | — |
| A733 | | | | | | | | | | | A744 |
| A745 | A746 | A747 | A748 | A749 | A750 | A751 | A752 | A753 | A754 | A755 | A756 |
| A757 | A758 | A759 | A760 | A761 | A762 | A763 | A764 | A765 | A766 | A767 | A768 |
| A769 | A770 | A771 | A772 | A773 | A774 | A775 | A776 | A777 | A778 | A779 | A780 |
| A781 | A782 | A783 | A784 | A785 | A786 | A787 | A788 | A789 | A790 | A791 | A792 |
| A793 | A794 | A795 | A796 | A797 | A798 | A799 | A800 | A801 | A802 | A803 | A804 |
| A805 | A806 | A807 | A808 | A809 | A810 | A811 | A812 | A813 | A814 | A815 | A816 |
| A817 | | | | | | | | | | | A828 |
| A829 | A830 | A831 | A832 | — | — | — | — | — | — | — | — |

TABLE 5
Compounds of formula I, represented as compounds of formula
A-Q
wherein Q is Q₂, and Q₂ is the radical C5:

| C5 | C5 | C5 | C5 | C5 | C5 | C5 | C5 | C5 | C5 | C5 | C5 |
|---|---|---|---|---|---|---|---|---|---|---|---|
| A1 | A2 | A3 | A4 | A5 | A6 | A7 | A8 | A9 | A10 | A11 | A12 |
| A13 | A14 | A15 | A16 | A17 | A18 | A19 | A20 | A21 | A22 | A23 | A24 |
| A25 | A26 | A27 | A28 | A29 | A30 | A31 | A32 | A33 | A34 | A35 | A36 |
| A37 | A38 | A39 | A40 | A41 | A42 | A43 | A44 | A45 | A46 | A47 | A48 |
| A49 | A50 | A51 | A52 | A53 | A54 | A55 | A56 | A57 | A58 | A59 | A60 |
| A61 | A62 | A63 | A64 | A65 | A66 | A67 | A68 | A69 | A70 | A71 | A72 |
| A73 | A74 | A75 | A76 | A77 | A78 | A79 | A80 | A81 | A82 | A83 | A84 |
| A85 | A86 | A87 | A88 | A89 | A90 | A91 | A92 | A93 | A94 | A95 | A96 |
| A97 | A98 | A99 | A100 | A101 | A102 | A103 | A104 | A105 | A106 | A107 | A108 |
| A109 | A110 | A111 | A112 | A113 | A114 | A115 | A116 | A117 | A118 | A119 | A120 |
| A121 | A122 | A123 | A124 | A125 | A126 | A127 | A128 | A129 | A130 | A131 | A132 |
| A133 | A134 | A135 | A136 | A137 | A138 | A139 | A140 | A141 | A142 | A143 | A144 |
| A145 | A146 | A147 | A148 | A149 | A150 | A151 | A152 | A153 | A154 | A155 | A156 |
| A157 | A158 | A159 | A160 | A161 | A162 | A163 | A164 | A165 | A166 | A167 | A168 |
| A169 | A170 | A171 | A172 | A173 | A174 | A175 | A176 | A177 | A178 | A179 | A180 |
| A181 | A182 | A183 | A184 | A185 | A186 | A187 | A188 | A189 | A190 | A191 | A192 |
| A193 | A194 | A195 | A196 | A197 | A198 | A199 | A200 | A201 | A202 | A203 | A204 |
| A205 | A206 | A207 | A208 | A209 | A210 | A211 | A212 | A213 | A214 | A215 | A216 |
| A217 | A218 | A219 | A220 | A221 | A222 | A223 | A224 | A225 | A226 | A227 | A228 |
| A229 | A230 | A231 | A232 | A233 | A234 | A235 | A236 | A237 | A238 | A239 | A240 |
| A241 | A242 | A243 | A244 | A245 | A246 | A247 | A248 | A249 | A250 | A251 | A252 |
| A253 | A254 | A255 | A256 | A257 | A258 | A259 | A260 | A261 | A262 | A263 | A264 |
| A265 | A266 | A267 | A268 | A269 | A270 | A271 | A272 | A273 | A274 | A275 | A276 |
| A277 | A278 | A279 | A280 | A281 | A282 | A283 | A284 | A285 | A286 | A287 | A288 |
| A289 | A290 | A291 | A292 | A293 | A294 | A295 | A296 | A297 | A298 | A299 | A300 |
| A301 | A302 | A303 | A304 | A305 | A306 | A307 | A308 | A309 | A310 | A311 | A312 |
| A313 | A314 | A315 | A316 | A317 | A318 | A319 | A320 | A321 | A322 | A323 | A324 |
| A325 | A326 | A327 | A328 | A329 | A330 | A331 | A332 | A333 | A334 | A335 | A336 |
| A337 | A338 | A339 | A340 | A341 | A342 | A343 | A344 | A345 | A346 | A347 | A348 |
| A349 | A350 | A351 | A352 | A353 | A354 | A355 | A356 | A357 | A358 | A359 | A360 |
| A361 | A362 | A363 | A364 | A365 | A366 | A367 | A368 | A369 | A370 | A371 | A372 |
| A373 | A374 | A375 | A376 | A377 | A378 | A379 | A380 | A381 | A382 | A383 | A384 |
| A385 | A386 | A387 | A388 | A389 | A390 | A391 | A392 | A393 | A394 | A395 | A396 |
| A397 | A398 | A399 | A400 | A401 | A402 | A403 | A404 | A405 | A406 | A407 | A408 |
| A409 | A410 | A411 | A412 | A413 | A414 | A415 | A416 | A417 | A418 | A419 | A420 |
| A421 | A422 | A423 | A424 | A425 | A426 | A427 | A428 | A429 | A430 | A431 | A432 |
| A433 | A434 | A435 | A436 | A437 | A438 | A439 | A440 | A441 | A442 | A443 | A444 |
| A445 | A446 | A447 | A448 | A449 | A450 | A451 | A452 | A453 | A454 | A455 | A456 |
| A457 | A458 | A459 | A460 | A461 | A462 | A463 | A464 | A465 | A466 | A467 | A468 |
| A469 | A470 | A471 | A472 | A473 | A474 | A475 | A476 | A477 | A478 | A479 | A480 |
| A481 | A482 | A483 | A484 | A485 | A486 | A487 | A488 | A489 | A490 | A491 | A492 |
| A493 | A494 | A495 | A496 | A497 | A498 | A499 | A500 | A501 | A502 | A503 | A504 |
| A505 | A506 | A507 | A508 | A509 | A510 | A511 | A512 | A513 | A514 | A515 | A516 |
| A517 | A518 | A519 | A520 | A521 | A522 | A523 | A524 | A525 | A526 | A527 | A528 |
| A529 | A530 | A531 | A532 | A533 | A534 | A535 | A536 | A537 | A538 | A539 | A540 |
| A541 | A542 | A543 | A544 | A545 | A546 | A547 | A548 | A549 | A550 | A551 | A552 |
| A553 | A554 | A555 | A556 | A557 | A558 | A559 | A560 | A561 | A562 | A563 | A564 |
| A565 | A566 | A567 | A568 | A569 | A570 | A571 | A572 | A573 | A574 | A575 | A576 |
| A577 | A578 | A579 | A580 | A581 | A582 | A583 | A584 | A585 | A586 | A587 | A588 |
| A589 | A590 | A591 | A592 | A593 | A594 | A595 | A596 | A597 | A598 | A599 | A600 |
| A601 | A602 | A603 | A604 | A605 | A606 | A607 | A608 | A609 | A610 | A611 | A612 |
| A613 | A614 | A615 | A616 | A617 | A618 | A619 | A620 | A621 | A622 | A623 | A624 |
| A625 | A626 | A627 | A628 | A629 | A630 | A631 | A632 | A633 | A634 | A635 | A636 |
| A637 | A638 | A639 | A640 | A641 | A642 | A643 | A644 | A645 | A646 | A647 | A648 |
| A649 | A650 | A651 | A652 | A653 | A654 | A655 | A656 | A657 | A658 | A659 | A660 |
| A661 | A662 | A663 | A664 | A665 | A666 | A667 | A668 | A669 | A670 | A671 | A672 |
| A673 | A674 | A675 | A676 | A677 | A678 | A679 | A680 | A681 | A682 | A683 | A684 |
| A685 | A686 | A687 | A688 | A689 | A690 | A691 | A692 | A693 | A694 | A695 | A696 |
| A697 | A698 | A699 | A700 | A701 | A702 | A703 | A704 | A705 | A706 | A707 | A708 |
| A709 | A710 | A711 | A712 | A713 | A714 | A715 | A716 | A717 | A718 | A719 | A720 |
| A721 | A722 | A723 | A724 | A725 | A726 | A727 | A728 | A729 | A730 | A731 | A732 |
| A733 | A734 | A735 | A736 | A737 | A738 | A739 | A740 | A741 | A742 | A743 | A744 |
| A745 | A746 | A747 | A748 | A749 | A750 | A751 | A752 | A753 | A754 | A755 | A756 |
| A757 | A758 | A759 | A760 | A761 | A762 | A763 | A764 | A765 | A766 | A767 | A768 |
| A769 | A770 | A771 | A772 | A773 | A774 | A775 | A776 | A777 | A778 | A779 | A780 |
| A781 | A782 | A783 | A784 | A785 | A786 | A787 | A788 | A789 | A790 | A791 | A792 |
| A793 | A794 | A795 | A796 | A797 | A798 | A799 | A800 | A801 | A802 | A803 | A804 |
| A805 | A806 | A807 | A808 | A809 | A810 | A811 | A812 | A813 | A814 | A815 | A816 |
| A817 | A818 | A819 | A820 | A821 | A822 | A823 | A824 | A825 | A826 | A827 | A828 |
| A829 | A830 | A831 | A832 | — | — | — | — | — | — | — | — |

TABLE 6
Compounds of formula I, represented as compounds of formula
A-Q
wherein Q is Q₂, and Q₂ is the radical C2:

| C2 | C2 | C2 | C2 | C2 | C2 | C2 | C2 | C2 | C2 | C2 | C2 |
|---|---|---|---|---|---|---|---|---|---|---|---|
| A1 | A2 | A3 | A4 | A5 | A6 | A7 | A8 | A9 | A10 | A11 | A12 |
| A13 | A14 | A15 | A16 | A17 | A18 | A19 | A20 | A21 | A22 | A23 | A24 |
| A25 | A26 | A27 | A28 | A29 | A30 | A31 | A32 | A33 | A34 | A35 | A36 |
| A37 | A38 | A39 | A40 | A41 | A42 | A43 | A44 | A45 | A46 | A47 | A48 |
| A49 | A50 | A51 | A52 | A53 | A54 | A55 | A56 | A57 | A58 | A59 | A60 |
| A61 | A62 | A63 | A64 | A65 | A66 | A67 | A68 | A69 | A70 | A71 | A72 |
| A73 | A74 | A75 | A76 | A77 | A78 | A79 | A80 | A81 | A82 | A83 | A84 |
| A85 | A86 | A87 | A88 | A89 | A90 | A91 | A92 | A93 | A94 | A95 | A96 |
| A97 | A98 | A99 | A100 | A101 | A102 | A103 | A104 | A105 | A106 | A107 | A108 |
| A109 | A110 | A111 | A112 | A113 | A114 | A115 | A116 | A117 | A118 | A119 | A120 |
| A121 | A122 | A123 | A124 | A125 | A126 | A127 | A128 | A129 | A130 | A131 | A132 |
| A133 | A134 | A135 | A136 | A137 | A138 | A139 | A140 | A141 | A142 | A143 | A144 |
| A145 | A146 | A147 | A148 | A149 | A150 | A151 | A152 | A153 | A154 | A155 | A156 |
| A157 | A158 | A159 | A160 | A161 | A162 | A163 | A164 | A165 | A166 | A167 | A168 |
| A169 | A170 | A171 | A172 | A173 | A174 | A175 | A176 | A177 | A178 | A179 | A180 |
| A181 | A182 | A183 | A184 | A185 | A186 | A187 | A188 | A189 | A190 | A191 | A192 |
| A193 | A194 | A195 | A196 | A197 | A198 | A199 | A200 | A201 | A202 | A203 | A204 |
| A205 | A206 | A207 | A208 | A209 | A210 | A211 | A212 | A213 | A214 | A215 | A216 |
| A217 | A218 | A219 | A220 | A221 | A222 | A223 | A224 | A225 | A226 | A227 | A228 |
| A229 | A230 | A231 | A232 | A233 | A234 | A235 | A236 | A237 | A238 | A239 | A240 |
| A241 | A242 | A243 | A244 | A245 | A246 | A247 | A248 | A249 | A250 | A251 | A252 |
| A253 | A254 | A255 | A256 | A257 | A258 | A259 | A260 | A261 | A262 | A263 | A264 |
| A265 | A266 | A267 | A268 | A269 | A270 | A271 | A272 | A273 | A274 | A275 | A276 |
| A277 | A278 | A279 | A280 | A281 | A282 | A283 | A284 | A285 | A286 | A287 | A288 |
| A289 | A290 | A291 | A292 | A293 | A294 | A295 | A296 | A297 | A298 | A299 | A300 |
| A301 | A302 | A303 | A304 | A305 | A306 | A307 | A308 | A309 | A310 | A311 | A312 |
| A313 | A314 | A315 | A316 | A317 | A318 | A319 | A320 | A321 | A322 | A323 | A324 |
| A325 | A326 | A327 | A328 | A329 | A330 | A331 | A332 | A333 | A334 | A335 | A336 |
| A337 | A338 | A339 | A340 | A341 | A342 | A343 | A344 | A345 | A346 | A347 | A348 |
| A349 | A350 | A351 | A352 | A353 | A354 | A355 | A356 | A357 | A358 | A359 | A360 |
| A361 | A362 | A363 | A364 | A365 | A366 | A367 | A368 | A369 | A370 | A371 | A372 |
| A373 | A374 | A375 | A376 | A377 | A378 | A379 | A380 | A381 | A382 | A383 | A384 |
| A385 | A386 | A387 | A388 | A389 | A390 | A391 | A392 | A393 | A394 | A395 | A396 |
| A397 | A398 | A399 | A400 | A401 | A402 | A403 | A404 | A405 | A406 | A407 | A408 |
| A409 | A410 | A411 | A412 | A413 | A414 | A415 | A416 | A417 | A418 | A419 | A420 |
| A421 | A422 | A423 | A424 | A425 | A426 | A427 | A428 | A429 | A430 | A431 | A432 |
| A433 | A434 | A435 | A436 | A437 | A438 | A439 | A440 | A441 | A442 | A443 | A444 |
| A445 | A446 | A447 | A448 | A449 | A450 | A451 | A452 | A453 | A454 | A455 | A456 |
| A457 | A458 | A459 | A460 | A461 | A462 | A463 | A464 | A465 | A466 | A467 | A468 |
| A469 | A470 | A471 | A472 | A473 | A474 | A475 | A476 | A477 | A478 | A479 | A480 |
| A481 | A482 | A483 | A484 | A485 | A486 | A487 | A488 | A489 | A490 | A491 | A492 |
| A493 | A494 | A495 | A496 | A497 | A498 | A499 | A500 | A501 | A502 | A503 | A504 |
| A505 | A506 | A507 | A508 | A509 | A510 | A511 | A512 | A513 | A514 | A515 | A516 |
| A517 | A518 | A519 | A520 | A521 | A522 | A523 | A524 | A525 | A526 | A527 | A528 |
| A529 | A530 | A531 | A532 | A533 | A534 | A535 | A536 | A537 | A538 | A539 | A540 |
| A541 | A542 | A543 | A544 | A545 | A546 | A547 | A548 | A549 | A550 | A551 | A552 |
| A553 | A554 | A555 | A556 | A557 | A558 | A559 | A560 | A561 | A562 | A563 | A564 |
| A565 | A566 | A567 | A568 | A569 | A570 | A571 | A572 | A573 | A574 | A575 | A576 |
| A577 | A578 | A579 | A580 | A581 | A582 | A583 | A584 | A585 | A586 | A587 | A588 |
| A589 | A590 | A591 | A592 | A593 | A594 | A595 | A596 | A597 | A598 | A599 | A600 |
| A601 | A602 | A603 | A604 | A605 | A606 | A607 | A608 | A609 | A610 | A611 | A612 |
| A613 | A614 | A615 | A616 | A617 | A618 | A619 | A620 | A621 | A622 | A623 | A624 |
| A625 | A626 | A627 | A628 | A629 | A630 | A631 | A632 | A633 | A634 | A635 | A636 |
| A637 | A638 | A639 | A640 | A641 | A642 | A643 | A644 | A645 | A646 | A647 | A648 |
| A649 | A650 | A651 | A652 | A653 | A654 | A655 | A656 | A657 | A658 | A659 | A660 |
| A661 | A662 | A663 | A664 | A665 | A666 | A667 | A668 | A669 | A670 | A671 | A672 |
| A673 | A674 | A675 | A676 | A677 | A678 | A679 | A680 | A681 | A682 | A683 | A684 |
| A685 | A686 | A687 | A688 | A689 | A690 | A691 | A692 | A693 | A694 | A695 | A696 |
| A697 | A698 | A699 | A700 | A701 | A702 | A703 | A704 | A705 | A706 | A707 | A708 |
| A709 | A710 | A711 | A712 | A713 | A714 | A715 | A716 | A717 | A718 | A719 | A720 |
| A721 | A722 | A723 | A724 | A725 | A726 | A727 | A728 | A729 | A730 | A731 | A732 |
| A733 | A734 | A735 | A736 | A737 | A738 | A739 | A740 | A741 | A742 | A743 | A744 |
| A745 | A746 | A747 | A748 | A749 | A750 | A751 | A752 | A753 | A754 | A755 | A756 |
| A757 | A758 | A759 | A760 | A761 | A762 | A763 | A764 | A765 | A766 | A767 | A768 |
| A769 | A770 | A771 | A772 | A773 | A774 | A775 | A776 | A777 | A778 | A779 | A780 |
| A781 | A782 | A783 | A784 | A785 | A786 | A787 | A788 | A789 | A790 | A791 | A792 |
| A793 | A794 | A795 | A796 | A797 | A798 | A799 | A800 | A801 | A802 | A803 | A804 |
| A805 | A806 | A807 | A808 | A809 | A810 | A811 | A812 | A813 | A814 | A815 | A816 |
| A817 | A818 | A819 | A820 | A821 | A822 | A823 | A824 | A825 | A826 | A827 | A828 |
| A829 | A830 | A831 | A832 | — | — | — | — | — | — | — | — |

TABLE 7
Compounds of formula I, represented as compounds of formula
A-Q
wherein A is A10:

| A10 | A10 | A10 | A10 | A10 | A10 | A10 | A10 | A10 | A10 | A10 | A10 |
|---|---|---|---|---|---|---|---|---|---|---|---|
| C1 | — | C3 | C4 | — | C6 | C7 | C8 | C9 | C10 | C11 | C12 |
| C13 | C14 | C15 | C16 | C17 | C18 | C19 | C20 | C21 | C22 | C23 | C24 |
| C25 | C26 | C27 | — | — | — | — | — | — | — | — | — |

TABLE 8
Compounds of formula I, represented as compounds of formula
A-Q
wherein A is A556:

| A556 | A556 | A556 | A556 | A556 | A556 | A556 | A556 | A556 | A556 | A556 | A556 |
|---|---|---|---|---|---|---|---|---|---|---|---|
| C1 | — | C3 | C4 | — | C6 | C7 | C8 | C9 | C10 | C11 | C12 |
| C13 | C14 | C15 | C16 | C17 | C18 | C19 | C20 | C21 | C22 | C23 | C24 |
| C25 | C26 | C27 | — | — | — | — | — | — | — | — | — |

TABLE 8
Compounds of formula I, represented as compounds of formula
A-Q
wherein A is A646:

| A646 | A646 | A646 | A646 | A646 | A646 | A646 | A646 | A646 | A646 | A646 | A646 |
|---|---|---|---|---|---|---|---|---|---|---|---|
| C1 | — | C3 | C4 | — | C6 | C7 | C8 | C9 | C10 | C11 | C12 |
| C13 | C14 | C15 | C16 | C17 | C18 | C19 | C20 | C21 | C22 | C23 | C24 |
| C25 | C26 | C27 | — | — | — | — | — | — | — | — | — |

Compounds of formulae 2.1 and 2.3 to 2.13.c are known by the names imazamox, imazethapyr, imazaquin, imazapyr, dimethenamid, atrazine, terbuthylazine, simazine, terbutryn, cyanazine, ametryn, terbumeton, prohexadione calcium, sethoxydim, clethodim, tepraloxydim, flumetsulam, metosulam, pyridate, bromoxynil, ioxynil, sulcotrione, carfentrazone, sulfentrazone, isoxaflutole, glufosinate, primisulfuron, prosulfuron, rimsulfuron, halosulfuron, nicosulfuron, ethoxysulfuron, flazasulfuron, triasulfuron, tralkoxydim, chlorsulfuron and thifensulfuron-methyl and are described in the Pesticide Manual, eleventh ed., British Crop Protection Council, 1997 under the entry numbers 412, 415, 414, 413, 240, 34, 692, 651, 693, 168, 20, 691, 595, 648, 146, 49, 339, 495, 626, 88, 425, 664, 112, 665, 436, 382, 589, 613, 644, 389, 519, 287, 325, 723, 717, 139 and 704. The compound of formula 2.13 wherein Y₂, Y₃ and Y₄ are methine, Y, is C—I, R₇₄ is COOMe, Y₅ is nitrogen, Y₆ is methyl and Y₇ is methoxy is known by the name iodosulfuron (especially the sodium salt) from AGROW No. 296, 16th January 1998, page 22. The compound of formula 2.13 wherein Y₁, Y₂, Y₃ and Y₄ are methine, R₇₄ is trifluoromethyl, Y₅ is nitrogen, Y₆ is trifluoromethyl and Y₇ is methoxy is known by the name tritosulfuron and is described in DE-A-40 38 430. The compound of formula 2.13 wherein Y₂ is NH—CHO, Y₁, Y₃ and Y₄ are methine, R₇₄ is CONMe₂, Y₅ is methine and Y₆ and Y₇ are methoxy is known by the name foramsulfuron and is described, for example, in WO 95/29899.

The compound of formula 2.13 wherein Y₂ is C—CH₂—NH—SO₂CH₃, Y₁, Y₃ and Y₄ are methine, R₇₄ is COOMe, Y₅ is methine, and Y₆ and Y₇ are methoxy, is known by the name mesosulfuron and is described, for example, under Chemical Abstracts Registry Number 208465-21-8.

Dichlorprop is described under Chemical Abstracts Registry Number 15165-67-0.

The S enantiomer of the compound of formula 2.12 is registered under the CAS-Reg. No. [35597-44-5]. The compound of the general formula 2.2, aRS,1′S(-)N-(1′-methyl-2′-methoxy-ethyl)-N-chloroacetyl-2-ethyl-6-methylaniline, and a compound of the general formula 2.3, (1S,aRS)-2-chloro-N-(2,4-dimethyl-3-thienyl)-N-(2-methoxy-1-methylethyl)-acetamide, are described, for example, in WO 97/34485. The compound of formula 2.9 wherein R₆₉ is NO₂ is known by the name mesotrione and is described, for example, in U.S. Pat. No. 5,006,158. The compound of formula 2.6 wherein R₆₂ is ethoxy, R₆₃ is fluorine, Y is methine, R₆₄ is methoxycarbonyl, R₆₅ is hydrogen and R₆₆ is chlorine is known by the name cloransulam, for example from AGROW No. 261, 2nd August 1996, page 21. The compound of formula 2.6 wherein R₆₂ is methoxy, R₆₃ is hydrogen, Y is C—F, R₆₄ is fluorine, R₆₅ is hydrogen and R₆₆ is fluorine is known by the name florasulam and is described in U.S. Pat. No. 5,163,995.

The following compounds of the composition according to the invention are described in the Pesticide Manual, eleventh ed., British Crop Protection Council, 1997:

| Compound of | Pesticide Manual |
|---|---|
| formula and/or name | eleventh ed., Entry No.: |
| 2.14 (metribuzin) | 497 |
| 2.15 (aclonifen) | 8 |
| 2.16 (glyphosate) | 383 |
| 2.17 (bentazone) | 65 |
| 2.18 (pendimethalin) | 557 |
| 2.19 (dicamba) | 210 |
| 2.20 (butylate) | 100 |
| 2.22 (clomazone) | 150 |
| 2.23 (2,4-D) | 192 |
| 2.24 (flumiclorac) | 340 |
| 2.25 (fluthiacet-methyl) | 359 |
| 2.26 (flurtamone) | 356 |
| 2.27 (flumioxazin) | 341 |
| 2.28 (paraquat) | 550 |
| 2.29 (azafenidin) | 37 |
| 2.30 (fluthiamide) | 51 |
| 2.33 (sulfosate) | 383 |
| 2.34 (asulam) | 33 |
| 2.35 (norflurazon) | 526 |
| 2.36 (terbacil) | 689 |
| 2.37 (thiazopyr) | 702 |
| 2.38 (dithiopyr) | 259 |
| 2.39 (hexazinone) | 400 |
| 2.40 (diuron) | 260 |
| 2.41 (MCPA) | 455 |
| 2.42 (mecoprop) | 459 |
| 2.43 (tebuthiuron) | 683 |
| prosulfocarb | 612 |
| pyraflufen-ethyl | 617 |
| fenoxaprop-P-ethyl | 309 |
| diclofop-methyl | 219 |
| amidosulfuron | 21 |
| flupyrsulfuron | 348 |
| flupyrsulfuron-methyl-sodium | 348 |
| metsulfuron-methyl | 498 |
| sulfosulfuron | 668 |
| tribenuron-methyl | 728 |
| imazamethabenz-methyl | 411 |
| chlorotoluron | 134 |
| isoproturon | 433 |
| methabenzthiazuron | 477 |
| bifenox | 69 |
| fluoroglycofen-ethyl | 344 |
| imazosulfuron | 416 |
| diflufenican | 232 |
| bilanafos | 71 |
| ethalfluralin | 279 |
| trifluralin | 740 |
| fluthiamid | 51 |
| isoxaben | 435 |
| triallate | 722 |
| 2,4-DB | 199 |
| MCPB | 457 |
| clopyralid | 153 |
| fluroxypyr | 354 |
| quinmerac | 636 |
| benazolin-ethyl | 55 |
| difenzoquat | 229 |
| dithiopyr | 259 |
| quinclorac | 635 |
| prodiamine | 593 |
| benefin | 57 |

The following compounds of the composition according to the invention are described in the Pesticide Manual, 12th ed., British Crop Protection Council, 2000:

| | Pesticide Manual |
|---|---|
| Compound | 12th ed., Entry No.: |
| picolinafen | 621 |
| beflubutamid | 57 |
| flucarbazone | 357 |
| cyhalofop-butyl | 191 |

The compound of formula 2.7 wherein R₆₇ is hydrogen and its preparation are described in U.S. Pat. No. 3,790,571; the compound of formula 2.6 wherein R₆₂ is ethoxy, Z is nitrogen, R₆₃ is fluorine, R₆₄ is chlorine and R₆₅ is hydrogen and R₆₆ is chlorine is described in U.S. Pat. No. 5,498,773.

The compound of formula 2.21 and its preparation are described in U.S. Pat. No. 5,183,492; the compound of formula 2.22 is described, under the name isoxachlortole, in AGROW No. 296, 16th January 1998, page 22. The compound of formula 2.31 is described, under the name fentrazamide, in The 1997 British Crop Protection Conference—Weeds, Conference Proceedings Vol. 1, 2-8, pages 67 to 72; the compound of formula 2.32 is described, under the name JV 485 (isoxapropazol), in The 1997 British Crop Protection Conference—Weeds, Conference Proceedings Vol. 1, 3A-2, pages 93 to 98. The compound of formula 2.44 is known by the name pethoxamid and is described, for example, in EP-A-0 206 251. The compound of formula 2.45 is known by the name procarbazone and is described, for example, in EP-A-0 507 171; the compound of formula 2.46 is known by the name fluazolate and is described, for example, in U.S. Pat. No. 5,530,126. The compound of formula 2.47 is known by the name cinidon-ethyl and is described, for example, in DE-A-40 37 840. The compound of formula 2.48 is known by the name benzfendizone and is described, for example, in WO 97/08953. The compound of formula 2.49 is known as diflufenzopyr and is described, for example, in EP-A-0 646 315. The compound of formula 2.50 (amicarbazone) and its preparation are disclosed in DD 298 393 and in U.S. Pat. No. 5,194,085. The compound of formula 2.51 (flufenpyr-ethyl) is described in Abstracts of Papers American Chemical Society, (2000) Vol. 220, No. Part 1, pp. AGRO 174. The compounds of formula 2.52 are described in WO 01/17352; the compound of formula 2.53 is described in U.S. Pat. No. 4,881,966.

It is extremely surprising that the combination of the compound of formula I with one or more active ingredients selected from formulae 2.1 to 2.53 and the compounds prosulfocarb, picolinafen, pyraflufen-ethyl, beflubutamid, fenoxaprop-P-ethyl, diclofop-methyl, amido-sulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin exceeds the additive effect on the weeds to be controlled that is to be expected in principle and thus broadens the range of action of the individual active ingredients especially in two respects: firstly, the rates of application of the individual compounds of formulae I and 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin are reduced while a good level of action is maintained and, secondly, the composition according to the invention achieves a high level of weed control also in those cases where the individual substances, in the low rates of application range, have become useless from the agronomic standpoint. The result is a considerable broadening of the spectrum of weeds and an additional increase in selectivity in respect of the crops of useful plants, as is necessary and desirable in the event of an unintentional overdose of active ingredient. The composition according to the invention, while retaining excellent control of weeds in crops of useful plants, also allows greater flexibility in succeeding crops.

The composition according to the invention can be used against a large number of agronomically important weeds, such as Stellaria, Nasturtium, Agrostis, Digitaria, Avena, Setaria, Sinapis, Lolium, Solanum, Phaseolus, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, Ipomoea, Chrysanthemum, Galium, Viola and Veronica. The composition according to the invention is suitable for all methods of application convention-ally used in agriculture, e.g. pre-emergence application, post-emergence application and seed dressing. The composition according to the invention is suitable especially for controlling weeds in crops of useful plants, such as cereals, rape, sugar beet, sugar cane, plantation crops, rice, maize and soybeans, and also for non-selective weed control.

“Crops” are to be understood to mean also those crops which have been made tolerant to herbicides or classes of herbicides (Ie.g. HPPD-inhibitors, ALS-inhibitors, EPSPS-(5-enol-pyruvyl-shikimate-3-phosphate-synthease)inhibitors or GS—(glutamine-synthease)inhibitors) as a result of conventional methods of breeding or genetic engineering. Examples for crops which have been made tolerant to imidazolinone as a result of conventional methods of breeding (mutagenese) is Clearfiled® canola. An example for crops which have been made tolerant to herbicides or classes of herbicides as a result of genetic engineering are maize seeds which are resistant to glyphosate and glufosinate respectively, commercially available under the brand Roundup Ready® and Liberty Link®.

The composition according to the invention comprises the compound of formula I and the compounds of formulae 2.1 to 2.53 and prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin in any mixing ratio, but usually has an excess of one component over the others. Generally, the mixing ratios (ratios by weight) of the compound of formula I and the mixing partners of formulae 2.1 to 2.53 and prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin are from 1:2000 to 2000:1, especially from 200:1 to 1:200.

The rate of application may vary within wide limits and depends on the nature of the soil, the method of application (pre- or post-emergence; seed dressing; application to the seed furrow; no tillage application etc.), the crop plant, the weed to be controlled, the prevailing climatic conditions, and other factors governed by the method of application, the time of application and the target crop. The active ingredient mixture according to the invention can generally be applied at a rate of from 1 to 5000 g of active ingredient mixture/ha.

The mixtures of the compound of formula I with the compounds of formulae 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin may be used in unmodified form, that is to say as obtained in the synthesis. Preferably, however, they are formulated in customary manner, together with the adjuvants conventionally used in formulation technology, such as solvents, solid carriers or surfactants, for example into emulsifiable concentrates, directly sprayable or dilutable solutions, dilute emulsions, wettable powders, soluble powders, dusts, granules or microcapsules. As with the nature of the compositions, the methods of application, such as spraying, atomising, dusting, wetting, scattering or pouring, are chosen in accordance with the intended objectives and the prevailing circumstances.

The formulations, i.e. the compositions, preparations or mixtures comprising the compounds of formulae I and 2.1 to 2.53 and prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin and also, where appropriate, one or more solid or liquid formulation adjuvants, are prepared in a manner known per se, e.g. by intimately mixing and/or grinding the active ingredients with the formulation adjuvants, e.g. solvents or solid carriers. In addition, surface-active compounds (surfactants) may also be used in the preparation of the formulations.

Examples of solvents and solid carriers are given, for example, in WO 97/34485, page 6.

Depending on the nature of the compound of formula I to be formulated, suitable surface-active compounds are non-ionic, cationic and/or anionic surfactants and surfactant mixtures having good emulsifying, dispersing and wetting properties.

Examples of suitable anionic, non-ionic and cationic surfactants are listed, for example, in WO 97/34485, pages 7 and 8.

Also suitable in the preparation of the herbicidal compositions according to the invention are the surfactants conventionally used in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol I-III, Chemical Publishing Co., New York, 1980-81.

The compositions according to the invention may additionally comprise an additive comprising an oil of vegetable or animal origin, a mineral oil, alkyl esters of such oils or mixtures of such oils and oil derivatives.

In the composition according to the invention, the amounts of oil additive employed are generally from 0.01 to 2%, based on the spray mixture. The oil additive can, for example, be added to the spray tank in the desired concentration after the spray mixture has been prepared.

Preferred oil additives comprise mineral oils or an oil of vegetable origin such as, for example, rapeseed oil, olive oil or sunflower oil, emulsified vegetable oil, such as AMIGO® obtainable from Rhône-Poulenc Canada Inc., alkyl esters of oils of vegetable origin such as, for example, the methyl derivatives, or an oil of animal origin such as fish oil or beef tallow. Especially preferred is the “additive type A”, which contains as active components essentially 80% by weight of alkyl esters of fish oils and 15% by weight of methylated rapeseed oil, and also 5% by weight of customary emulsifiers and pH modifiers.

Especially preferred oil additives comprise alkyl esters of higher fatty acids (C₈-C₂₂), especially the methyl derivatives of C₁₂-C₁₈ fatty acids, for example the methyl esters of lauric acid, palmitic acid and oleic acid. Those esters are known as methyl laurate (CAS-111-82-0), methyl palmitate (CAS-112-39-0) and methyl oleate (CAS-112-62-9). A preferred fatty acid methyl ester derivative is Emery® 2230 and 2231 (Henkel subsidiary company Cognis GmbH, DE).

The application and action of the oil additives can be improved by combining them with surface-active substances such as non-ionic, anionic or cationic surfactants. Examples of suitable anionic, non-ionic and cationic surfactants are listed in WO 97/34485 on pages 7 and 8.

Preferred surface-active substances are anionic surfactants of the dodecylbenzylsulfonate type, especially the calcium salts thereof, and also non-ionic surfactants of the fatty alcohol ethoxylate type. Special preference is given to ethoxylated C₁₂-C₂₂ fatty alcohols having a degree of ethoxylation of from 5 to 40. Examples of commercially available preferred surfactants are the Genapol types (Clariant AG, Muttenz, Switzerland). The concentration of the surface-active substances based on the total additive is generally from 1 to 30% by weight.

Surface-active substances the use of which is likewise preferred are silicone surfactants, especially polyalkyl-oxide-modified heptamethyltrisiloxanes, such as are obtainable commercially as, for example, Silwet L-77®, and also perfluorinated surfactants.

Examples of oil additives consisting of mixtures of oils or mineral oils or derivatives thereof with surfactants are Edenor ME SU®, Turbocharge® (Zeneca Agro, Stoney Creek, Ontario, CA) or, more especially, Actipron® (BP Oil UK Limited, GB).

The addition of an organic solvent to the oil additive/surfactant mixture can, furthermore, bring about a further increase in action. Suitable solvents are, for example, Solvesso®(ESSO) or Aromatic Solvent®) (Exxon Corporation) types. The concentration of those solvents can be from 10 to 80% of the total weight.

Such oil additives, which are also described, for example, in U.S. Pat. No. 4,834,908, are especially preferred for the composition according to the invention. An especially preferred oil additive is known under the name MERGE®, it can be obtained from the BASF Corporation and a basic description thereof is given, for example, in U.S. Pat. No. 4,834,908 in col. 5, as Example COC-1. A further oil additive that is preferred according to the invention is SCORE® (Novartis Crop Protection Canada).

In addition to the above-listed oil additives, formulations of alkylpyrrolidones such as are marketed commercially, for example as Agrimax®, may additionally be added to the spray mixture in order to enhance the action of the compositions according to the invention. There may likewise be used, for the purpose of enhancing action, formulations of synthetic latices, for example polyacrylamide, polyvinyl compounds or poly-1-p-menthene, such as are available on the market as, for example, Bond®, Courier® or Emerald®. In addition, propionic acid-containing solutions, such as Eurogkem Pen-e-trate®, may be added to the spray mixture as action-enhancing agents.

To the compositions according to the invention comprising the compounds of formulae 2.52 there are preferably added one or more of the above-listed oil additives or of the above-listed alkylpyrrolidone formulations, synthetic latices or propionic acid-containing solutions.

The herbicidal formulations usually contain from 0.1 to 99% by weight, especially from 0.1 to 95% by weight, of active ingredient mixture comprising a compound of formula I together with the compounds of formulae 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenz-thiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin, from 1 to 99.9% by weight of a solid or liquid formulation adjuvant, and from 0 to 25% by weight, especially from 0.1 to 25% by weight, of a surfactant.

Whereas commercial products are usually formulated as concentrates, the end user will normally employ dilute formulations. The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. Preferred formulations have especially the following compositions:

(%=percent by weight)

Emulsifiable Concentrates:

active ingredient mixture: 1 to 90%, preferably 5 to 20%
surfactant: 1 to 30%, preferably 10 to 20%
liquid carrier: 5 to 94%, preferably 70 to 85%
   Dusts:
active ingredient mixture: 0.1 to 10%, preferably 0.1 to 5%
solid carrier: 99.9 to 90%, preferably 99.9 to 99%
   Suspension Concentrates:
active ingredient mixture: 5 to 75%, preferably 10 to 50%
water: 94 to 24%, preferably 88 to 30%
surfactant: 1 to 40%, preferably 2 to 30%
   Wettable Powders:
active ingredient mixture: 0.5 to 90%, preferably 1 to 80%
surfactant: 0.5 to 20%, preferably 1 to 15%
solid carrier: 5 to 95%, preferably 15 to 90%
   Granules:
active ingredient mixture: 0.1 to 30%, preferably 0.1 to 15%
solid carrier: 99.5 to 70%, preferably 97 to 85%

The following Examples illustrate the invention further, but do not limit the invention.

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| N-methyl-2-pyrrolidone | — | — | 30% | 10% |
| arom. hydrocarbon mixture | 75% | 60% | — | — |
| C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the compound of formula I and the mixing partner or partners of formulae 2.1 to 2.53 and prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin to be formulated separately and to be brought together in the desired mixing ratio in the applicator in the form of a “tank mixture” in water shortly before application.

The compositions according to the invention may additionally comprise growth regulators, such as, for example, trinexapac (744), chlormequat chloride (129), clofencet (148), cyclanilide (170), ethephon (281), flurprimidol (355), gibberellic acid (379), inabenfide (421), maleic hydrazide (449), mefluidide (463), mepiquat chloride (465), paclobutrazol (548), prohexadione-calcium (595), uniconazole (746) or thidiazuron (703). Fungicides, such as, for example, azoxystrobin (43), epoxiconazole (48), benomyl (60), bromuconazole (89), bitertanol (77), carbendazim (107), cyproconazole (189), cyprodinil (190), diclomezine (220), difenoconazole (228), diniconazole (247), epoxiconazole (48), ethirimol (284), etridiazole (294), fenarimol (300), fenbuconazole (302), fenpiclonil (311), fenpropidin (313), fenpropimorph (314), ferimzone (321), fludioxonil (334), fluquinconazole (349), flutolanil (360), flutriafol (361), imazalil (410), ipconazole (426), iprodione (428), isoprothiolane (432), kasugamycin (438), kresoxim-methyl (439), spiroxamine (441), mepronil (466), myclobutanil (505), nuarimol (528), pefurazoate (554), pencycuron (556), phthalide (576), probenazole (590), prochloraz (591), propiconazole (607), pyrazophos (619), pyroquilon (633), quinoxyfen (638), quintozene (639), tebuconazole (678), tetraconazole (695), thiabendazole (701), thifluzamide (705), triadimefon (720), triadimenol (721), tricyclazole (734), tridemorph (736), triflumizole (738), triforine (742), triticonazole (745) or vinclozolin (751), may also be present in the compositions according to the invention. The number in parentheses after each active ingredient indicates the entry number of the active ingredient in the Pesticide Manual, eleventh ed., British Crop Protection Council, 1997.

Biological Examples:

A synergistic effect exists whenever the action of the active ingredient combination of the compound of formula I with compounds of formulae 2.1 to 2.53 and prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin is greater than the sum of the actions of the active ingredients applied separately.

The herbicidal action to be expected We for a given combination of two herbicides can be calculated as follows (see COLBY, S. R., “Calculating synergistic and antagonistic response of herbicide combinations”, Weeds 15, pages 20-22, 1967:
We=X+[Y•(100−X)/100]
wherein:

X=percentage herbicidal action on treatment with the compound of formula I at a rate of application of p kg per hectare, compared with the untreated control (=0%).

Y=percentage herbicidal action on treatment with a compound of formula 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chloro-toluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin at a rate of application of q kg per hectare, compared with the untreated control.

We=expected herbicidal action (percentage herbicidal action compared with the untreated control) following treatment with the compounds of formulae I and 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin at a rate of application of p+q kg of active ingredient per hectare.

When the action actually observed is greater than the value to be expected We, there is a synergistic effect.

The synergistic effect of the combinations of a compound of formula I with the compounds of formulae 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin is demonstrated in the following Examples.

Experiment Description—Pre-Emergence Test:

Monocotyledonous and dicotyledonous test plants are sown in standard soil in plastics pots. Directly after sowing, the test compounds are applied in aqueous suspension by spraying (500 litres of water/ha). The rates of application depend on the optimum concentrations determined under field conditions and greenhouse conditions. The test plants are then grown in the greenhouse under optimum conditions. The tests are evaluated after 36 days (% action, 100%=plant has died, 0%=no phytotoxic action). The mixtures used in this test exhibit good results.

Experiment Description—Post-Emergence Test:

The test plants are grown to the 2- to 3-leaf stage in plastics pots under greenhouse conditions. A standard soil is used as cultivation substrate. At the 2- to 3-leaf stage, the herbicide is applied to the test plants both alone and in admixture. Application is carried out using an aqueous suspension of the test compounds in 500 litres of water/ha. The rates of application depend on the optimum concentrations determined under field conditions and greenhouse conditions. The tests are evaluated after 33 days (% action, 100%=plant has died, 0%=no phytotoxic action). In this test, too, the mixtures used exhibit good results.

It has been shown, surprisingly, that specific safeners are suitable for mixing with the synergistic composition according to the invention. The present invention accordingly relates also to a selectively herbicidal composition for controlling grasses and weeds in crops of useful plants, especially in maize crops, that comprises a compound of formula I, one or more compounds selected from the compounds of formulae 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin, and a safener (counter agent, antidote) that protects the useful plants, but not the weeds, against the phytotoxic action of the herbicide, as well as to the use of such a composition in the control of weeds in crops of useful plants.

There is accordingly also proposed in accordance with the invention a selectively herbicidal composition that, in addition to comprising customary inert formulation adjuvants, such as carriers, solvents and wetting agents, comprises as active ingredient a mixture of a) an amount, effective for herbicide synergism, of the compound of formula I and one or more compounds selected from the compounds of formulae 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin, and b) an amount, effective for herbicide antagonism, of a compound selected from the compound of formula 3.1 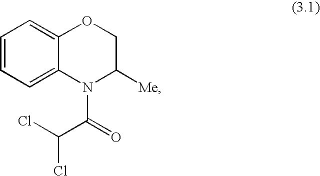
and the compound of formula 3.2 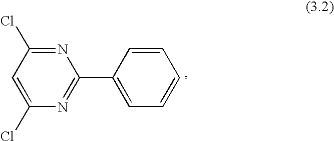
and the compound of formula 3.3 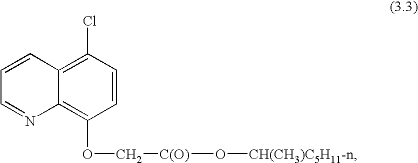
the free acid thereof and salts and hydrates thereof,
and the compound of formula 3.4 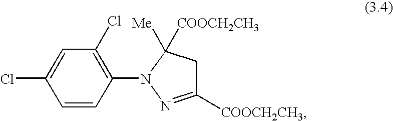
   and the compound of formula 3.5 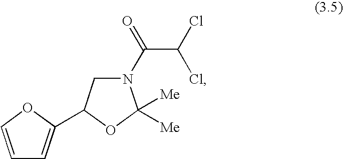
   and the compound of formula 3.6 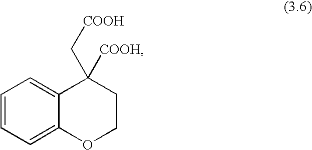
   and the compound of formula 3.7 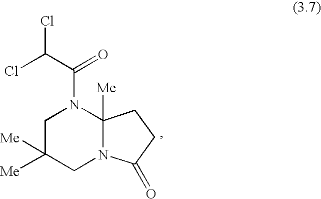
   and the compound of formula 3.8 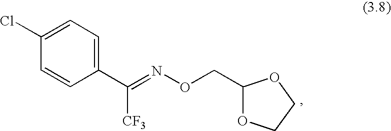
   and of formula 3.9
   Cl₂CHCON(CH₂CH═CH₂)₂ (3.9),
   and of formula 3.10 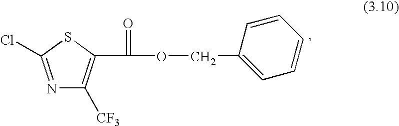
   and of formula 3.11 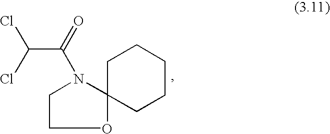
   and of formula 3.12 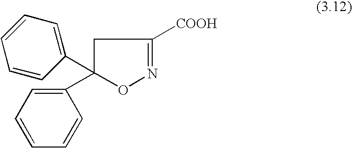
   and methyl and ethyl esters thereof and salts thereof, especially the sodium salt,
and of formula 3.13 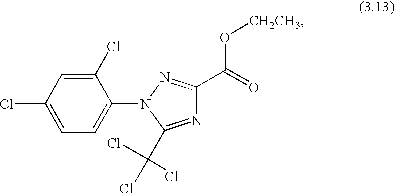
   and of formula 3.14 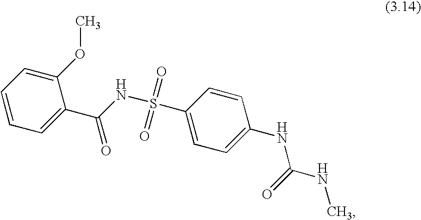
   and of formula 3.15 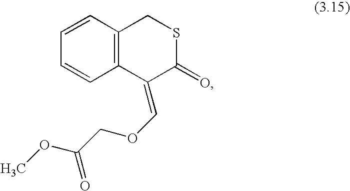
   and of formula 3.16 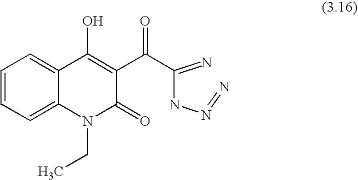
   and of formula 3.17

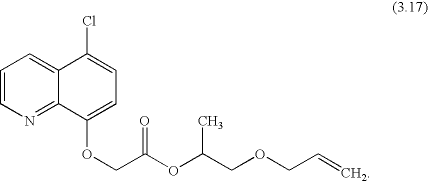

The invention relates also to a selectively herbicidal composition that, in addition to comprising customary inert formulation adjuvants, such as carriers, solvents and wetting agents, comprises as active ingredient a mixture of
a) a herbicidally effective amount of the compound of formula I and
b) an amount, effective for herbicide antagonism, of a compound selected from the compounds of formulae 3.1, 3.2, 3.3, 3.4, 3.5, 3.6, 3.7, 3.8, 3.9, 3.10, 3.11, 3.12, 3.13, 3.14, 3.15, 3.16 and 3.17.

Preferred compositions according to the invention comprise as safener a compound selected from the compounds of formulae 3.1, 3.3 and 3.8. Such safeners are suitable especially for the compositions according to the invention that comprise the above-mentioned preferred compounds of formulae 2.1 to 2.53 or prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin.

Preferred compositions according to the invention also comprise an amount, effective for herbicide antagonism, of 2-(5-chloroquinolin-8-yloxy)acetic acid-1-methyl hexyl ester of formula 3.3, or a hydrate thereof, especially 1-methylhexyl-(5-chloroquinolin-8-yloxy)acetate tetrahydrate, the free acid thereof or a salt thereof of formula 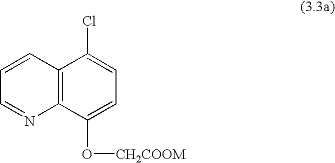
wherein M is a mono-, di- or tri-valent metal, ammonium, N(R)₄ or HN(R)₃, wherein the substituents R are identical to or different from one another and are C₁-C₁₆alkyl or C₁-C₁₆hydroxyalkyl, or M is S(Rₐ)₃ or P(Rₐ)₄, wherein the substituents Rₐ are identical to or different from one another and are C₁-C₂Oalkyl, C₂-C₂₀alkenyl, C₂-C₂₀alkynyl, aryl substituted by C₁-C₂₀alkyl, C₂-C₂₀alkenyl or by C₂-C₂₀alkynyl, or heteroaryl substituted by C₁-C₂₀alkyl, C₂-C₂₀alkenyl or by C₂-C₂₀alkynyl, or 2 substituents Rₐ together with the sulfur or phosphorus atom to which they are bonded form a 5- or 6-membered ring.

The metal atoms M that may be present in formula 3.3a are preferably those of alkali metals or alkaline earth metals, especially sodium, potassium, calcium, magnesium and also especially aluminium and iron as preferred examples of trivalent metals.

Of the alkyl and hydroxyalkyl substituents R, preference is given to those having from 12 to 16 carbon atoms and also to those having from 1 to 4 carbon atoms. The groups N(R)₄ and HN(R)₃ especially contain one long-chain and 2 or 3 short-chain alkyl groups, such as, for example, hexadecyl-triethylammonium, tetradecyl-triethylammonium, dodecyl-triethyl-ammonium, dodecyl-ethyl-dimethylammonium and also tetradodecylammonium. Preferred alkyl groups Rₐ contain from 1 to 12, especially from 1 to 6, carbon atoms. The alkyl groups R and Rₐ may themselves be substituted, for example by halogen, alkoxy or haloalkoxy, each of which preferably has from 1 to 4 carbon atoms. Preferred alkenyl and alkynyl groups Rₐ contain from 2 to 12 carbon atoms. They may contain more than one unsaturated bond and may be substituted by halogen, alkoxy or haloalkoxy, each of which preferably has from 1 to 4 carbon atoms. Suitable examples of aryl groups Rₐ are phenyl, naphthyl, tetrahydro-naphthyl, indanyl and indenyl, phenyl being preferred. Such groups may be substituted by the above-mentioned alkyl, alkenyl and alkynyl groups. There may be mentioned as heteroaryl groups Rₐ preferably 5- and 6-membered rings that contain especially nitrogen and/or oxygen atoms, such as, for example, pyridyl, pyrimidinyl, triazinyl, thienyl, thiazolyl, pyrazolyl, imidazolyl, piperidyl, dioxolanyl, morpholinyl and tetrahydrofuryl. Such heterocycles too may themselves be substituted by the above-mentioned alkyl, alkenyl and alkynyl groups. Groups of two Rₐ substituents may, together with the sulfur or phosphorus atom to which they are bonded, form a ring. Preferably, 5- or 6-membered, saturated rings are formed. The sulfonium and phosphonium cations that can be used according to the invention are described, for example, in WO 00/44227.

Preferred salts of 2-(5-chloroquinolin-8-yloxy)acetic acid-1-methyl hexyl ester comprise a compound of formula 3.3a wherein M is sodium, potassium or tri(hydroxyethylene)ammonium.

A further group of preferred salts of 2-(5-chloroquinolin-8-yloxy)acetic acid-1-methyl hexyl ester comprises those wherein, in formula 3.3a, M is calcium, magnesium, aluminium, iron, trimethylsulfonium, triphenylsulfonium, tetraphenylphosphonium, triphenyl-methyl-phosphonium, triphenyl-benzylphosphonium, C₁₂-C₁₆alkyl-trimethylammonium, C₁₂-C₁₆alkyl-triethylammonium, tetradodecylammonium or dodecyl-ethyl-dimethylammonium.

The salts of formula 3.3a can be prepared according to customary methods, for example by reaction of 2-(5-chloroquinolin-8-yloxy)acetic acid-1-methyl hexyl ester with an equimolar amount of a metal hydroxide in alcoholic solution at room temperature.

The salts listed in the following Table are obtainable in that manner:

TABLE A
Compounds of formula 3.3a:

| Compound No. | M | M.p. (° C.) |
|---|---|---|
| 2.01 | Na | >250 |
| 2.02 | K | >265 |
| 2.03 | Ca | |
| 2.04 | Mg | |
| 2.05 | NH₄ | 227-228 |
| 2.06 | NH(CH₂CH₂OH)₃ | 132-152 |
| 2.07 | N(C₁₂H₂₅)₄ | |
| 2.08 | N(C₁₂H₂₅)(C₂H₅)(CH₃)₂ | |
| 2.09 | N(C₁₂H₂₅)(CH₃)₃ | |
| 2.10 | N(C₁₂H₂₅)(C₂H₅)₃ | |
| 2.11 | Al | |
| 2.12 | Fe | |
| 2.13 | H | 232-233 |
| 2.14 | S(CH₃)₃ | |
| 2.15 | S(C₆H₅)₃ | |
| 2.16 | P(C₆H₅)₄ | |
| 2.17 | P(C₆H₅)₃CH₃ | |
| 2.18 | P(C₆H₅)₃CH₂C₆H₅ | |

Further preferred compositions according to the invention comprise a compound of formula 2.53 and an amount, effective for herbicide antagonism, of 2-(5-chloroquinolin-8-yloxy)-1-methylhexyl ester of formula 3.3, or a hydrate thereof, especially 1-methylhexyl (5-chloroquinolin-8-yloxy)acetate tetrahydrate, the free acid thereof or a salt thereof of formula 3.3a.

Combinations of the compound of formula I with the compound of formula 3.1 have proved to be especially effective compositions. Such a composition is used preferably together with the compound of formula 2.2a 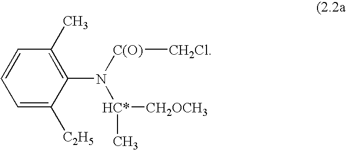
aRS,1′S(−)N-(1′-methyl-2′-methoxyethyl)-N-chloroacetyl-2-ethyl-6-methylaniline).

The invention relates also to a method for the selective control of weeds in crops of useful plants, which comprises treating the useful plants, seeds or cuttings thereof, or the area of cultivation thereof, with a herbicidally effective amount of the herbicide of formula I, optionally one or more herbicides selected from the compounds of formulae 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin, and an amount, effective for herbicide antagonism, of a safener from formulae 3.1 to 3.17.

The compounds of formulae 3.1 to 3.17 are known and are described, for example, in the Pesticide Manual, eleventh ed., British Crop Protection Council, 1997 under the entry numbers 61 (formula 3.1, benoxacor), 304 (formula 3.2, fenclorim), 154 (formula 3.3, cloquintocet), 462 (formula 3.4, mefenpyr-diethyl), 377 (formula 3.5, furilazole), 363 (formula 3.8, fluxofenim), 213 (formula 3.9, dichlormid) and 350 (formula 3.10, flurazole). The compound of formula 3.11 is known as MON 4660 (Monsanto) and is described, for example, in EP-A-0 436 483. The compound of formula 3.17 is described, for example, in U.S. Pat. No. 6,162,762.

The compound of formula 3.6 (AC 304415) is described, for example, in EP-A-0 613 618, and the compound of formula 3.7 in DE-A-29 48 535. The compounds of formula 3.12 are described in DE-A-43 31 448, and the compound of formula 3.13 in DE-A-35 25 205. The compound of formula 3.14 is known, for example, from U.S. Pat. No. 5,215,570, and the compound of formula 3.15 from EP-A-0 929 543. The compound of formula 3.17 is described in WO 99/00020. In addition to the compound of formula 3.17, the other 3-(5-tetrazolyl-carbonyl)-2-quinolones described in WO 99/00020, especially the compounds specifically disclosed in Tables 1 and 2 on pages 21 to 29, are also suitable for protecting crop plants against the phytotoxic action of the compounds of formula I.

As crop plants that can be protected by the safeners of formulae 3.1 to 3.17 against the damaging effect of the above-mentioned herbicides there come into consideration especially cereals, cotton, soybeans, sugar beet, sugar cane, plantation crops, rape, maize and rice, more especially maize. “Crops” are to be understood to mean also those crops which have been made tolerant to herbicides or classes of herbicides as a result of conventional methods of breeding or genetic engineering.

The weeds to be controlled may be both monocotyledonous and dicotyledonous weeds, such as, for example Stellaria, Agrostis, Digitaria, Avena, Apera, Brachiaria, Phalaris, Setaria, Sinapis, Lolium, Solanum, Echinochloa, Scirpus, Monochoria, Sagittaria, Panicum, Bromus, Alopecurus, Sorghum halepense, Sorghum bicolor, Rottboellia, Cyperus, Abutilon, Sida, Xanthium, Amaranthus, Chenopodium, Ipomoea, Chrysanthemum, Galium, Viola and Veronica.

Areas of cultivation include the areas of ground on which the crop plants are already growing or which have been sown with the seeds of those crop plants, as well as ground intended for the cultivation of such crop plants.

Depending on the intended use, a safener of formula 3.1 to 3.17 can be used in the pretreatment of the seed of the crop plant (dressing of the seeds or cuttings) or can be introduced into the soil before or after sowing. It can, however, also be applied, either alone or together with the herbicide, after emergence of the plants. The treatment of the plants or seeds with the safener can therefore in principle be carried out independently of the time at which the herbicide is applied. The plants can, however, also be treated by simultaneous application of herbicide and safener (e.g. in the form of a tank mixture). The ratio of the rate of application of safener to the rate of application of herbicide depends largely on the method of application. In the case of field treatment, which is carried out either using a tank mixture comprising a combination of safener and herbicide or by separate application of safener and herbicide, the ratio of herbicides to safener is generally from 100:1 to 1:10, preferably from 20:1 to 1:1. In the case of field treatment it is usual to apply from 0.001 to 1.0 kg of safener/ha, preferably from 0.001 to 0.25 kg of safener/ha.

The rate of application of herbicides is generally from 0.001 to 5 kg/ha, but preferably from 0.005 to 0.5 kg/ha.

The compositions according to the invention are suitable for all methods of application conventionally used in agriculture, e.g. pre-emergence application, post-emergence application and seed dressing.

In the case of seed dressing, generally from 0.001 to 10 g of safener/kg of seed, preferably from 0.05 to 2 g of safener/kg of seed, are applied. When the safener is applied in liquid form shortly before sowing, with soaking of the seeds, then advantageously the safener solutions used contain the active ingredient in a concentration of from 1 to 10 000 ppm, preferably from 100 to 1000 ppm.

For the purpose of application, the safeners of formulae 3.1 to 3.17 or combinations of those safeners with a herbicide of formula I and optionally one or more herbicides selected from formulae 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin are advantageously formulated together with adjuvants customary in formulation technology, e.g. into emulsifiable concentrates, coatable pastes, directly sprayable or dilutable solutions, dilute emulsions, wettable powders, soluble powders, dusts, granules or microcapsules.

Such formulations are described, for example, in WO 97/34485, pages 9 to 13. The formulations are prepared in known manner, e.g. by intimately mixing and/or grinding the active ingredients with liquid or solid formulation adjuvants, e.g. solvents or solid carriers. In addition, surface-active compounds (surfactants) can also be used in the preparation of the formulations. Solvents and solid carriers suitable for that purpose are mentioned, for example, in WO 97/34485, page 6.

Depending on the nature of the compound of formulae I, 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin and 3.1 to 3.17 to be formulated, there come into consideration as surface-active compounds non-ionic, cationic and/or anionic surfactants and surfactant mixtures having good emulsifying, dispersing and wetting properties. Examples of suitable anionic, non-ionic and cationic surfactants are listed, for example, on pages 7 and 8 of WO 97/34485. Also suitable for the preparation of the herbicidal compositions according to the invention are the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol. I-III, Chemical Publishing Co., New York, 1980-81.

The herbicidal formulations usually contain from 0.1 to 99% by weight, especially from 0.1 to 95% by weight, of active ingredient mixture comprising the compound of formula I, a compound selected from the compounds of formulae 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin and the compounds of formulae 3.1 to 3.17, from 1 to 99.9% by weight of a solid or liquid formulation adjuvant and from 0 to 25% by weight, especially from 0.1 to 25% by weight, of a surfactant. Whereas commercial products are usually formulated as concentrates, the end user will normally employ dilute formulations.

The compositions may also comprise further ingredients, such as stabilisers, e.g. vegetable oils or epoxidised vegetable oils (epoxidised coconut oil, rapeseed oil or soybean oil), anti-foams, e.g. silicone oil, preservatives, viscosity regulators, binders, tackifiers, and also fertilisers or other active ingredients. For the use of safeners of formulae 3.1 to 3.17, or of compositions comprising them, in the protection of crop plants against the damaging effects of herbicides of formulae I and 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenz-thiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin, various methods and techniques come into consideration, such as, for example, the following:

i) Seed Dressing

a) Dressing of the seeds with a wettable powder formulation of a compound from formulae 3.1 to 3.17 by shaking in a vessel until uniformly distributed over the seed surface (dry dressing). In that procedure approximately from 1 to 500 g of compound from formulae 3.1 to 3.17 (4 g to 2 kg of wettable powder) are used per 100 kg of seed.
b) Dressing of the seeds with an emulsifiable concentrate of a compound from formulae 3.1 to 3.17 according to method a) (wet dressing).
c) Dressing by immersing the seeds for from 1 to 72 hours in a liquor comprising from 100 to 1000 ppm of a compound from formulae 3.1 to 3.17 and optionally subsequently drying the seeds (immersion dressing).

Dressing the seed or treating the germinated seedling are naturally the preferred methods of application, because treatment with the active ingredients is directed entirely at the target crop. Generally from 1 to 1000 g of antidote, preferably from 5 to 250 g of antidote, are used per 100 kg of seed, but depending on the methodology, which also allows other active ingredients or micronutrients to be added, concentrations above or below the limits indicated may be employed (repeat dressing).

ii) Application as a Tank Mixture

A liquid formulation of a mixture of antidote and herbicide is used (ratio by weight of the one to the other from 10:1 to 1:100), the rate of application of herbicide being from 0.005 to 5.0 kg per hectare. Such tank mixtures are applied before or after sowing.

iii) Application to the Seed Furrow

The compound from formulae 3.1 to 3.17 is introduced into the open, sown seed furrow in the form of an emulsifiable concentrate, wettable powder or granules. Once the seed furrow has been covered over, the herbicide is applied in the usual manner pre-emergence.

iv) Controlled Release of Active Ingredient

The compound from formulae 3.1 to 3.17 is applied in solution to mineral carrier granules or polymerised granules (urea/formaldehyde) and dried. If desired, it is also possible to apply a coating that allows the active ingredient to be released in metered amounts over a specific period of time (coated granules).

Preferred formulations have especially the following compositions:

(%=percent by weight)

Emulsifiable Concentrates:

active ingredient mixture: 1 to 90%, preferably 5 to 20%
surfactant: 1 to 30%, preferably 10 to 20%
liquid carrier: 5 to 94%, preferably 70 to 85%
   Dusts:
active ingredient mixture: 0.1 to 10%, preferably 0.1 to 5%
solid carrier: 99.9 to 90%, preferably 99.9 to 99%
   Suspension Concentrates:
active ingredient mixture: 5 to 75%, preferably 10 to 50%
water: 94 to 24%, preferably 88 to 30%,
surfactant: 1 to 40%, preferably 2 to 30%
   Wettable powders:
active ingredient mixture: 0.5 to 90%, preferably 1 to 80%
surfactant: 0.5 to 20%, preferably 1 to 15%
solid carrier: 5 to 95%, preferably 15 to 90%
   Granules:
active ingredient mixture: 0.1 to 30%, preferably 0.1 to 15%
solid carrier: 99.5 to 70%, preferably 97 to 85%

The following Examples illustrate the invention further, but do not limit the invention.

Formulation Examples for mixtures of herbicides of formula I, optionally of formulae 2.1 to 2.53 and the compounds prosulfocarb, picolinafen, Pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin and safeners of formulae 3.1 to 3.17 (%=percent by weight)

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| N-methyl-2-pyrrolidone | — | — | 30% | 10% |
| arom. hydrocarbon mixture | 75% | 60% | — | — |
| C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the compounds of formulae I, 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin and 3.1 to 3.17 to be formulated separately and then to be brought together in the desired mixing ratio in the applicator in the form of a “tank mixture” in water shortly before application.

The ability of the safeners of formulae 3.1 to 3.17 to protect crop plants against the phytotoxic action of herbicides of formula I is illustrated in the following Examples.

Biological Example: Safening Action

The test plants are grown in plastics pots under greenhouse conditions to the 4-leaf stage. At that stage, either the herbicides alone or the mixtures of the herbicides with the test compounds being tested as safeners are applied to the test plants. The test compounds are applied in the form of an aqueous suspension prepared from a 25% wettable powder (Example F3, b)), using 500 litres of water/ha. 4 weeks after application, the phytotoxic action of the herbicides on the crop plants, e.g. maize and cereals, is evaluated using a percentage scale. 100% indicates that the test plant has died, 0% indicates no phytotoxic action. The mixtures according to the invention exhibit a good action in this test.

1. A selectively herbicidal composition that, in addition to comprising customary inert formulation adjuvants, comprises as active ingredient a mixture of
a) a herbicidally effective amount of the compound of formula I 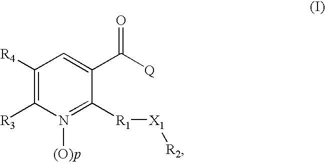
wherein
p is 0 or 1;
R₁ is a C₁-C₆alkylene, C₃-C₆alkenylene or C₃-C₆alkynylene chain, which may be substituted one or more times by halogen or by R₅, the unsaturated bonds of the chain not being attached directly to the substituent X₁;
X₁ is oxygen, —O(CO)—, —(CO)O—, —O(CO)O—, —N(R₆)—O—, —O—NR₅₁-, thio, sulfinyl, sulfonyl, —SO₂NR₇—, —NR₅₂SO₂— or —NR₈—;
R₂ is a C₁-C₈alkyl, C₃-C₆alkenyl or C₃-C₆alkynyl group, which is substituted one or more times by halogen, hydroxy, amino, formyl, nitro, cyano, mercapto, carbamoyl, C₁-C₆alkoxy, C₁-C₆alkoxycarbonyl, C₂-C₆alkenyl, C₂-C₆haloalkenyl, C₂-C₆alkynyl, C₂-C₆haloalkynyl, C₃-C₆-cycloalkyl, halo-substituted C₃-C₆cycloalkyl, C₃-C₆alkenyloxy, C₃-C₆alkynyloxy, C₁-C₆halo-alkoxy, C₃-C₆haloalkenyloxy, cyano-C₁-C₆alkoxy, C₁-C₆alkoxy-C₁-C₆alkoxy, C₁-C₆alkoxy-C₁-C₆alkoxy-C₁-C₆alkoxy, C₁-C₆alkylthio-C₁-C₆alkoxy, C₁-C₆alkylsulfinyl-C₁-C₆alkoxy, C₁-C₆-alkylsulfonyl-C₁-C₆alkoxy, C₁-C₆alkoxycarbonyl-C₁-C₆alkoxy, C₁-C₆alkoxycarbonyl, C₁-C₆-alkylcarbonyl, C₁-C₆alkylthio, C₁-C₆alkylsulfinyl, C₁-C₆alkylsulfonyl, C₁-C₆haloalkylthio, C₁-C₆haloalkylsulfinyl, C₁-C₆haloalkylsulfonyl, oxiranyl (which may in turn be substituted by C₁-C₆alkyl), (3-oxetanyl)-oxy (which may in turn be substituted by C₁-C₆alkyl), benzylthio, benzylsulfinyl, benzylsulfonyl, C₁-C₆alkylamino, di(C₁-C₆alkyl)amino, R₉S(O)₂O, R₁₀N(R₁₁)SO₂—, rhodano, phenyl, phenoxy, phenylthio, phenylsulfinyl or by phenylsulfonyl;
wherein the phenyl- or benzyl-containing groups may in turn be substituted by one or more C₁-C₆alkyl, C₁-C₆haloalkyl, C₁-C₆alkoxy, C₁-C₆haloalkoxy, halogen, cyano, hydroxy or nitro groups, or
R₂ is phenyl, which may be substituted one or more times by C₁-C₆alkyl, C₁-C₆haloalkyl, C₁-C₆alkoxy, C₁-C₆haloalkoxy, halogen, cyano, hydroxy or by nitro; or
R₂ is C₃-C₆cycloalkyl; C₃-C₆cycloalkyl substituted by C₁-C₆alkoxy or by C₁-C₆alkyl; 3-oxetanyl or 3-oxetanyl substituted by C₁-C₆alkyl;
or, when Q is Q₂ or Q₃, or when Q is Q₁ wherein R₁₄ and R₂₂ denote a C₂-C₃alkylene chain, R₂ may additionally be a five- to ten-membered, monocyclic or fused bicyclic ring system, which may be aromatic, saturated or partially saturated and which may contain from 1 to 4 hetero atoms selected from nitrogen, oxygen and sulfur, the ring system being bonded to the substituent X₁ directly or via a C₁-C₄alkylene, C₂-C₄alkenyl-C₁-C₄alkylene, C₂-C₄alkynyl-C₁-C₄alkylene, —N(R₁₂)—C₁-C₄alkylene, —SO—C₁-C₄alkylene or —SO₂—C₁-C₄alkylene group, and wherein each ring system may contain no more than two oxygen atoms and no more than two sulfur atoms and the ring system may itself be mono-, di- or tri-substituted by C₁-C₆alkyl, C₁-C₆haloalkyl, C₂-C₆alkenyl, C₂-C₆haloalkenyl, C₂-C₆alkynyl, C₂-C₆haloalkynyl, C₁-C₆alkoxy, hydroxy, C₁-C₆haloalkoxy, C₃-C₆alkenyloxy, C₃-C₆alkynyloxy, mercapto, C₁-C₆alkylthio, C₁-C₆haloalkylthio, C₃-C₆alkenylthio, C₃-C₆haloalkenylthio, C₃-C₆alkynylthio, C₂-C₅alkoxyalkylthio, C₃-C₅acetylalkylthio, C₃-C₆alkoxycarbonylalkylthio, C₂-C₄cyanoalkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₂alkylaminosulfonyl, di(C₁-C₂alkyl)aminosulfonyl, di(C₁-C₄alkyl)amino, halogen, cyano, nitro, phenyl or by benzylthio, wherein phenyl and benzylthio may in turn be substituted on the phenyl ring by C₁-C₃alkyl, C₁-C₃haloalkyl, C₁-C₃alkoxy, C₁-C₃haloalkoxy, halogen, cyano or by nitro, and wherein the substituents on the nitrogen in the heterocyclic ring are other than halogen; or
R₂ is hydrogen or unsubstituted C₁-C₈alkyl, when either
a) R₁ is substituted by the group R₅, or
b) Q is the group Q₂, or
c) Q is the group Q₃ when X₁ is —O(CO)—, —(CO)O—, —N(R₆)—O—, —O—NR₅₁—, —SO₂NR₇—, —NR₅₂SO₂— or —NR₈—; or
d) Q is the group Q₁ when X₁ is —N(R₆)—O—, —O—NR₅₁—, —SO₂NR₇—, —NR₅₂SO₂— or —NR₈—, or
e) Q is the group Q₁ wherein R₁₄ and R₂₂ in Q₁ denote a C₂-C₃alkylene chain and X₁ is —O(CO)— or —(CO)O—;
R₃ is C₁-C₃haloalkyl;
R₄ is hydrogen, halogen, C₁-C₃alkyl, C₁-C₃haloalkyl, C₁-C₃alkoxy, C₁-C₃alkoxy-C₁-C₃alkyl or C₁-C₃alkoxy-C₁-C₃alkoxy;
R₅ is hydroxy, C₁-C₆alkoxy, C₃-C₆cycloalkyloxy, C₁-C₆alkoxy-C₁-C₆alkoxy, C₁-C₆alkoxy-C₁-C₆alkoxy-C₁-C₆alkoxy or C₁-C₂alkylsulfonyloxy;
R₆, R₇, R₈, R₉, R₁₀, R₁₁, R₁₂, R₅₁ and R₅₂ are each independently of the others hydrogen, C₁-C₆alkyl, C₁-C₆haloalkyl, C₁-C₆alkoxycarbonyl, C₁-C₆alkylcarbonyl, C₁-C₆alkoxy-C₁-C₆alkyl, C₁-C₆alkoxy-C₁-C₆alkyl substituted by C₁-C₆alkoxy, benzyl, or phenyl, wherein phenyl and benzyl may in turn be substituted one or more times by C₁-C₆alkyl, C₁-C₆haloalkyl, C₁-C₆-alkoxy, C₁-C₆haloalkoxy, halogen, cyano, hydroxy or by nitro; wherein R₆ is not hydrogen when R₉ is hydrogen, C₁-C₆alkoxycarbonyl or C₁-C₆alkylcarbonyl;
Q is Q₁ 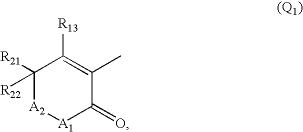
wherein
A₁ is C(R₁₄R₁₅), NR₁₆ or oxygen;
A₂ is C(R₁₇R₁₈), C(O), —C═N—O—R₁₉, oxygen, thio, sulfinyl, sulfonyl, —NR₂₀ or ethylene; with the provisos that A₁ is other than oxygen when A₂ is oxygen, C(O), thio, sulfinyl, —C═N—O—R₁₉, NR₂₀ or C(R₁₇R₁₈), R₁₇ and R₁₈ being each independently of the other C₁-C₄alkoxy, C₁-C₄-alkylthio, C₁-C₄alkylsulfinyl or C₁-C₄alkylsulfonyl; and that Al is other than NR₁₆ when A₂ is thio, sulfinyl or C(R₁₇R₁₈), R₁₇ and R₁₈ being each independently of the other C₁-C₄alkoxy, C₁-C₄alkylthio, C₁-C₄alkylsulfinyl or C₁-C₄alkylsulfonyl;
R₁₄ and R₂₂ are each independently of the other hydrogen, C₁-C₄alkyl, C₁-C₄haloalkyl, C₃-C₄-alkenyl, C₃-C₄alkynyl, C₁-C₄alkylthio, C₁-C₄alkylsulfinyl, C₁-C₄alkylsulfonyl, C₁-C₄alkylsulfonyl-oxy, C₁-C₄alkoxy, C₁-C₄alkoxycarbonyl or C₁-C₄alkylcarbonyl;
R₁₅ and R₂₁ are each independently of the other hydrogen, C₁-C₄alkyl, C₁-C₄haloalkyl, C₃-C₄-alkenyl or C₃-C₄alkynyl;
R₁₇ is hydrogen, C₁-C₄alkyl, C₁-C₄haloalkyl, C₁-C₄alkoxy, C₁-C₄alkylthio, C₁-C₄alkylsulfinyl or C₁-C₄alkylsulfonyl;
R₁₈ is hydrogen, C₁-C₄alkyl, C₁-C₄haloalkyl, C₃-C₄alkenyl, C₃-C₄alkynyl, C₁-C₄alkoxy, C₁-C₄-alkylthio, C₁-C₄alkylsulfinyl, C₁-C₄alkylsulfonyl or di(C₁-C₄)alkoxyalkyl-C₁-C₄alkyl;
R₂₀ is C₁-C₄alkyl, C₃-C₆cycloalkyl, C₃-C₄alkenyl, C₃-C₄alkynyl, C₁-C₄alkylcarbonyl, C₁-C₄alkyl-carbonyloxy, di(C₁-C₄)alkylaminocarbonyl or benzyl, wherein the phenyl group may be substituted one or more times by C₁-C₆alkyl, C₁-C₆haloalkyl, C₁-C₆alkoxy, C₁-C₆haloalkoxy, halogen, cyano, hydroxy or by nitro;
R₁₉ and R₁₆ are each independently of the other hydrogen, C₁-C₄alkyl, C₃-C₆cycloalkyl, C₃-C₄alkenyl, C₃-C₄alkynyl, benzyl or phenyl, wherein phenyl and benzyl may in turn be substituted one or more times by C₁-C₆alkyl, C₁-C₆haloalkyl, C₁-C₆alkoxy, C₁-C₆haloalkoxy, halogen, cyano, hydroxy or by nitro;
or R₁₄ and R₂₂ together form a C₂-C₃alkylene chain;
or R₁₄ and R₁₅ together and/or R₁₇ and R₁₈ together and/or R₂₁ and R₂₂ together form a C₂-C₄alkylene chain, which may be interrupted by oxygen and/or by carbonyl and/or by sulfur, with the proviso that the oxygen and sulfur atoms are separated by at least one methylene group;
or R₁₄ and R₁₈ together form a C₂-C₄alkylene chain; or
R₂₂ and R₁₈ together form a C₂-C₄alkylene chain;
or R₁₈ forms, together with R₂₂ or R₁₄, a direct bond;
or R₁₆ and R₁₈ together form a C₂-C₄alkylene chain;
R₁₃ is hydroxy; O⁻M⁺ wherein M⁺ is an alkali metal cation or an ammonium cation; halogen, C₁-C₁₂alkylsulfonyloxy, amino, C₁-C₄alkylthio, C₁-C₁₂alkylsulfinyl, C₁-C₁₂alkylsulfonyl, C₁-C₁₂-haloalkylthio, C₁-C₁₂haloalkylsulfinyl, C₁-C₁₂haloalkylsulfonyl, C₁-C₆alkoxy-C₁-C₆alkylthio, C₁-C₆alkoxy-C₁-C₆alkylsulfinyl, C₁-C₆alkoxy-C₁-C₆alkylsulfonyl, C₃-C₁₂alkenylthio, C₃-C₁₂-alkenylsulfinyl, C₃-C₁₂alkenylsulfonyl, C₃-C₁₂alkynylthio, C₃-C₁₂alkynylsulfinyl, C₃-C₁₂alkynyl-sulfonyl, C₁-C₄alkoxycarbonyl-C₁-C₄alkylthio, C₁-C₄alkoxycarbonyl-C₁-C₄alkylsulfinyl, C₁-C₄-alkoxycarbonyl-C₁-C₄alkylsulfonyl, (C₁-C₄alkoxy)₂P(O)O, C₁-C₄alkyl-(C₁-C₄alkoxy)P(O)O, H(C₁-C₄alkoxy)P(O)O, R₂₃R₂₄N, R₂₅R₂₆NNH, R₂₇R₂₈NC(O)O—, R₂₉R₃₀NC(O)NH—, C₁-C₁₈alkyl-carbonyloxy, C₂-C₁₈alkenylcarbonyloxy, C₂-C₁₈alkynylcarbonyloxy, C₃-C₆cycloalkylcarbonyl-oxy, C₁-C₁₂alkoxycarbonyloxy, C₁-C₁₂alkylthiocarbonyloxy or C₁-C₁₂alkylthiocarbamoyl, wherein the alkyl, alkenyl and alkynyl groups may be substituted by halogen, C₁-C₆alkoxy, C₁-C₆alkylthio, C₁-C₆alkylsulfinyl, C₁-C₆alkylsulfonyl or by cyano;
or R₁₃ is phenoxy, phenylthio, phenylsulfinyl, phenylsulfonyl, phenylsulfonylamino, phenyl-sulfonyloxy or benzoyloxy, wherein the phenyl groups may in turn be substituted by one or more halogen, nitro, cyano, C₁-C₄alkyl, C₁-C₄haloalkyl, C₁-C₄alkoxy or C₁-C₄haloalkoxy groups;
or R₁₃ is a group Het₁-thio, Het₂-sulfinyl, Het₃-sulfonyl, Het₄-(CO)O or Het₅-N(R₃₃); wherein Het₁, Het₂, Het₃, Het₄ and Het₅ are each independently of the others a five- to ten-membered, monocyclic or fused bicyclic ring system, which may be aromatic or partially saturated and which may contain from 1 to 4 hetero atoms selected from nitrogen, oxygen and sulfur and wherein each ring system may contain no more than two oxygen atoms and no more than two sulfur atoms and the ring system may itself be substituted by C₁-C₆alkyl, C₁-C₆haloalkyl, C₁-C₆alkoxy, C₁-C₆haloalkoxy, C₁-C₆alkylthio, C₁-C₆alkylsulfinyl, C₁-C₆alkylsulfonyl, di(C₁-C₄alkyl)aminosulfonyl, di(C₁-C₄alkyl)amino, halogen, cyano, nitro or by phenyl, and wherein the substituents on the nitrogen in the heterocyclic ring are other than halogen;
R₂₃, R₂₄, R₂₅, R₂₆, R₂₇, R₂₈, R₂₉, R₃₀ and R₃₃ are each independently of the others hydrogen or C₁-C₆alkyl;
or R₂₃ and R₂₄ together or R₂₅ and R₂₆ together or R₂₇ and R₂₈ together or R₂₉ and R₃₀ together are pyrrolidino, piperidino, morpholino or thiomorpholino, each of which may be mono- or poly-substituted by methyl groups;
or Q is Q₂ 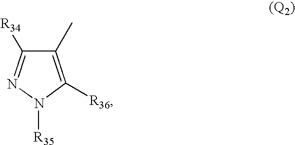
wherein
R₃₄ is hydrogen, C₁-C₄alkyl, C₁-C₄haloalkyl, C₃-C₆cycloalkyl, C₂-C₄alkenyl, C₂-C₄alkynyl or benzyl, wherein the phenyl group may be substituted one or more times by C₁-C₆alkyl, C₁-C₆haloalkyl, C₁-C₆alkoxy, C₁-C₆haloalkoxy, halogen, cyano, hydroxy or by nitro;
R₃₅ is hydrogen, C₁-C₄alkyl, C₁-C₄haloalkyl, C₃-C₆cycloalkyl, C₃-C₄alkenyl, C₃-C₄alkynyl or benzyl, wherein the phenyl group may be substituted one or more times by C₁-C₆alkyl, C₁-C₆haloalkyl, C₁-C₆alkoxy, C₁-C₆haloalkoxy, halogen, cyano, hydroxy or by nitro;
R₃₆ is hydroxy; O⁻M⁺ wherein M⁺ is an alkali metal cation or an ammonium cation; halogen, C₁-C₁₂alkylsulfonyloxy, amino, C₁-C₄alkylthio, C₁-C₁₂alkylsulfinyl, C₁-C₁₂alkylsulfonyl, C₁-C₁₂haloalkylthio, C₁-C₁₂haloalkylsulfinyl, C₁-C₁₂haloalkylsulfonyl, C₁-C₆alkoxy-C₁-C₆alkyl-thio, C₁-C₆alkoxy-C₁-C₆alkylsulfinyl, C₁-C₆alkoxy-C₁-C₆alkylsulfonyl, C₃-C₁₂alkenylthio, C₃-C₁₂alkenylsulfinyl, C₃-C₁₂alkenylsulfonyl, C₃-C₁₂alkynylthio, C₃-C₁₂alkynylsulfinyl, C₃-C₁₂alkynylsulfonyl, C₁-C₄alkoxycarbonyl-C₁-C₄alkylthio, C₁-C₄alkoxycarbonyl-C₁-C₄alkyl-sulfinyl, C₁-C₄alkoxycarbonyl-C₁-C₄alkylsulfonyl, (C₁-C₄alkoxy)₂P(O)O, C₁-C₄alkyl-(C₁-C₄alkoxy)P(O)O, H(C₁-C₄alkoxy)P(O)O, R₃₇R₃₈N, R₃₉R₄₀NNH, R₄₁R₄₂NC(O)O—, R₄₃R₄₄NC(O)NH—, C₁-C₁₈alkylcarbonyloxy, C₂-C₁₈alkenylcarbonyloxy, C₂-C₁₈alkynylcarbonyl-oxy, C₃-C₆cycloalkylcarbonyloxy, C₁-C₁₂alkoxycarbonyloxy, C₁-C₁₂alkylthiocarbonyloxy or C₁-C₁₂alkylthiocarbamoyl, wherein the alkyl, alkenyl and alkynyl groups may be substituted by halogen, C₁-C₆alkoxy, C₁-C₆alkylthio, C₁-C₆alkylsulfinyl, C₁-C₆alkylsulfonyl or by cyano; or
R₃₆ is phenoxy, phenylthio, phenylsulfinyl, phenylsulfonyl, phenylsulfonylamino, phenyl-sulfonyloxy or benzoyloxy, wherein the phenyl groups may in turn be substituted one or more times by halogen, nitro, cyano, C₁-C₄alkyl, C₁-C₄haloalkyl, C₁-C₄alkoxy or by C₁-C₄halo-alkoxy,
or R₃₆ is a group Het₇-thio, Het₈-sulfinyl, Het₉-sulfonyl, Het₁₀-(CO)O or Het₁₁—N(R₄₇); wherein Het₇, Het₈, Het₉, Het₁₀ and Het₁₁ are each independently of the others a five- to ten-membered, monocyclic or fused bicyclic ring system, which may be aromatic or partially saturated and which may contain from 1 to 4 hetero atoms selected from nitrogen, oxygen and sulfur and wherein each ring system may contain no more than two oxygen atoms and no more than two sulfur atoms and the ring system may itself be substituted by C₁-C₆alkyl, C₁-C₆haloalkyl, C₁-C₆alkoxy, C₁-C₆haloalkoxy, C₁-C₆alkylthio, C₁-C₆alkylsulfinyl, C₁-C₆alkyl-sulfonyl, di(C₁-C₄alkyl)aminosulfonyl, di(C₁-C₄alkyl)amino, halogen, cyano, nitro or by phenyl, and wherein the substituents on the nitrogen in the heterocyclic ring are other than halogen;
R₃₇, R₃₈, R₃₉, R₄₀, R₄₁, R₄₂, R₄₃, R₄₄ and R₄₇ are each independently of the others hydrogen or C₁-C₆alkyl; or
R₃₇ and R₃₈ together or R₃₉ and R₄₀ together or R₄₁ and R₄₂ together or R₄₃ and R₄₄ together are pyrrolidino, piperidino, morpholino or thiomorpholino, each of which may be mono- or poly-substituted by methyl groups;
or Q is Q₃ 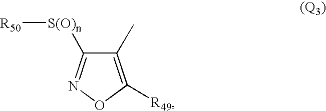
wherein
R₄₉ is C₁-C₄alkyl, C₁-C₄haloalkyl, C₃-C₆cycloalkyl or halo-substituted C₃-C₆cycloalkyl;
R₅₀ is C₁-C₃alkylene, which may be substituted by halogen, hydroxy, C₁-C₆alkoxy, C₂-C₈-alkenyl, C₂-C₆alkynyl, C₃-C₆cycloalkyl, C₁-C₆alkoxy-C₁-C₆alkoxy, C₁-C₆alkoxy-C₁-C₆alkoxy-C₁-C₆alkoxy, (3-oxetanyl)-oxy, or by (3-oxetanyl)-oxy substituted by C₁-C₆alkyl, or by benzylthio, benzylsulfinyl, benzylsulfonyl, phenyl, phenoxy, phenylthio, phenylsulfinyl or by phenylsulfonyl, wherein the phenyl- and benzyl-containing groups may in turn be substituted by one or more C₁-C₆alkyl, C₁-C₆haloalkyl, C₁-C₆alkoxy, C₁-C₆haloalkoxy, halogen, cyano, hydroxy or nitro groups;
or R₅₀ is phenyl, wherein the phenyl-containing group may in turn be substituted by one or more C₁-C₆alkyl, C₁-C₆haloalkyl, C₁-C₆alkoxy, C₁-C₆haloalkoxy, halogen, cyano, hydroxy or nitro substituents,
or R₅₀ is C₃-C₆cycloalkyl, C₃-C₆cycloalkyl substituted by C₁-C₆alkoxy or by C₁-C₆alkyl, 3-oxetanyl or 3-oxetanyl substituted by C₁-C₆alkyl; and
n is 0, 1 or 2; or an agronomically acceptable salt/N-oxide/isomer/enantiomer of such a compound except for the compound 4-hydroxy-3-[2-(2-methoxyethoxyethoxymethyl)-6-trifluoromethylpyridine-3-carbonyl]-bicyclo[3.2.1]oct-3-en-2-one, and with the provisos that —R₁—X₁—R₂ is other than C₁-C₄alkoxy-C₁-C₄alkoxy-C₁-C₄alkyl when
a) Q is Q₁ wherein A₁ is C(R₁₄R₁₅) and A₂ is C(R₁₇R₁₈), R₁₅, R₁₇ and R₁₈ are hydrogen and R₁₄ and R₂₂ together form a C₂-C₃alkylene chain; and when
b) Q is Q₁, R₁₄ and R₂₂ do not together form a C₂-C₃alkylene chain, A₁ is C(R₁₄R₁₅), or A₁ is NR₁₆ and A₂ is oxygen; and when
c) Q is Q₃,
and
b) a synergistically effective amount of one or more compounds selected from a compound of formula 2.1 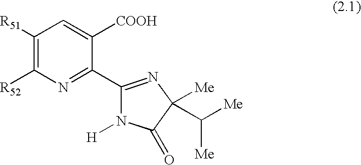
wherein R₅₁ is CH₂—OMe, ethyl or hydrogen;
R₅₂ is hydrogen, or R₅₁ and R₅₂ together are the group —CH═CH—CH═CH—;
and a compound of formula 2.2 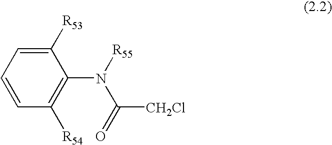
wherein R₅₃ is ethyl, R₅₄ is methyl or ethyl, and R₅₅ is —CH(Me)—CH₂OMe, <S>—CH(Me)—CH₂OMe, CH₂OMe or CH₂O—CH₂CH₃;
and a compound of formula 2.3 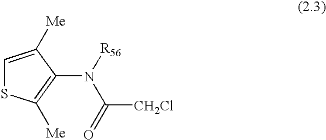
wherein R₅₆ is CH(Me)—CH₂OMe or <S>CH(Me)—CH₂OMe;
and a compound of formula 2.4 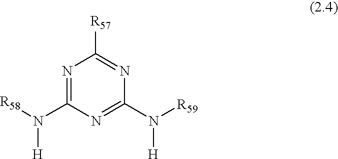
wherein R₅₇ is chlorine, methoxy or methylthio, R₅₈ is ethyl or isopropyl, and R₅₉ is ethyl, isopropyl, —C(CN)(CH₃)—CH₃ or tert-butyl;
and a compound of formula 2.5 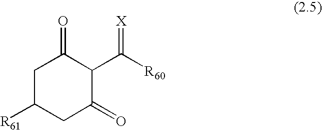
wherein R₆₀ is ethyl or n-propyl, R₆₁ is COO⁻½ Ca⁺⁺, —CH₂—CH(Me)S—CH₂CH₃, the group 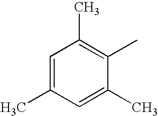
or the group 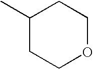
and X is oxygen, N—O—CH₂CH₃ or N—O—CH₂CH═CH—Cl;
and a compound of formula 2.6 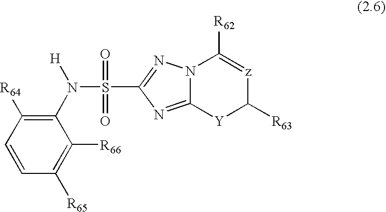
wherein R₆₂ is hydrogen, methoxy or ethoxy, R₆₃ is hydrogen, methyl, methoxy or fluorine, R₆₄ is COOMe, fluorine or chlorine, R₆₅ is hydrogen or methyl, Y is methine, C—F or nitrogen, Z is methine or nitrogen, and R₆₆ is fluorine or chlorine;
and a compound of formula 2.7 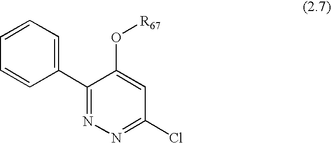
wherein R₆₇ is hydrogen or —C(O)—S-n-octyl;
and a compound of formula 2.8 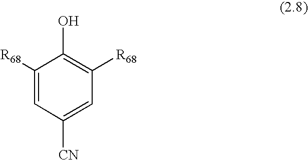
wherein R₆₈ is either bromine or iodine;
and a compound of formula 2.9 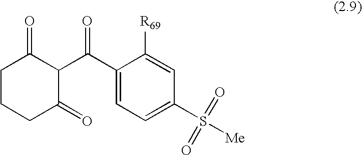
wherein R₆₉ is chlorine or nitro;
and a compound of formula 2.10 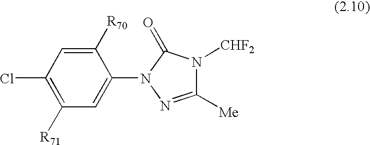
wherein R₇₀ is fluorine or chlorine, and R₇₁ is —CH₂—CH(Cl)—COOCH₂CH₃ or —NH—SO₂Me;
and a compound of formula 2.11 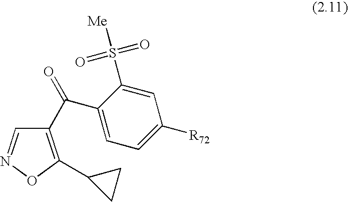
wherein R₇₂ is trifluoromethyl or chlorine;
and a compound of formula 2.12 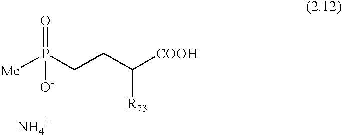
wherein R₇₃ is NH₂ or <S>NH₂;
and a compound of formula 2.13 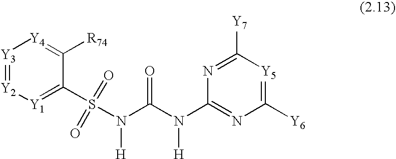
wherein Y₂ is nitrogen, methine, C—NH—CHO, C—CH₂—NH—SO₂CH₃ or N-Me, Y₁ is nitrogen, methine, C—Cl or C—I, Y₃ is methine, Y₄ is methine or Y₃ and Y₄ together are sulfur or C—Cl, Y₅ is nitrogen or methine, Y₆ is methyl, difluoromethoxy, trifluoromethyl or methoxy, Y₇ is methoxy or difluoromethoxy and R₇₄ is CONMe₂, COOMe, COOC₂H₅, trifluoromethyl, CH₂—CH₂CF₃, O—CH₂—CH₂Cl or SO₂CH₂CH₃, or a sodium salt thereof;
and the compound of formula 2.13.c 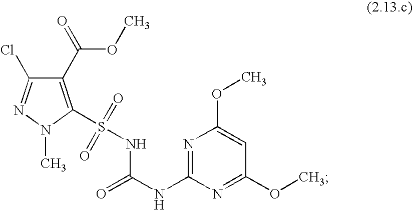
and the compound of formula 2.14 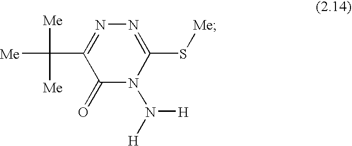
and the compound of formula 2.15 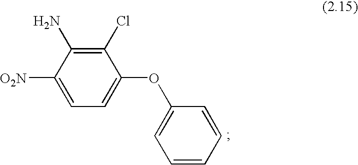
and the compound of formula 2.16 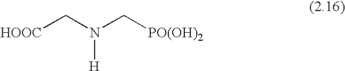
and ammonium, isopropylammonium, sodium and trimesium salts thereof;
and the compound of formula 2.17 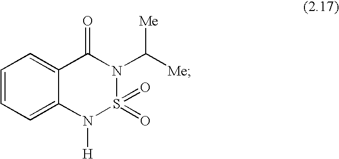
and the compound of formula 2.18 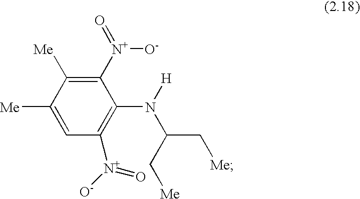
and the compound of formula 2.19 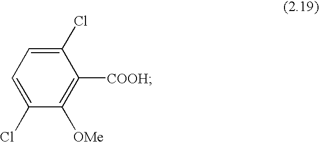
and the compound of formula 2.20 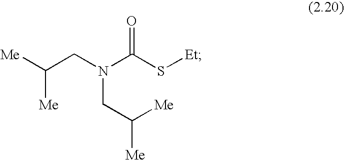
and the compound of formula 2.21 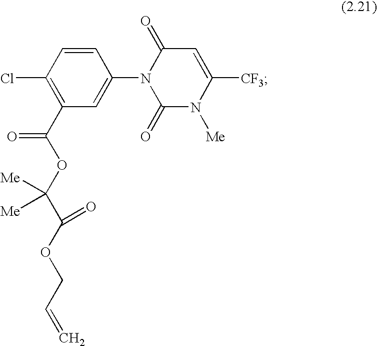
and the compound of formula 2.22 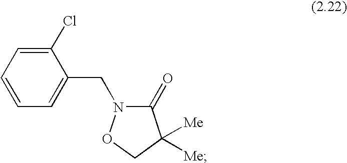
and the compound of formula 2.23 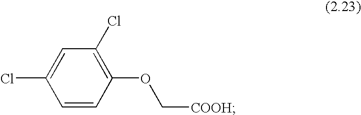
and the compound of formula 2.24 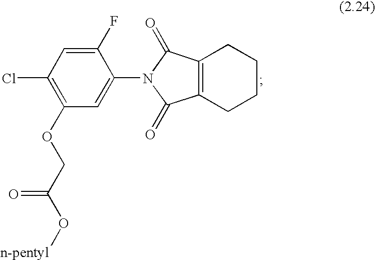
and the compound of formula 2.25 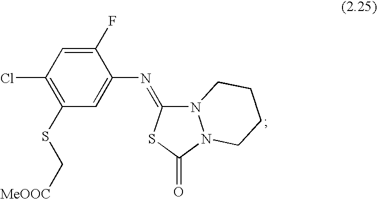
and the compound of formula 2.26 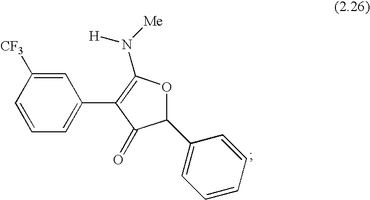
and the compound of formula 2.27 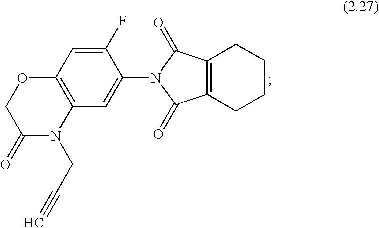
and the compound of formula 2.28 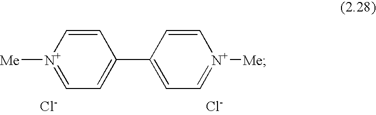
the compound of formula 2.29 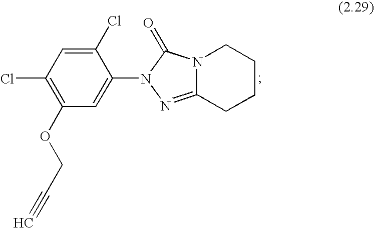
and the compound of formula 2.30 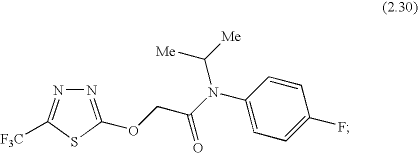
and the compound of formula 2.31 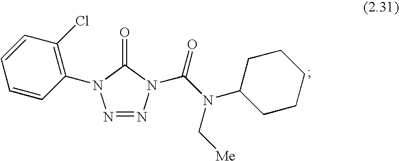
and the compound of formula 2.32 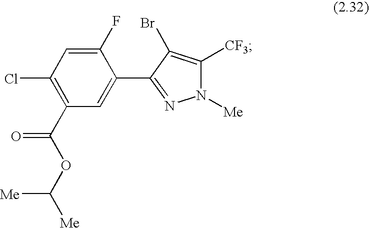
and the compound of formula 2.33 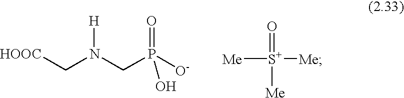
and the compound of formula 2.34 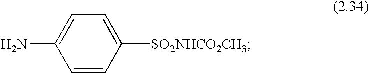
and the compound of formula 2.35 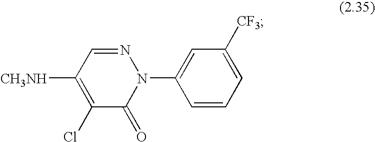
and the compound of formula 2.36 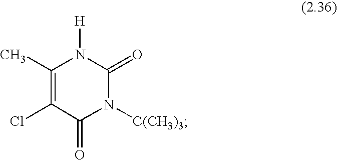
and the compound of formula 2.37 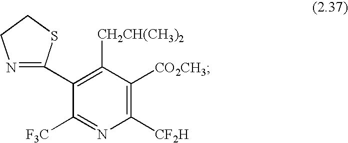
and the compound of formula 2.38 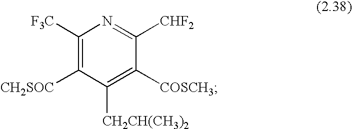
and the compound of formula 2.39 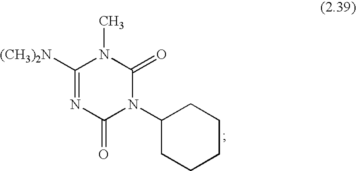
and the compound of formula 2.40 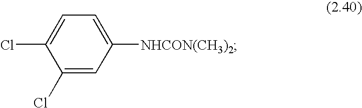
and the compound of formula 2.41 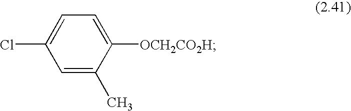
and the compound of formula 2.42 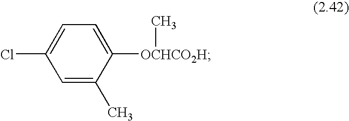
and the compound of formula 2.43 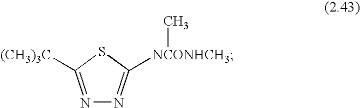
and the compound of formula 2.44 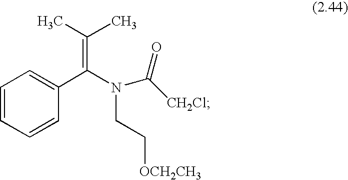
and the compound of formula 2.45 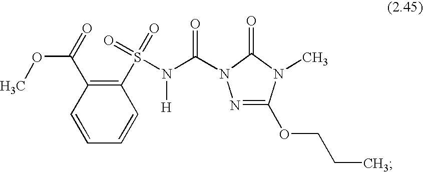
and the compound of formula 2.46 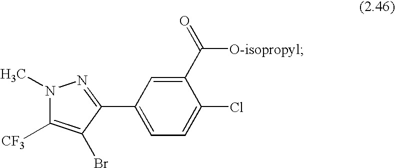
and the compound of formula 2.47 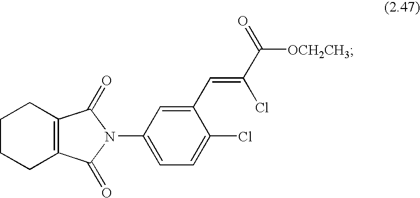
and the compound of formula 2.48 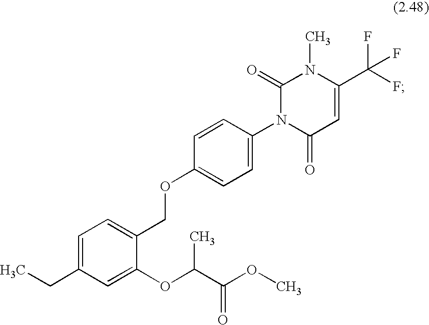
and the compound of formula 2.49 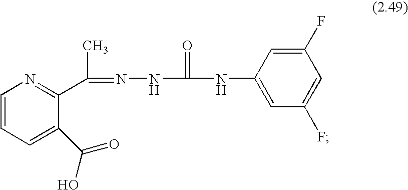
and the compound of formula 2.50 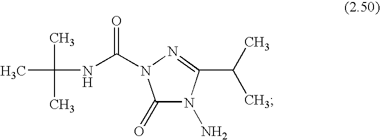
and the compound of formula 2.51 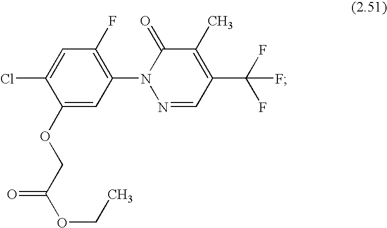
and a compound of formula 2.52 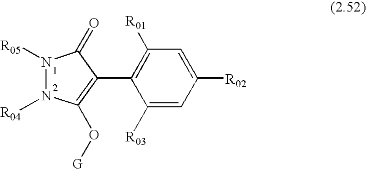
wherein
R₀₁, R₀₂ and R₀₃ are each independently of the others halogen, nitro, cyano, C₁-C₄alkyl, C₂-C₄alkenyl, C₂-C₄alkynyl, C₁-C₄haloalkyl, C₂-C₆haloalkenyl, C₃-C₆cycloalkyl, halo-substituted C₃-C₆cycloalkyl, C₁-C₆alkoxyalkyl, C₁-C₆alkylthioalkyl, hydroxy, mercapto, C₁-C₆alkoxy, C₃-C₆alkenyloxy, C₃-C₆alkynyloxy, C₁-C₄alkylcarbonyl, C₁-C₄alkoxycarbonyl, C₁-C₄alkylthio, C₁-C₄alkylsulfinyl, C₁-C₄alkylsulfonyl, amino, C₁-C₄alkylamino or di(C₁-C₄alkyl)amino;
R₀₄ and R₀₅ together are a group
—C—R₀₆(R₀₇)—O—C—R₀₈(R₀₉)—C—R₀₁₀(R₀₁₁)—C—R₀₁₂(R₀₁₃)— (Z₁),
—C—R₀₁₄(R₀₁₅)—C—R₀₁₆(R₀₁₇)—O—C—R₀₁₈(R₀₁₉)—C—R₀₂₀(R₀₂₁)— (Z₂) or
—C—R₀₂₂(R₀₂₃)—C—R₀₂₄(R₀₂₅)—C—R₀₂₆(R₀₂₇)—O—C—R₀₂₈(R₀₂₉)— (Z₃),
wherein R₀₆, R₀₇, R₀₈, R₀₉, R₀₁₀, R₀₁₁, R₀₁₂, R₀₁₃, R₀₁₄, R₀₁₅, R₀₁₆, R₀₁₇, R₀₁₈, R₀₁₉, R₀₂₀, R₀₂₁, R₀₂₂, R₀₂₃, R₀₂₄, R₀₂₅, R₀₂₆, R₀₂₇, R₀₂₈ and R₀₂₉ are, each independently of the others, hydrogen, halogen, C₁-C₄alkyl or C₁-C₄haloalkyl, it being possible for an alkylene ring, which together with the carbon atoms of the group Z₁, Z₂ or Z₃ contains from 2 to 6 carbon atoms and which may be interrupted by oxygen, to be either fused or spiro-bound to the carbon atoms of the group Z₁, Z₂ or Z₃ or that alkylene ring bridges at least one ring atom of the group Z₁, Z₂ or Z₃;
G is hydrogen, —C(X₁)—R₀₃₀, —C(X₂)—X₃—R₀₃₁, —C(X₄)—N(R₀₃₂)—R₀₃₃, —SO₂—R₀₃₄, an alkali metal cation, alkaline earth metal cation, sulfonium cation or ammonium cation or —P(X₅)(R₀₃₅)—R₀₃₆;
X₁, X₂, X₃, X₄ and X₅ are each independently of the others oxygen or sulfur; and
R₀₃₀, R₀₃₁, R₀₃₂, R₀₃₃, R₀₃₄, R₀₃₅ and R₀₃₆ are each independently of the others hydrogen, C₁-C₅alkyl, C₁-C₅haloalkyl, C₂-C₅alkenyl, C₁-C₅alkoxyalkyl, C₃-C₆cycloalkyl or phenyl, and R₀₃₄ may additionally be C₂-C₂₀alkenyl; C₂-C₂₀alkenyl substituted by halogen, C₁-C₆alkylcarbonyl, C₁-C₆alkoxycarbonyl, C₁-C₆alkylcarbonyloxy, C₁-C₆alkoxy, C₁-C₆thioalkyl, C₁-C₆alkylthiocarbonyl, C₁-C₆alkylcarbonylthio, C₁-C₆alkylsulfonyl, C₁-C₆alkylsulfoxyl, C₁-C₆alkylaminosulfonyl, C₁-C₆(di)alkylaminosulfonyl, C₁-C₆C₁-C₆alkylsulfonyloxy, C₁-C₆alkyl-sulfonylamino, C₁-C₆alkylamino, C₁-C₆(di)alkylamino, C₁-C₆alkylcarbonylamino, di-C₁-C₆ alkylcarbonylamino, C₁-C₆alkylalkylcarbonylamino, cyano, (C₃-C₇)cycloalkyl, (C₃-C₇)heterocyclyl, tri-C₁-C₆alkylsilyl, tri-C₁-C₆alkylsilyloxy, phenyl or heteroaryl; or R₀₃₄ is C₂-C₂₀alkynyl; C₂-C₂₀alkynyl substituted by halogen, C₁-C₆alkylcarbonyl, C₁-C₆ alkoxycarbonyl, C₁-C₆alkylcarbonyloxy, C₁-C₆alkoxy, C₁-C₆thioalkyl, C₁-C₆alkylthiocarbonyl, C₁-C₆alkylcarbonylthio, C₁-C₆alkylsulfonyl, C₁-C₆alkylsulfoxyl, C₁-C₆alkylaminosulfonyl, di-C₁-C₆ alkylaminosulfonyl, C₁-C₆alkylsulfonyloxy, C₁-C₆alkylsulfonylamino, C₁-C₆alkylamino, di-C₁-C₆alkylamino, C₁-C₆alkylcarbonylamino, di-C₁-C₆alkylcarbonylamino, C₁-C₆alkylcarbonylamino, cyano, (C₃-C₇)cycloalkyl, (C₃-C₇)heterocyclyl, tri-C₁-C₆alkylsilyl, tri-C₁-C₆alkylsilyloxy, phenyl or heteroaryl; or R₀₃₄ is (C₁-C₇)cycloalkyl; (C₁-C₇)cycloalkyl substituted by halogen, haloalkyl, C₁-C₆alkyl, C₁-C₆alkoxy, C₁-C₆alkylcarbonyloxy, C₁-C₆thioalkyl, C₁-C₆alkylcarbonylthio, C₁-C₆alkylamino, C₁-C₆alkylcarbonylamino, tri-C₁-C₆alkylsilyl or by tri-C₁-C₆alkylsilyloxy; or R₀₃₄ is heteroaryl; heteroaryl substituted by halogen, C₁-C₆haloalkyl, nitro, cyano, C₁-C₆alkyl, C₁-C₆alkoxy, C₁-C₆alkylcarbonyloxy, C₁-C₆thioalkyl, C₁-C₆alkylcarbonylthio, C₁-C₆alkylamino, C₁-C₆alkylcarbonylamino, tri-C₁-C₆alkylsilyl or by tri-C₁-C₆alkylsilyloxy; heteroaryloxy, heteroarylthio, heteroarylamino, di-heteroarylamino, phenylamino, diphenylamino, C₂-C₆cycloalkylamino, di-C₂-C₆cycloalkylamino or C₂-C₆cycloalkoxy and salts and diastereoisomers of compounds of formula 2.52;
and the compound of formula 2.53 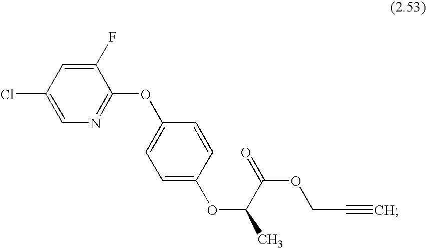
and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin.

2. A method of controlling undesired plant growth in crops of useful plants, which comprises allowing a herbicidally effective amount of a composition according to claim 1 to act on the crop plant or the area of cultivation thereof.

3. A method according to claim 2, wherein the crop plant is maize or a cereal.

4. A method according to claim 2, wherein the crop of useful plants is treated with the said composition at a rate of application corresponding to a total amount of active ingredient of from 1 to 5000 g per hectare.

5. A selectively herbicidal composition that, in addition to comprising customary inert formulation adjuvants, such as carriers, solvents and wetting agents, comprises as active ingredient a mixture of
a) an amount, effective for herbicide synergism, of the compound of formula I according to claim 1 and one or more compounds selected from the compounds of formulae 2.1 to 2.53 and the compounds prosulfocarb, picolinafen, pyraflufen-ethyl, beflubutamid, fenoxaprop-P-ethyl, diclofop-methyl, amidosulfuron, flupyrsulfuron, flupyrsulfuron-methyl-sodium, metsulfuron-methyl, sulfosulfuron, tribenuron-methyl, imazamethabenz-methyl, flucarbazone, chlorotoluron, isoproturon, methabenzthiazuron, bifenox, fluoroglycofen-ethyl, imazosulfuron, diflufenican, bilanafos, ethalfluralin, trifluralin, fluthiamide, isoxaben, triallate, 2,4-DB, dichlorprop, MCPA, MCPB, mecoprop, MCPP, mecoprop-P, clopyralid, fluroxypyr, quinmerac, benazolin-ethyl, difenzoquat, cyhalofop-butyl, dithiopyr, quinclorac, prodiamine, benefin and trifluralin according to claim 1 and
b) an amount, effective for herbicide antagonism, of a compound selected from the compound of formula 3.1 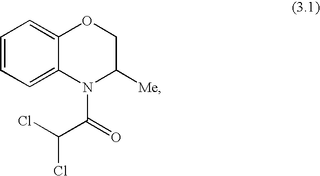
and the compound of formula 3.2 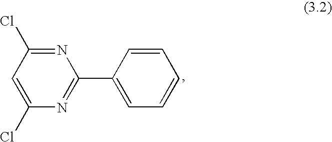
and the compound of formula 3.3 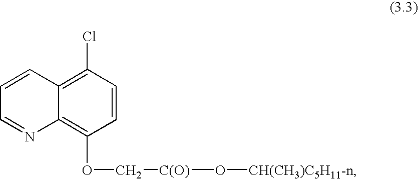
the free acid thereof or a hydrate or salt thereof,
and the compound of formula 3.4 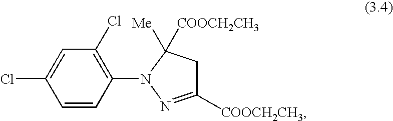
and the compound of formula 3.5 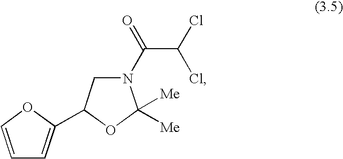
and the compound of formula 3.6 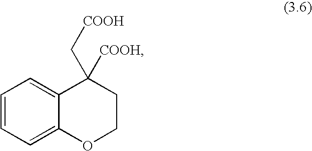
and the compound of formula 3.7 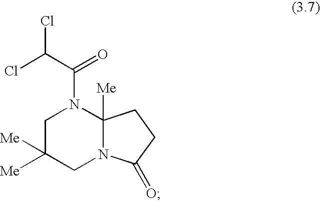
and the compound of formula 3.8 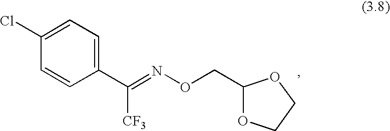
and of formula 3.9
Cl₂CHCON(CH₂CH═CH₂)₂ (3.9),
and of formula 3.10 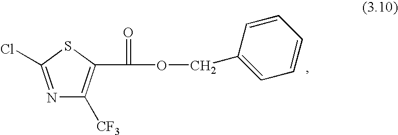
and of formula 3.11 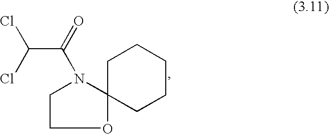
and of formula 3.12 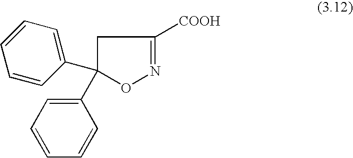
or a methyl or ethyl ester thereof or a salt thereof, and of formula 3.13 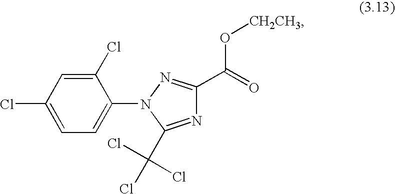
and of formula 3.14 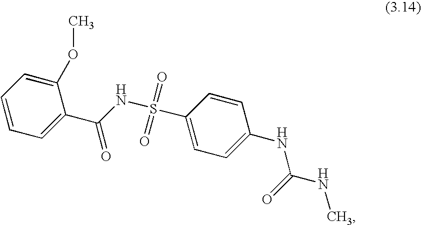
and of formula 3.15 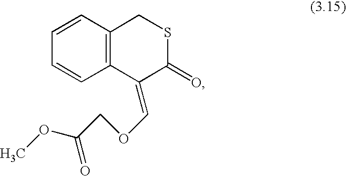
and of formula 3.16 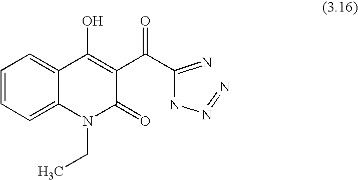
and of formula 3.17

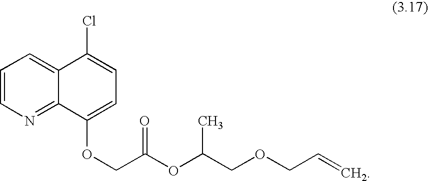

6. A method for the selective control of weeds and grasses in crops of useful plants, which comprises treating the useful plants, seeds or cuttings thereof, or the area of cultivation thereof, with an amount, effective for herbicide synergism, of a composition according to claim 5.

7. A method according to claim 6, wherein the rate of application of herbicide is from 1 to 5000 g/ha and the rate of application of safener is from 0.001 to 0.5 kg/ha.

8. A method according to claim 6, wherein the crop of useful plants is maize or a cereal.

9. A selectively herbicidal composition that, in addition to comprising customary inert formulation adjuvants, such as carriers, solvents and wetting agents, comprises as active ingredient a mixture of
a) a herbicidally effective amount of a compound of formula I according to claim 1 and
b) an amount, effective for herbicide antagonism, of a compound selected from the compound of formula 3.1 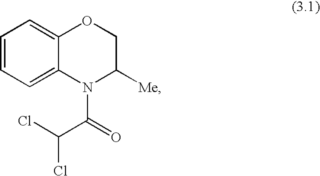
and the compound of formula 3.2 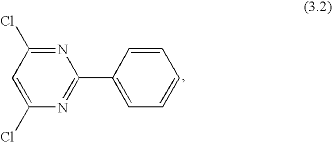
and the compound of formula 3.3 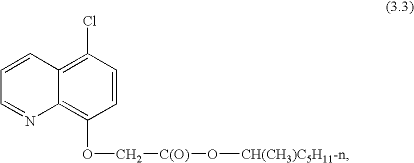
the free acid thereof or a salt or hydrate thereof,
and the compound of formula 3.4 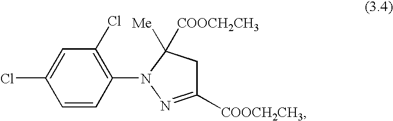
and the compound of formula 3.5 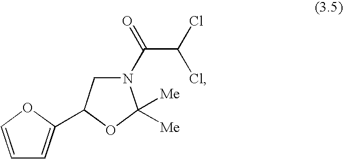
and the compound of formula 3.6 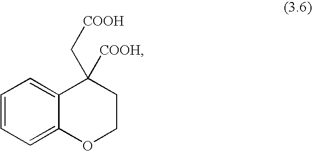
and the compound of formula 3.7 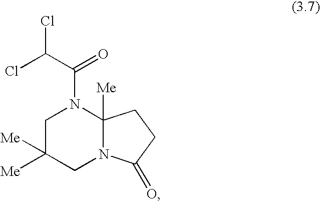
and the compound of formula 3.8 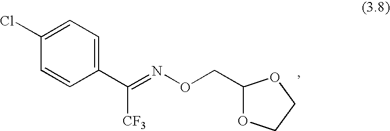
and of formula 3.9
Cl₂CHCON(CH₂CH═CH₂)₂ (3.9),
and of formula 3.10 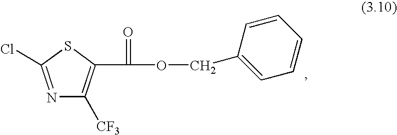
and of formula 3.11 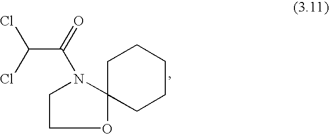
and of formula 3.12 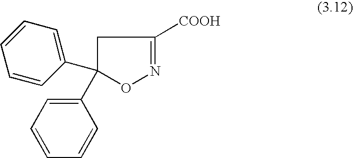
or a methyl or ethyl ester thereof or a salt thereof, and of formula 3.13 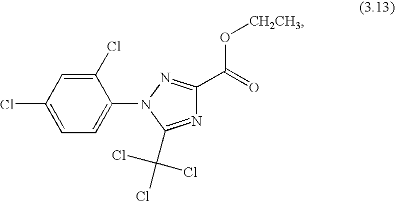
and of formula 3.14 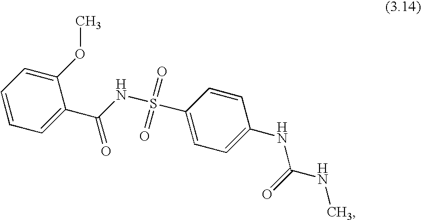
and of formula 3.15 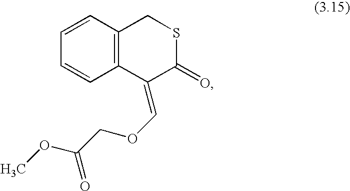
and of formula 3.16 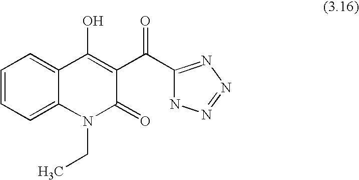
and of formula 3.17

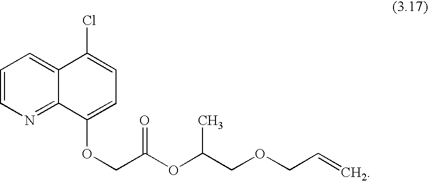

10. A method for the selective control of weeds and grasses in crops of useful plants, which comprises treating the useful plants, seeds or cuttings thereof, or the area of cultivation thereof, with a selective herbicidal amount of a composition according to claim 9.
